(19) United States
(12) Patent Application Publication
(10) Pub. No.: US 2016/0048603 A1
(43) Pub. Date: Feb. 18, 2016

(54) Online decision engine for applied research and statistics

(71) Applicant: Robert Eric Heidel, Knoxville, TN (US)

(72) Inventor: Robert Eric Heidel, Knoxville, TN (US)

(21) Appl. No.: 14/756,122

(22) Filed: Aug. 3, 2015

Related U.S. Application Data
(60) Provisional application No. 62/070,178, filed on Aug. 18, 2014.

(51) Int. Cl. G06F 17/30; G06F 17/18; G06F 3/0484

(52) U.S. Cl. CPC G06F 17/30882; G06F 3/04842; G06F 17/18

(57) ABSTRACT

This non-provisional patent application pertains to an embodiment of an online decision engine for applied research and statistics. Users will interact with a point-and-click interface that asks questions to guide researchers to the correct research methods and statistics to answer their research questions. A number of decision engines exist in the overall decision engine. These decision engines include: Research questions, research designs, statistical power, sample size, evidence-based medicine, epidemiology, diagnostic testing, variables, statistics, databases, surveys, psychometrics, and education. Users are presented a series of questions and based on their answers and clicking on buttons with the answers embedded in them, they are linked to webpages with the correct research method or statistical test based on their responses to the questions presented.

### CROSS-REFERENCE TO RELATED APPLICATIONS

U.S. Provisional Patent Application No. 62/070,178

### STATEMENT REGARDING FEDERALLY SPONSORED RESEARCH OR DEVELOPMENT

Not applicable

### REFERENCE TO SEQUENCE LISTERING

Not applicable

### BACKGROUND OF THE INVENTION

1. Field of Invention

This invention generally relates to an online decision engine for applied research and statistics, specifically an online decision engine that gives users access to information and methods for conducting and interpreting research methods and statistics by answering questions and clicking on buttons with their answers embedded in them and being linked to other respective webpages containing information and methods.

2. Prior Art

### Statistical Consultants

Statistical consulting is an “expanding and evolving” field where empirical and statistical methodologies are employed to study clinical phenomena.¹ Statistical consultants provide empirical support to researchers across a wide spectrum of disciplines and professions. Marquardt said, “Statistical consulting is unique in that . . . statistics is used and is useful in far more fields of application than any other technical discipline.”² Statistics is an independent science that also plays an essential role in the scientific methodologies of many other fields.³ Collaboration between statistical consultants and researchers increases the chance for publication.⁴⁻⁶ However, past research has shown that poorly designed studies are a result of limited or misguided communication between researchers and statistical consultants.⁷⁻⁸

Statistical consultants play a much more collaborative and industrious role in applied research and statistics in comparison to the traditional “technical” contributions of the past.⁹ Statistical consultants can increase the “quality and utility” of inferences, implications, and conclusions yielded from research studies.¹⁰ In essence, consultants are purveyors of the scientific method.¹¹

Statistical consultants come from a wide range of educational and professional backgrounds. They may have been trained as educators, epidemiologists, engineers, or other biomedical professionals. Regardless of prior training and experience, researchers are best served by a statistical scientist. A statistical scientist is “an individual trained in statistics, probability, computer science and applied mathematics that uses these disciplines to advance our understanding and enlarge our knowledge of important problems.¹² Because they work with a wide range of professions, it behooves consultants to have a strong command of various empirical methodologies, possess a wealth of applied experience, and exhibit a genuine interest in advancing scientific discovery.¹³

Statistical consultants are also educators. Consultancy provides an excellent learning environment to learn and apply the philosophy, theory, and utility of statistics. Kirk said, “Good consulting rarely takes place in the absence of teaching—the two are inseparable.”¹⁴ Education in consultancy also promotes the efficacy of statistical science and reinforces client's feelings of autonomy and abilities to understand empirical literature.¹⁵⁻¹⁶

Statistical consultants also conduct collaborative and methodological research.¹⁷ Collaborative research can be conducted in terms of discovery, integration, teaching, or application.¹⁸ Methodological research is focused on solutions to statistical, empirical, and consultative topics. The invention and application of new methods and analyses augments the elasticity and robustness of statistics as a science and methodology.

Statistical consultants, as purveyors, collaborators, and researchers, have to take in a lot of information from their clients to obtain a sound frame of reference regarding potential research. This information is then synthesized in the consultant's cognitive schema to formulate a methodologically sound analysis and methodology. Marquardt wrote, “Problem formulation, problem solution, and implementation . . . always require a balance that incorporates adequate technical sophistication to capture the most important problem features, and at the same time avoid excessive complications. The best consultants have the technical skills and judgment to choose a proper balance, and the personal confidence to use and sell as simple or complex a technique when the selected approach is right for the circumstances.”¹⁹ Statistical and empirical competencies are important within statistical consultation, but just as important is the “sufficient wisdom, common sense, or . . . good judgment” of the consultant to apply, synthesize, and evaluate in the consultative environment.¹¹

### Statistical Clients

Researchers experience high levels of cognitive dissonance before seeking out help due to their lack of experience and competencies related to statistics.²⁰ Zahn and Isenberg wrote, “Statistical analyses cause anxieties in many clients, partly because most people want to avoid appearing ignorant, and partly because there is so much new to learn in order to not be ignorant”¹⁵ Undergraduate and graduate training also rarely equips researchers with the capabilities to conduct research.²¹⁻²²

Clients often come to statistical consultants expecting certain tasks to be performed: Developing and refining research questions, recommending research designs, conducting power analyses, designing data collection and management systems, planning and executing data analyses, interpreting results, and preparing abstracts and manuscripts.¹⁹ Communication and knowledge of the existing empirical literature is critical.¹⁵

### The Research Question

The research question is the foundation of everything empirical. It is cultivated through the researcher's efforts to read the existing empirical literature, clinical expertise, collaborations with peers, and motivation for scientific discovery. Valid research questions are the basis for making contributions to the literature. Research questions should be answerable, appropriate, meaningful, and purposeful.²³ The research question directly influences research hypotheses, research populations, sampling methods, selecting research designs, choosing variables, establishing effect sizes, managing data, calculating sample size and statistical power, interpreting research findings, and publishing.

Understanding the nature of a problem and the research question posed by researchers is critical in statistical consultation. Upwards of 80% of statistical consultation should be spent formulating and refining the research question.⁶ Statistical consultants are 100% dependent upon researchers knowing the existing literature and what types of evidence have been generated. The explicit and mutual understanding of the clinical problem and research question is the “single most important element” of statistical consultation.²⁴

There are two mnemonics from the literature that are used to formulate and refine research questions: FINER (feasible, interesting, novel, ethical, and relevant) and PICO (population, intervention, comparator, and outcome).²⁵⁻²⁶ Secondary, tertiary, and ancillary research questions are often asked and are yielded from variables and phenomena in the empirical literature or clinical environment.²⁷ Multivariate research questions need to be asked to fill gaps in the empirical literature.²²

### The Research Hypothesis

The research hypothesis plays a central role in choosing research designs, sampling methods, variables, effect size, and statistical analysis.²⁸ The research hypothesis should be “simple, specific, and stated in advance.”²⁹ Statistical consultants help researchers formulate their research hypotheses in the context of magnitude, variance, and direction of a given effect size.

### The Research Design

Statistical consultants help researchers choose research designs that are feasible and will answer their research question.²⁵ Simplifying, deducing, and operationalizing the choices associated with research design is an important contribution by statistical consultants. In regards to design, consultants also help define inclusion and exclusion criteria, standardize research protocols, and train researchers. Rigorous study design is the best tool for controlling for bias in empirical research.²³

Consultants can also assist clients with choosing sampling methodologies for their studies. There are two primary forms of sampling: Probability and non-probability. Probability sampling is a type of sampling where every member of a population has an equal chance of being chosen for participation in a study. There are three types of probability sampling: Simple random sampling, stratified random sampling, and clustered random sampling. Non-probability sampling is where researchers analyze data that is available to them. Convenience sampling and purposive sampling fall under the guise of non-probability sampling methods.

### Measurement of Variables

As Don Vito Corleone eloquently stated in The Godfather, “Let me say that we must always look to our interests,” this inventor proclaims that as statistical consultants, “we must always look to our measures.”³⁰ Measurement has a pervasive and encompassing impact on all aspects of empirical research and variables are always chosen to answer the research question.²⁴ Consultants should reinforce the use of variables that appear in published studies and encourage them to measure for outcomes using the most widely accepted “gold standard” method. Outcome measures should be objective, valid, sensitive, specific, accurate, precise, and prevalent so that valid treatment effects can be established.

There are three primary scales of measurement that statistical consultants work with on a daily basis. Categorical is the lowest level of measurement where participants are assigned numerical headings based on their possession of a characteristic or trait or an occurrence, event, or outcome. Ordinal measurement is a numbered continuum that allows for rating phenomena or events. Continuous measurement is the highest level of measurement because it contains a “true zero” and allows for accounting for both distance and magnitude. Different statistical tests are conducted based on the scale of measurement of predictor, demographic, confounding, control, and outcome variables.

### Statistical Power

Statistical power is an indeterminate and challenging aspect of statistical and empirical reasoning that most researchers admonish in favor of asking statistical consultants, “How many people do I need in each group to reach a significant p-value?” Oftentimes, researchers have no idea what type of effect size (magnitude, variance, or direction) they are hypothesizing. Essentially, the researchers are conducting the study to establish the effect size.

There are several empirical components that are isomorphic with statistical power. This means that each component has an interdependent relationship with statistical power. A change in one component will always exact a predictable and static change in other components. The isomorphic components of statistical power are 1) the scale of measurement of the outcome, 2) the research design, 3) the hypothesized magnitude of the effect size, 4) the hypothesized variance of the effect size, and 5) the sample size.

Categorical outcomes will decrease statistical power and increase the required sample size. This is because of reduced precision and accuracy in categorical measurement. Ordinal outcomes will also decrease statistical power and increase the required sample size. Ordinal outcomes are analyzed using less powerful non-parametric statistics. Continuous outcomes will increase statistical power and decrease the required sample size. The presence of a “true zero” allows for more precision and accurate measurement of phenomena and outcomes.

Between-subjects designs decrease statistical power and increase the required sample size. This occurs because more observations are needed to compare independent groups. Within-subjects designs increase statistical power and decrease the required sample size. This is because each observation serves as its own control. Multivariate designs decrease statistical power and increase the required sample size because more observations are needed to account for multivariate associations.

Small effect sizes decrease statistical power and increase the required sample size. More observations of an outcome are needed to detect small nuances of treatment effects. Large effect sizes increase statistical power and decrease the required sample size. Because large differences are easier to detect, fewer participants are needed to achieve statistical significance.

When treatment effects are expected to be highly varied or heterogeneous, statistical power will decrease and the required sample size will increase. In order to pick up unique variance in a highly varied effect, more observations are needed to detect significance. When effects are thought to have limited variance or be homogeneous, statistical power will increase and the required sample size will decrease. Homogenous or limited variance in a treatment effect will be detected faster.

When researchers have access to smaller sample sizes, statistical power will decrease and the flexibility of the effect size will decrease. Flexibility means the ability to detect both small and large effect sizes, regardless of limited or extensive variance. Small sample sizes require the use of less powerful non-parametric statistics and do not give a sound representation of the true variance that may exist in a population. When researchers have access to larger sample sizes, statistical power will increase the flexibility of the effect size will increase. It is commonly known in statistics that with more observations of an outcome, the likelihood of detecting statistical significance drastically increases.

### Sample Size

The open source application, G*Power, is a towering contribution to the field of empiricism and should be a part of any statistical consultant's toolkit.³¹⁻³² The methods for calculating a priori and post hoc power analyses are very user-friendly within the program and the outputs are readily interpretable. Statistical consultants can teach clients the isomorphic tendencies of statistical power using G*Power and the aforementioned interdependencies between outcome measurement, research design, magnitude and variance of, effect size, and sample size. Sample size calculations are very important in the planning stages of a study and statistical consultants can provide this value with the right knowledge and technology.

### Database Management

A database is where researchers store and manipulate research data. The importance of data collection, data entry, data validation, and data maintenance cannot be overlooked in statistical consultation. After a long career as a statistical consultant, Kirk said, “ . . . often their data fails to address the questions of interest and may even defy an appropriate statistical analysis.”¹⁴ Consultants make an invaluable contribution to the logistics of planning a research study by creating and executing a data management system for researchers.

Databases are structured according to the type of research design being used. There are three primary database designs: Between-subjects, within-subjects, and multivariate. After the researcher has identified all of the variables that will be collected in a study with their scales of measurement, the database is created concurrently with a code book that contains all of the variable names and their respective codifications.

### Statistical Analysis

Sprent wrote, “Perhaps the greatest pitfall facing consultants is the temptation to worry only about the statistics of a problem, or to treat a problem at its face value.”⁷ Statistical consultants are tasked with giving research data a thorough examination in regards to data validity, meeting statistical assumptions, and conducting the correct statistics. Statistics should only be run when they are grounded in a research question. Simply running multiple analyses can greatly increase Type I error rates where false significant findings are yielded.

Statistical consultants are responsible for presenting the results of statistical analyses in an annotated write-up that addresses all research questions. The consultant should also interpret the findings in regards to descriptive statistics and p-values. All statistical findings, including the non-significant statistical findings, are reported by consultants. Tables, figures, and visual aids can be created as well.

### Evidence-Based Medicine

Evidence-based medicine is an applied framework for integrating clinical evidence into clinical practice in medicine.³³ There are five specific parts to practicing evidence-based medicine: Asking, acquiring, appraising, applying, and assessing. The PICO mnemonic is used for writing valid research questions. Search queries are also structured using the PICO mnemonic to yield more specific, or “healthy,” search results. For different kinds of clinical evidence, there are certain questions that readers have to ask themselves after reading an article to better understand its utility and generalizability to the current clinical situation. Then, clinicians have to make a decision to apply and integrate the clinical evidence and assess the efficacy of evidence-based practice.

### Epidemiology

Epidemiology is the study of disease states in populations. In order for researchers to study the beneficence or harm associated with treatments, they employ a series of epidemiological calculations. After a treatment is tested using experimental designs, the control event rate (CER) and the experimental event rate (EER) are calculated. Based upon the treatment effect being either efficacious or detrimental, either the absolute risk reduction (ARR) or absolute risk increase (ARI) is calculated by subtracting the CER from the EER. In order to calculate the number needed to treat (NNT), or the number of people that have to be treated to prevent a future bad outcome, divide 1 by the ARR. To calculate the number needed to harm (NNH), or the number of people that have to be treated to cause a future bad outcome, divide 1 by the ARI.

Odds ratios are used as measures of association between predictor and outcome variables in retrospective epidemiological studies. Prevalence is the number of cases of a disease state that exist at any given time. When conducting prospective epidemiological studies, relative risk is the measure of association used and incidence, or the number of new cases in a given population, is calculated. The 95% confidence intervals of odds ratios and relative risk calculations are the primary inference when the statistics are utilized.

### Diagnostic Testing

Diagnostic testing is an empirical methodology used to establish the ability of a diagnostic test in correctly diagnosing disease states. In order to do this, diagnostic calculations are used. In order to conduct an experimental study for a new diagnostic test, there must be a “gold standard” diagnostic test administered concurrently with each observation and the results must be observed in an independent fashion. Sensitivity is the ability of a diagnostic test to detect disease states. Specificity is the ability of a diagnostic test to detect healthy people. Positive Predictive Value (PPV) is the confidence or precision of a diagnostic test in detecting disease states. Negative Predictive Value (NPV) is the confidence or precision of a diagnostic test in detecting healthy people. Receiver Operator Characteristic (ROC) curves are used to establish cut-points for maximizing sensitivity and specificity for diagnostic tests using continuous measurement. Area under the curve (AUC) is an inferential statistic used to test diagnostic ability in ROC curves. Several diagnostic tests can be tested concurrently to see which has the most AUC using ROC curves.

### Variables

First and foremost, variables are chosen to answer research questions. There are several types of variables. Independent variables are what the researcher manipulates to better understand the dependent variable. Interventions (or the lack thereof) and group membership are often used as independent variables. Dependent variables are what the researcher is observing or measuring in a research study. Control variables are variables that adjust the relationship between independent and dependent variables. Predictor variables are variables that have potential associations with outcome variables. Outcome variables are variables that researchers utilize to measure for phenomena and constructs. Confounding variables are variables that adjust the relationship between predictor and outcome variables. Demographic variables are used to describe the samples that are taken from population and analyzed using inferential statistics. If at all possible, all variables should be measured at the “gold standard” level or by the most widely accepted manner of measuring for the phenomenon or construct of interest.

### Surveys

When attempting to measure for unique, novel, or subjective phenomena and outcomes, or if a measure or instrument does not exist to measure for phenomena or outcomes of interest, statistical consultants can provide clients with a validated eight-step method for creating survey instruments that can account for the aforementioned phenomena or outcomes.³⁴⁻³⁵ The eight steps are 1) create a construct specification, 2) expert review of the construct specification, 3) choose a survey methodology, 4) write survey items, 5) pretest the survey, 6) make changes and formally structure the survey, 7) conduct a pilot study with reliability and factor analyses, and 8) conduct a validation study with validity and confirmatory factor analyses.

### Psychometrics

Psychometrics is the science underlying the utility and interpretability of survey instruments and psychological tests. Reliability and validity are the two primary components of psychometrics. Reliability is the confidence, consistency, and precision of a given survey instrument. There are several types of reliability: Internal consistency reliability, test-retest reliability, alternate/parallel forms reliability, and inter-rater reliability. Cronbach's alpha is an internal consistency measure of reliability used for assessing the intercorrelations among survey items that have response sets at an ordinal level or higher. Split-half reliability gives an internal consistency measure of reliability that assumes that two randomly assigned halves of an instrument should significant correlate. Kudar-Richardson 20 (KR-20) is the internal consistency measure of reliability used when the response sets of survey items are dichotomous and categorical. Alternate/parallel forms reliability is not feasible for most researchers as it entails writing two exactly similar survey instruments. Principal Component Analysis (PCA) is a type of exploratory factor analysis that is used to give a mathematical and conceptual understanding of the construct of interest.

Validity is the utility, interpretability, and accuracy of a given survey instrument. There are several types of validity: Construct validity, concurrent validity, predictive validity, content validity, convergent validity, divergent validity, known-groups validity, incremental validity, and face validity. All forms of validity falls under the guise of construct validity because it represents measuring what it is one is supposed to be measuring using a survey instrument. Concurrent validity is a type of evidence that shows a survey instrument correlates with another measure at the same time. Predictive validity is a type of evidence where a survey instrument can predict for future occurrences. Content validity is evidence that a survey instrument's items cover all of the pertinent content areas in a given body of knowledge related to the construct of interest. Convergent validity is evidence of a significant positive correlation between a survey instrument and another measure that is theoretically or conceptually similar. Divergent validity is evidence of a significant negative correlation between a survey instrument and another measure that is theoretically or conceptually dissimilar. Known-groups validity is a type of validity evidence that shows a survey instrument can differentiate between independent groups. Incremental validity is evidence of a survey instrument's scores accounting for new and unique variance within a theoretical or conceptual network of measures or constructs. Face validity is a weak form of evidence where a survey instrument looks like it is supposed to do at face value. Confirmatory Factor Analysis (CFA) is used to confirm the mathematical and conceptual understanding of the construct of interest from the PCA or theoretical framework.

### Education

Bloom's Taxonomy is a theoretical framework associated with levels of “knowing” or “understanding” in a given area of knowledge. There are six levels of “knowing” or “understanding” within Bloom's Taxonomy: Knowledge, comprehension, application, analysis, synthesis, and evaluation. The framework is also often used as a pedagogical framework for writing instructional goals and objectives. There are numerous action verbs that can be derived from the six levels of “knowing” or “understanding” that can be used to write objectives related to meeting a goal.

Maslow's Hierarchy of needs is an educational theory focused on development of individuals towards their potential. There are five sequential steps in the pyramid used to describe the theory that eventually lead to a person achieving their potential. The first and most foundational step is basic physiological needs such as food, water, clothing, shelter, and relative good health. Safety is the second step. Relative safety and security in the immediate environment on a consistent basis and in society as a whole is needed for human beings to socialize. The third level is love, affection, and belongingness where social success is sought out and mutual giving and receiving of love, bonding, and social acceptance is central. Self-esteem is the fourth level where a sense of “self” is developed through intrapersonal reinforcement and social success. After all four levels are obtained, then a person's true potential can be achieved. This is known as “self-actualization.” People that achieve self-actualization have the ability to do what they were meant to do or what they want to do.

Research and statistics induces cognitive dissonance in most people. The lexicon of statistical science is nebulous and often intimidating to people that do not work in the field. A research and statistics dictionary written by a statistical consultant can help.

### Decision Trees

Decision trees for choosing the correct research design or statistical test exist. They are often printed at the back of textbooks. Research Engineer improves upon the use of decision trees by providing users an easy point-and-click interface and the correct questions to get them to the correct research design or statistical test. Research Engineer is also published online and can be access anywhere the internet or Wi-Fi is available. Research Engineer also goes much more in-depth than traditional decision trees.

### CURRENT STATE OF THE INVENTION

The website, called Research Engineer and located at http://www.scalelive.com, was published online in August of 2014. Since that time, it has been accessed in 229 countries and territories around the world. According to Google Analytics, there was a total of 357,908 sessions across 308,082 unique visitors. A total of 1,239,416 pageviews occurred with an average of 3.46 pages per session. According to Google Adwords, a total of 24,775,325 ad impressions occurred with 340,400 clicks, yielding a click through rate (CTR) of 1.37%. According to Bing Ads, a total of 7,120,148 ad impressions occurred with 63,212 clicks, yielding a CTR of 0.89%. According to Google Adsense, 1,617,269 impressions have been made on the website with 11,011 ads clicked, yielding a 3.01% CTR.

### Objects and Advantages

Accordingly, this online decision engine for research and statistics has many advantages over past methods and applications and they are:

(a) Research Engineer is the world's first online decision engine for applied research and statistics
(b) Users can choose the correct research methodology, sample size, database, and statistical test to answer their research questions
(c) Users can choose the correct methods for evidence-based medicine, variables, epidemiological calculations, diagnostic testing calculations, surveys, psychometrics, and writing instructional goals and objectives
(d) Fills the “gap” between what researchers know and what they can actually do
(e) Provides the methods for conducting and interpreting over 60 different statistical and psychometric analyses in SPSS (Statistical Package for the Social Sciences, Armonk, N.Y.: IBM Corporation)
(f) Research biases can be better accounted for due to increased precision and accuracy of research methods and statistics
(g) Research Engineer asks the right questions and gets researchers the correct answers
(h) A vest wealth of pertinent and practical empirical and statistical information written in easy-to-understand language will be freely accessible
(i) The website can be accessed anywhere around the world where the internet or Wi-Fi is available, using smart phones, tablets, or computers
(j) A wide range of useful topics are covered for both beginning and expert levels of experience and competencies
(k) Reduces cognitive dissonance associated with research and statistics
(l) Research Engineer is like having statistical consultation for free
(m) Research Engineer can be used in an educational capacity to teach empirical and statistical reasoning
(n) Researchers and scientists will have quick access to a wide spectrum of empirical and statistical methods
(o) A vast improvement over traditional decision trees—Research Engineer is a dynamic and interactive experience
(p) Download pre-formatted databases, calculators, and documents related to research and statistics
(q) Calculate the needed sample size to acquire adequate statistical power
(r) Create valid surveys using a validated eight-step methodology
(s) Choose the correct epidemiological test given efficacious or detrimental treatment effects
(t) Assess the ability of diagnostic tests

### SUMMARY

In accordance with one embodiment, this non-provisional application pertains to an embodiment of an online decision engine that provides empirical and statistical support across a wide range of applied methodologies. Users will interact with a point-and-click interface that asks questions to guide researchers to the correct research methods and statistics to answer their research questions. A number of decision engines exist in the overall decision engine, Research Engineer, which can be accessed at http://www.scalelive.com. These decision engines include: Research questions, research designs, statistical power, sample size, evidence-based medicine, epidemiology, diagnostic testing, variables, statistics, databases, surveys, psychometrics, and education. Users are presented a series of questions and based on their answers and clicking on buttons with the answers embedded in them, they are linked to webpages with the correct research method or statistical test based on their responses to the questions presented. Research Engineer provides the information and methods for conducting and interpreting over 60 different statistics in SPSS. A decision engine is available for writing valid research questions using the FINER and PICO mnemonics. Another decision engine gets users to the correct research design based on their research question. Users can use a decision engine for choosing a database structure that matches their research design. The statistical power decision engine works users through the reasoning associated with research design, outcomes, effect size, variance, and sample size and statistical power. The methods for conducting and interpreting sample size calculations for ten different statistical tests in G*Power are presented. The methods for conducting the five steps associated with integrating evidence-based medicine into clinical practice (asking, acquiring, appraising, applying, assessing) are made into a decision engine. An epidemiology decision engine is presented to allow users to calculate important epidemiological measures. A diagnostic testing engine shows the different calculations needed to assess diagnostic tests. A variables engine guides users through the reasoning associated with scales of measurement and types of variables. A validated eight-step method for creating survey instruments is available as a survey decision engine. The methods for conducting and interpreting reliability and validity analyses are presented as a psychometrics decision engine. Users are presented with information about writing instructional goals and objectives using 54 action verbs from Bloom's Taxonomy, using an educational theory called Maslow's Hierarchy of Needs, and the definitions for a wide range of empirical and statistical terms. Preformatted calculators for equivalency trials, non-inferiority trials, epidemiological calculations, and diagnostic testing are downloadable. Preformatted databases structured for running between-subjects, within-subjects, and multivariate statistics are downloadable. Construct specification and focus group templates are also downloadable.

### BRIEF DESCRIPTION OF THE DRAWINGS

FIG. 1. This figure depicts the Research Engineer decision engine homepage. Users of the online decision engine will click on buttons in the homepage to move forward. Users can access any of the available decision engines in Research Engineer.

FIG. 2. This figure depicts the Research decision engine in Research Engineer. Users of the online decision engine will click on buttons in the webpages to move forward. Users can access nine decision engines in Research Engineer, including a webpage where free calculators for equivalency trials, non-inferiority trials, meta-analysis, epidemiological calculations, and diagnostic testing calculations.

FIG. 3. This figure depicts the Research Questions decision engine in Research Engineer. Users of the online decision engine will click on buttons in the webpages of the Research Questions decision engine to move forward. Users will work through the FINER mnemonic and then the PICO mnemonic. Upon completion of the PICO mnemonic part of the decision engine, users are prompted to click on-a button that will take them to the Research Designs decision engine in Research Engineer.

FIG. 4. This figure depicts the Research Designs decision engine in Research Engineer. Users of the online decision engine will be asked questions and depending upon their answers, they will click on buttons that have their answers embedded in them to navigate to the next webpage containing pertinent information or questions. Users will answer questions by clicking the buttons until they get to the correct research design that will answer their research question. Researchers are asked if they want to conduct a systematic review, equivalency trial or non-inferiority trial. They are asked if they are going to use random selection, random assignment, prospective observational designs, or retrospective observational designs. Upon completion of the Research Designs decision engine, users are prompted to click on a button that will take them to the Statistical Power decision engine in Research Engineer.

FIGS. 5, 5A. This figure depicts the Statistical Power decision engine in Research Engineer. Users of the online decision engine will be asked questions and depending upon their answers, they will click on buttons that have their answers embedded into them to navigate to the next webpage containing pertinent information or questions. Users will answer questions by clicking the buttons until they get to the correct understanding of the interdependencies of outcomes, research design, and effect size with statistical power. Users are asked if they will measure for categorical, ordinal or continuous outcomes. Then, users are asked if they will be using a between-subjects, within-subjects, or multivariate research design. Finally, users are asked if they plan on measuring for small or large effect sizes. After clicking on a button for either small or large effect size, visiting either the small effect sizes or large effect sizes webpage, users are told to click on a button that will take them to the Variance of Outcome webpage. Users are asked if they hypothesize limited or extensive variance in the outcome, if they will have a relative small or large sample size, and what type of sampling methodology, probability or non-probability, will be used. Upon completion of the Statistical Power decision engine, users are told to click on a button that will take them to the Sample Size decision engine in Research Engineer.

FIG. 6. This figure depicts the Sample Size decision engine in Research Engineer. Users of the online decision engine will be asked questions about what statistical test they want to run a sample size calculation for in their research. They will click on a button that has the statistical test embedded into it to navigate to the webpage containing the methods for conducting and interpreting the test in G*Power. There are ten types of statistical tests that users can access by clicking on buttons on the Sample Size decision engine: Chi-square, Mann-Whitney U, independent samples t-test, ANOVA, McNemar's test, Wilcoxon, repeated-measures t-test, repeated-measures ANOVA, point biserial, and Pearson's r. Upon completion of the Sample Size decision engine, users are told to click on a button that will take them to the Statistics decision engine in Research Engineer.

FIGS. 7, 7A, 7B, 7C. These figures depict the Evidence-Based Medicine decision engine in Research Engineer. Users of the online decision engine will be presented with a series of questions related to asking clinical questions, acquiring clinical evidence, appraising clinical evidence, applying clinical evidence, and assessing evidence-based practice. Depending upon what type of evidence that has been acquired, clinicians will have to use different methods to appraise and apply that respective type of evidence. Users will click on a button to designate what type of evidence they want to appraise which will navigate them to a webpage containing questions related to appraising that type of evidence. Users are then asked to click on button that will take them to a webpage containing questions about applying that type of evidence in the current clinical context. There are ten different types of evidence that can be appraised and applied: Randomized Controlled Trial evidence, Systematic Review evidence, Qualitative evidence, Clinical Decision Analysis evidence, Economic Analysis evidence, Clinical Practice Guidelines, Diagnosis evidence, Screening evidence, Prognosis evidence, and Harm evidence. After the appraisal and application questions are presented, users are prompted to click on a button that takes them to a webpage related to assessing evidence-based medicine. Users then click on buttons to navigate through the methods for assessing evidence-based practice. Upon completion of the Evidence-Based Medicine decision engine, users are told to click on a button that will take them back to the Research Engineer webpage.

FIG. 8. This figure depicts the Epidemiology decision engine in Research Engineer. Users of the online decision engine will be presented with a series of questions related to epidemiological calculations. Users will click on a button that has an epidemiological calculation embedded into it to navigate to the webpage containing information and methods related to that respective calculation. Users will get information about odds ratios, prevalence, relative risk, and incidence. Then, they will work through the Epidemiology engine by clicking on buttons in its webpages. After navigating through the control event rate and experimental event rate webpages, users will be asked if the treatment effect is hypothesized to be efficacious or detrimental. Depending upon their answer and clicking on buttons in the webpage, they will be sent to a webpage for either absolute risk reduction or absolute risk increase. Following these pages and clicking on buttons to move forward, users will be presented with either the number needed to treat or number needed to harm webpages. A calculator for all epidemiological calculations is downloadable.

FIG. 9. This figure depicts the Diagnostic Testing decision engine in Research Engineer. Users of the online decision engine will be asked a series of questions related to diagnostic testing. Users will click on a button that has a diagnostic calculation embedded into it to navigate to the webpage containing information and methods related to that respective calculation. Users have the option of moving forward in the Diagnostic Testing engine by click on buttons in each respective page. The Diagnostic Testing decision engine includes webpages for sensitivity, specificity, positive predictive value, negative predictive value, receiver operator characteristic, area under the curve, and diagnostic accuracy are all presented. A calculator for all diagnostic testing application is downloadable.

FIG. 10. This figure depicts the Variables decision engine in Research Engineer. Users of the online decision engine will be asked a series of questions related to their specific needs in regards to scales of measurement and types of variables. Users have the option of choosing which type of variable to learn about by clicking on buttons with the names of different types of variables embedded in them and being navigated to those respective pages. Users work through webpages with the scales of measurement: Categorical, nominal, ordinal, continuous, interval, ratio, and count. Users can also work through webpages explaining different types of variables: Independent, dependent, control, predictor, outcome, confounding, and demographic.

FIGS. 11, 11A, 11B, 11C, 11D, 11E, 11F, 11G, 11H, 11I, 11J, 11K, 11L, 11M. These figures depict the Statistics decision engine in Research Engineer. Users of the online decision engine will be asked questions regarding the type of research design being used, the number of groups or observations being assessed, the types of outcomes being used, and the statistical assumptions of certain statistical tests. Based on the answers to the questions and clicking on buttons with answers embedded in them within the webpages of the Statistics decision engine, they will navigate to the correct statistical test to answer their research questions. The following webpages can be accessed by clicking on buttons related to statistics in the Statistics decision engine: Statistical assumptions, descriptive statistics, between-subjects, within-subjects, correlations, multivariate, regression, SPSS, and validation of statistical findings. The methods for conducting and interpreting each type of statistical test in SPSS are presented in each webpage. Upon completion of the Statistics decision engine, users are told to click on a button that will take them to the Databases decision engine in Research Engineer.

12. This figure depicts the Databases decision engine in Research Engineer. Users of the online decision engine will be asked a question regarding the type of research design being used. They will click on the button with the name of the correct database embedded in it to gain access to webpages containing the methods for constructing the correct database. Users will also have the chance to download a preformatted database and code book.

FIG. 13. This figure depicts the Surveys decision engine in Research Engineer. Users of the online decision engine will be presented with information related to creating surveys. Users work through the Surveys decision engine by clicking on buttons with the names of the steps embedded in them to navigate through each of the eight steps for creating a survey. They have the opportunity to download a construct specification and a focus group template. Upon completion of the Survey decision engine, users are told to click on a button that will take them to the Psychometrics decision engine in Research Engineer.

FIGS. 14, 14A. This figure depicts the Psychometrics decision engine in Research Engineer. Users of the online decision engine will be presented with a series of questions related to their specific research needs. They can choose either reliability or validity by clicking buttons with the words embedded in them within the Psychometrics decision engine. Users are navigated to other webpages that give an explanation of each type of reliability or validity evidence and present the methods for conducting and interpreting the psychometrics in SPSS.

FIG. 15. This figure depicts the Education decision engine in Research Engineer. Users of the online decision engine will be presented with a series of buttons with the names of educational constructs embedded in them. They can choose writing instructional goals and objectives, Maslow's Hierarchy of Needs, or a research and statistics dictionary by clicking on buttons in the Education decision engine. Users will then navigate to respective pages to gain more insight into each educational topic.

### DRAWINGS

### List of Reference Numerals

101 Research Engineer webpage
102 Research webpage
103 Research Questions webpage
104 Research Designs webpage
105 Statistical Power webpage
106 Sample Size webpage
107 Evidence-Based Medicine webpage
108 Epidemiology webpage
109 Diagnostic Testing webpage
110 Variables webpage
111 Statistics webpage
112 Databases webpage
113 Surveys webpage
114 Psychometrics webpage
115 Education webpage
201 Calculators webpage
301 FINER webpage
302 Feasible Research Questions webpage
303 Interesting Research Questions webpage
304 Novel Research Questions webpage
305 Ethical Research Questions webpage
306 Relevant Research Questions webpage
307 PICO webpage
308 Population webpage
309 Intervention webpage
310 Comparator webpage
311 Outcome webpage
401 Systematic Review webpage
402 Equivalency Trial webpage
403 Non-Inferiority Trial webpage
404 Random Selection webpage
405 Random Assignment webpage
406 Randomized Controlled Trial webpage
407 Intention-to-Treat webpage
408 Blinding webpage
409 Quasi-Experimental Designs webpage
410 Counterbalanced Design webpage
411 Interrupted Time Series Design webpage
412 Equivalent Time Sample Design webpage
413 Nonequivalent Control Group Design webpage
414 Observational Designs webpage
415 Prospective Cohort webpage
416 Retrospective Designs webpage
417 Case Series webpage
418 Case-Control webpage
419 Cross-Sectional webpage
420 Retrospective Cohort webpage
421 Propensity Score Matching webpage
501 Outcomes webpage
502 Categorical Outcomes webpage
503 Ordinal Outcomes webpage
504 Continuous Outcomes webpage
505 Research Design webpage
506 Between-Subjects Design webpage
507 Within-Subjects Design webpage
508 Multivariate Designs webpage
509 Effect Size
510 Small Effect Sizes
511 Large Effect Sizes webpage
512 Variance of Outcome webpage
513 Limited Variance webpage
514 Extensive Variance webpage
515 Sample Sizes webpage
516 Small Sample Sizes webpage
517 Large Sample Sizes webpage
518 Sampling Methods webpage
519 Probability Sampling webpage
520 Simple Random Sampling webpage
521 Stratified Random Sampling webpage
522 Clustered Random Sampling webpage
523 Non-Probability Sampling webpage
524 Convenience Sampling webpage
525 Purposive Sampling webpage
601 Sample Size for Chi-Square
602 Sample Size for Mann-Whitney U webpage
603 Sample Size for Independent samples t-test webpage
604 Sample Size for ANOVA webpage
605 Sample Size for McNemar's Test webpage
606 Sample Size for Wilcoxon Test webpage
607 Sample Size for Repeated-Measures t-test webpage
608 Sample Size for Repeated-Measures ANOVA webpage
609 Sample Size for Point Biserial webpage
610 Sample Size for Pearson's r webpage
701 Asking Clinical Questions webpage
702 Acquiring Clinical Evidence webpage
703 Appraising Clinical Evidence webpage
704 Appraising Therapy Evidence webpage
705 Applying Clinical Evidence webpage
706 Assessing Evidence-Based Practice webpage
707 Appraising Randomized Controlled Trial Evidence webpage
708 Applying Randomized Controlled Trial Evidence webpage
709 Appraising Systematic Review Evidence webpage
710 Applying Systematic Review Evidence webpage
711 Appraising Qualitative Evidence webpage
712 Applying Qualitative Evidence webpage
713 Appraising Clinical Decision Analysis Evidence webpage
714 Applying Clinical Decision Analysis Evidence webpage
715 Appraising Economic Analysis Evidence webpage
716 Applying Economic Analysis Evidence webpage
717 Appraising Clinical Practice Guideline Evidence webpage
718 Applying Clinical Practice Guideline Evidence webpage
719 Appraising Diagnosis Evidence webpage
720 Applying Diagnosis Evidence webpage
721 Appraising Screening Evidence webpage
722 Applying Screening Evidence webpage
723 Appraising Prognosis Evidence webpage
724 Applying Prognosis Evidence webpage
725 Appraising Harm Evidence webpage
726 Applying Harm Evidence webpage
727 Asking Clinical Questions Assessment webpage
728 Acquiring Clinical Evidence Assessment webpage
729 Appraising Clinical Evidence Assessment webpage
730 Applying Clinical Evidence Assessment webpage
731 Assessing Clinical Practice webpage
801 Odds Ratio webpage
802 Prevalence webpage
803 Relative Risk webpage
804 Incidence webpage
805 Control Event Rate webpage
806 Experimental Event Rate webpage
807 Treatment Effect webpage
808 Absolute Risk Reduction webpage
809 Number Needed to Treat webpage
810 Absolute Risk Increase webpage
811 Number Needed to Harm webpage
901 Sensitivity webpage
902 Specificity webpage
903 Receiver Operator Characteristic webpage
904 Positive Predictive Value webpage
905 Negative Predictive Value webpage
906 Diagnostic Accuracy webpage
1001 Scales of Measurement webpage
1002 Categorical Variables webpage
1003 Nominal Variables webpage
1004 Ordinal Variables webpage
1005 Continuous Variables webpage
1006 Interval Variables webpage
1007 Ratio Variables webpage
1008 Count Variables webpage
1009 Types of Variables webpage
1010 Independent Variables webpage
1011 Dependent Variables webpage
1012 Predictor Variables webpage
1013 Outcome Variables webpage
1014 Confounding Variables webpage
1015 Demographic Variables webpage
1016 Control Variables webpage
1101 Statistical Assumptions webpage
1102 Descriptive Statistics webpage
1103 Between-Subjects webpage
1104 Within-Subjects webpage
1105 Correlations webpage
1106 Multivariate webpage
1107 Regression webpage
1108 SPSS webpage
1109 Validation of Statistical Findings webpage
1110 Independence of Observations webpage
1111 Normality webpage
1112 Homogeneity of Variance webpage
1113 Normality of Difference Scores webpage
1114 Sphericity webpage
1115 Chi-Square Assumption webpage
1116 Skewness and Kurtosis webpage
1117 Logarithmic Transformations webpage
1118 Mauchly's Test webpage
1119 Levene's Test webpage
1120 Measures of Central Tendency webpage
1121 Mean webpage
1122 Median webpage
1123 Mode webpage
1124 Measures of Variability webpage
1125 Variance webpage
1126 Standard Deviation webpage
1127 Interquartile Range webpage
1128 Frequency webpage
1129 Cross-Tabulation webpage
1130 One Group webpage
1131 Chi-Square Goodness-of-fit webpage
1132 One-Sample Median Test webpage
1133 One-Sample t-test webpage
1134 Two Groups webpage
1135 Fisher's Exact Test webpage
1136 Chi-Square webpage
1137 Mann-Whitney U webpage
1138 Normality and Independent Samples t-test webpage
1139 Transformations for Independent Samples t-test webpage
1140 Homogeneity of Variance and Independent Sample t-test webpage
1141 Mann-Whitney U and Homogeneity of Variance webpage
1142 Independent Samples t-test webpage
1143 Three or More Groups webpage
1144 Unadjusted Odds Ratio webpage
1145 Kruskal-Wallis webpage
1146 Normality and ANOVA webpage
1147 Transformations for ANOVA webpage
1148 Homogeneity of Variance and ANOVA webpage
1149 Kruskal-Wallis and Homogeneity of Variance webpage
1150 ANOVA webpage
1151 One Observation webpage
1152 Baseline Frequency webpage
1153 Baseline Median webpage
1154 Baseline Observations webpage
1155 Two Observations webpage
1156 McNemar's webpage
1157 Wilcoxon webpage
1158 Normality and Repeated-Measures t-test webpage
1159 Transformations for Repeated-Measures t-test webpage
1160 Repeated-Measures t-test webpage
1161 Three or More Observations webpage
1162 Cochran's Q webpage
1163 Friedman's ANOVA webpage
1164 Normality and Repeated-Measures ANOVA webpage
1165 Transformations for Repeated-Measures ANOVA webpage
1166 Sphericity and Repeated-Measures ANOVA webpage
1167 Repeated-Measures ANOVA webpage
1168 Greenhouse-Geisser webpage
1169 Phi-Coefficient webpage
1170 Point Biserial webpage
1171 Rank Biserial webpage
1172 Biserial webpage
1173 Spearman's rho webpage
1174 Pearson's r webpage
1175 Multivariate Statistics with Categorical Outcomes webpage
1176 Logistic Regression webpage
1177 Multinomial Logistic Regression webpage
1178 Proportional Odds Regression webpage
1179 Survival Analysis webpage
1180 Kaplan-Meier webpage
1181 Cochran-Mantel-Haenszel webpage
1182 Cox Regression webpage
1183 Multivariate Statistics with Continuous Outcomes webpage
1184 ANCOVA webpage
1185 Fixed-Effects ANOVA webpage
1186 Random-Effects ANOVA webpage
1187 Mixed-Effects ANOVA webpage
1188 Multiple Regression webpage
1189 Multiple Outcomes webpage
1190 MANOVA webpage
1191 MANCOVA webpage
1192 Count Outcomes webpage
1193 Negative Binomial Regression webpage
1194 Poisson Regression webpage
1195 Simultaneous Regression webpage
1196 Stepwise Regression webpage
1197 Hierarchical Regression webpage
1198 Residual Analysis webpage
1199 Normal Probability Plot webpage
11100 Linearity webpage
11101 Bootstrap webpage
11102 Split-Half webpage
11103 Jack-Knife webpage
1201 Between-Subjects Database webpage
1202 Within-Subjects Database webpage
1203 Multivariate Database webpage
1301 Construct Specification webpage
1302 Expert Review webpage
1303 Survey Methodology webpage
1304 Survey Types webpage
1305 Survey Parts webpage
1306 Survey Modes of Administration webpage
1307 Survey Items webpage
1308 Survey Pretest webpage
1309 Survey Structure webpage
1310 Pilot Study webpage
1311 Validation Study webpage
1401 Reliability webpage
1402 Internal Consistency Reliability webpage
1403 Cronbach's alpha
1404 Split-Half Reliability webpage
1405 KR-20 webpage
1406 Test-Retest Reliability webpage
1407 Alternate/Parallel Forms Reliability webpage
1408 Inter-Rater Reliability webpage
1409 Kappa webpage
1410 Intraclass Correlation Coefficient webpage
1411 Exploratory Factor Analysis webpage
1412 Validity webpage
1413 Construct Validity webpage
1414 Concurrent Validity webpage
1415 Predictive Validity webpage
1416 Content Validity webpage
1417 Known-Groups Validity webpage
1418 Convergent Validity webpage
1419 Divergent Validity webpage
1420 Incremental Validity webpage
1421 Face Validity webpage
1422 Confirmatory Factor Analysis webpage
1501 Writing Instructional Goals and Objectives webpage
1502 Maslow's Hierarchy of Needs webpage
1503 Research and Statistics Dictionary webpage

### DETAILED DESCRIPTION

This patent disclosure pertains to an embodiment of an online decision engine for applied research and statistics. The online decision engine will provide information and methods for conducting and interpreting research methods and statistics by answering questions and clicking on buttons with their answers embedded in them to be linked to webpages containing the correct methods and statistics.

Using a web-based application for creating and publishing webpages (Weebly.com), an online decision engine for research and statistics was created and published to the internet with a domain name. Using applications purchased from Weebly.com, a point-and-click interface was used to drag components of a webpage into an editor where they could be manipulated. Text, pictures, internal links, buttons, external links, search engines, social buttons, and HyperText Markup Language (HTML) components were embedded into the webpages and manipulated.

A central part of the online decision engine, called Research Engineer, is that users are asked questions related to their specific research needs, given their current educational, empirical, or statistical contexts and environment. These questions are what researchers have to ask themselves when conducting research and statistics and represent the inherent reasoning associated with applied research and statistics. The potential answers to the questions presented in the online decision engines are embedded in buttons that act as internal links to other webpages in Research Engineer. The webpages that users access are entirely dependent upon their answers. However, if users do not know what questions need to be asked, nor what methods or statistics to use, they are led to these respective methods and statistics by answering the questions presented to them in the decision engines.

Decision trees are often published in the back of textbooks related to research and statistics. These are used to help students and researchers to choose the correct method or statistical test. Research Engineer is similar to the decision trees in the backs of these textbooks, but provides an online, interactive, and dynamic decision engine with much more accessibility and sophistication as well as a simple point-and click interface to get users to the correct method or statistical test.

The accessibility comes from the fact that the website and its respective webpages can be accessed from any type of electronic device with internet or Wi-Fi capabilities such as smart phones, tablets, and computers. The website and its respective webpages can be found by typing search queries into popular search engines like Google, Bing, and Yahoo and clicking on the search results for the website and its respective pages. The website and its respective webpages can also be accessed by typing the Uniform Resource Locator (URL) directly into the address bar in the form of a Hypertext Transfer Protocol (HTTP) protocol, domain name, and specific web page. Internet servers or search browsers contain address bars where URLs can be typed. The application for publishing webpages automatically generates a mobile-friendly version of the website and its respective decision engines, information, and methods.

Sophistication comes in the form of creating an online decision engine that covers a wide range of both simple and complex concepts in research and statistics. The online decision engine gives users an automated experience in that they only have to click on buttons in response to questions to get to the correct method or statistical test for their given situation. The decision engine leads users through several important phases of planning and designing a research study. Depending upon the specific needs that students, researchers, or scientists, Research Engineer can be used as a decision engine or just as a reference for methods and information. If users want to use decision engines within Research Engineer, they will have click on buttons with words embedded in them to link to the respective decision engines.

There are two prevalent mnemonic devices presented in the literature that can be used to formulate and refine research questions: FINER (feasible, interesting, novel, ethical, and relevant) and PICO (population, intervention, comparator, and outcome). Within each component of the two mnemonics, certain questions to be asked and pondered by researchers in order to write valid and answerable research questions. Each component of the FINER mnemonic is presented to users in a sequential fashion, followed by the PICO mnemonic. The questions that researchers need to ask themselves to meet the criteria associated with each part of the two mnemonics are presented in the respective webpages of the Research Questions decision engine. Users are prompted to click on buttons with the next component embedded in them to move forward in the decision engine. After working through each of component of the two mnemonics, users are prompted to click on a button that will link them to the Research Designs decision engine.

Within the Research Designs decision engine, users will be presented a series of questions that will lead them to the correct research design, given their current empirical context or environment. Users will click on buttons with different answers to these questions and be linked to other webpages based on the buttons that are clicked. There are a total of five questions that need to be asked to get researchers to the correct research design:

1. Will you randomly select participants from the population of interest?
2. Will you random assign participants to treatment groups?
3. Are you conducting a systematic review?
4. Are you conducting an equivalency trial?
5. Are you conducting a non-inferiority trial?
6. Are you collecting data in a retrospective or prospective fashion?
7. What type of retrospective design will answer your research question?

Based on the answers to the above questions presented in the Research Designs decision engine and the buttons that are clicked by users in response of the aforementioned questions, users can be linked to webpages containing information and methods for conducting case series, case-control, propensity score matching, cross-sectional, retrospective cohort, prospective cohort, quasi-experimental, randomized controlled trial, systematic review, equivalency trial, and non-inferiority trial designs. Two pre-formatted calculators for use in equivalency trials and non-inferiority trials are available for download in webpages in the decision engine. A pre-formatted database for conducting meta-analysis in systematic reviews is also available for download. The calculators and database are downloaded by clicking on a button with the name of the respective calculator or database embedded in it. Diagrams of each research design are presented in the respective webpages of the decision engine. After answering the questions and clicking on buttons with answers embedded in them and being linked to the correct research design for their given empirical situation, users are prompted to click on a button that will link them to the Statistical Power decision engine.

Within the Statistical Power decision engine, users will be presented a series of questions that will lead them through the empirical reasoning associated with choices made by researchers and their effects upon statistical power. A series of Venn diagrams are presented to give context to the reasoning presented on each webpage of the decision engine. Users are asked what the scale of measurement is for their outcome (categorical, ordinal, or continuous) and based on clicking on a button with one of the scales embedded in it, they will be linked to a webpage that presents a description of the effects of the scale of measurement on statistical power. Users are prompted to click on a button to move onto the next part of the decision engine. Users are asked what type of research design is going to be used in their study (between-subjects, within-subjects, or multivariate) and based on clicking on a button with one of the designs embedded in it, they will be linked to a webpage that presents a description of the effects of the design on statistical power. Users are prompted to click on a button to move onto the next part of the decision engine. Users are asked what type of effect size (small effect size or large effect size) they hypothesize exists and based on clicking on a button with one of the effect sizes embedded in it, they will be linked to a webpage that presents a description of the effects of the effect size on statistical power. Users are prompted to click on a button to move onto the next part of the decision engine. Users are asked how much variance they expect to exist in the outcome (limited variance or extensive variance) and based on clicking on a button with one of the variances embedded in it, they will be linked to a webpage that presents a description of the effects of that variance on statistical power. Users are prompted to click on a button to move onto the next part of the decision engine. Users are asked what type of sample size they expect to be able to collect (small sample size or large sample size) and based on clicking on a button with one of the sample sizes embedded in it, they will be linked to a webpage that presents a description of the effects of sample size on statistical power. Users are prompted to click on a button to move onto the next part of the decision engine. Users are asked if they plan on using probability (simple random sampling, stratified random sampling, or clustered random sampling) or non-probability sampling (convenience sampling or purposive sampling) and based on clicking on a button with one of the forms of sampling embedded in it, they will be linked to a webpage that presents a description of the effects of the sampling method. At this point, users are prompted to click on a button that will link them to the Sample Size decision engine.

Within the Sample Size decision engine, users will be presented with a series of buttons with the names of statistical tests embedded in them. Once users click on the button that contains the name of the statistical test they want to calculate a sample size for, they will be linked to the respective webpage where information and methods for conducting and interpreting a sample size calculation for that test in G*Power are presented. Information and methods for conducting and interpreting sample size calculations are available for the following statistical tests: Chi-square, Fisher's Exact Test, odds ratio, Mann-Whitney U, independent samples t-test, one-way ANOVA, McNemar's test, relative risk, Wilcoxon, repeated-measures t-test, repeated-measures ANOVA, point biserial, and Pearson's r. After being linked to the type of sample size calculation users need and the information and methods are presented, users are prompted to click on a button that will link them to the Statistics decision engine.

Within the Statistics decision engine, users will be presented with a series of questions related to choosing the correct statistical test to answer their research question. The correct choice of statistical test is dependent upon the answers to the following questions:

1. What type of research design are you using?
2. What is the scale of measurement of your outcome?
3. How many independent groups are you comparing?
4. How many observations of the outcome are you collecting?
5. Are you predicting for a dichotomous categorical outcome? A polychotomous categorical outcome? An ordinal outcome? A continuous outcome? A count outcome? Are you conducting survival analysis? Are you using a factorial design (fixed-effects, random-effects, mixed effects)? Are you adjusting a continuous outcome? Are you comparing independent groups on multiple outcomes?
6. Have you met the statistical assumptions associated with conducting the statistical test?

Once users have answered these questions and click on buttons with their answers to the questions embedded in them, they will be linked to the respective webpage where information and methods for conducting and interpreting the statistical test in SPSS are presented. The following statistical tests are integrated into the Statistics decision engine: Mean, median, mode, variance, standard deviation, interquartile range, frequency, cross-tabulation, Chi-square Goodness-of-Fit, one-sample median test, one-sample t-test, Chi-square test of independence to yield unadjusted odds ratios with 95% confidence intervals, Mann-Whitney U, skewness, kurtosis, Levene's Test of Equality of Variances, independent samples t-test, unadjusted odds ratios with 95% confidence intervals, Kruskal-Wallis, one-way ANOVA, logarithmic transformations, Bonferroni, Tukey's test, Scheffe's test, baseline frequency, baseline median, baseline observation, McNemar's test, Wilcoxon, repeated-measures t-test, Cochran's Q, relative risk with 95% confidence intervals, Friedman's ANOVA, Mauchly's Test of Sphericity, repeated-measures ANOVA, Greenhouse-Geisser, phi-coefficient, point biserial, rank biserial, biserial, Spearman's rho, Pearson's r, logistic regression, multinomial logistic regression, proportional odds regression, Kaplan-Meier, Cochran-Mantel-Haenszel, Cox regression, fixed-effects ANOVA, random-effects ANOVA, mixed-effects ANOVA, ANCOVA, multiple regression, MANOVA, MANCOVA, negative binomial regression, Poisson regression, simultaneous regression, stepwise regression, hierarchical regression, residual analysis, normal probability plots, linearity, exploratory factor analysis, confirmatory factor analysis, bootstrap validation, and split-half validation. A pre-formatted database for conducting each statistical test is also available for download in each respective webpage. The database is downloaded by clicking on a button with the name of the respective database embedded in it. Diagrams of each statistical test are presented in the respective webpages of the decision engine. After answering the questions and clicking on buttons with answers embedded in them and being linked to the correct statistical test for their given empirical situation, users are prompted to click on a button that will link them to the Databases decision engine.

Within the Databases decision engine, users are asked what kind of database is used to enter, manipulate, and analyze data for the statistical test they are using in their research project. There are three kinds of database structures that are used given the type of research design or statistical test being used: Between-subjects, within-subjects, and multivariate. Once users choose the type of database they need, the will click on a button with the name of the database embedded in it. Users are linked to a webpage with information and methods for designing and constructing the database. Users are also able to click a button with the name of the database embedded in it to download the database. Another button in the webpage will allow users to download a code book to coincide with their chosen database. After answering the questions and clicking on buttons with answers embedded in them and being linked to the correct database and downloading the database and code book, users are prompted to click on a drop-down menu at the top of the website and click on any type of decision engine that is needed to answer their research question. The types of decision engines available to users of Research Engineers include evidence-based medicine, epidemiology, diagnostic testing, variables, surveys, psychometrics, education, store, Statistical Forum blog, calculators, search, and sitemap.

One of the decision engines that users can be linked to by search engine, URL, or clicking on a button in the website is the Evidence-Based Medicine decision engine. This decision engine is used to help students and researchers find, appraise, interpret, and apply clinical evidence using five sequential steps. The decision engine helps researchers ask relevant clinical questions, acquire quality evidence, critically appraise clinical evidence, apply clinical evidence, and assess evidence-based interventions. Users are prompted to click on a button to be linked to a webpage where information and methods for writing background and foreground questions and the PICO mnemonic that is employed with foreground questions. Users are given information on where to find potential knowledge gaps in clinical practice and then are prompted to click on a button that will link them to a webpage focused on acquiring clinical evidence. Information and methods for acquiring the highest level of clinical evidence available are presented. The PICO mnemonic is used in literature search queries to improve upon the specificity or “correctness” of search results. The 6S approach to ranking the validity and generalizability of clinical evidence is presented. The institutions, journals, and publishers of clinical evidence are presented as well.

Users are then prompted to click on a button that links them to a webpage focused on teaching researchers how to critically appraise different types of clinical evidence. Users can click on any five buttons with the different types of evidence embedded in them and be linked to the respective webpages where questions are presented to users that relate directly towards the important parts of critically appraising that type of evidence. There are a total of ten different types of evidence that can be appraised by clicking on buttons with their names embedded in them: Individual randomized controlled trials, systematic reviews, qualitative studies, clinical decision analyses, economic analyses, clinical practice guidelines, diagnosis, screening, prognosis, and harm evidence. Once users are presented the questions related to critically appraising the type of evidence, they are prompted to click on a button that links them to a webpage related to applying that type of evidence. Users are presented with a series of question that relate directly towards the important parts of applying clinical evidence in their current environment. Once users are presented the questions related to applying clinical evidence with their patients, they are prompted to click on a button that links them to a webpage related to assessing evidence-based clinical practice. Users are presented a series of questions related to assessing their asking of clinical questions to fill knowledge gaps. They are then prompted to click on a button linking them to a webpage containing questions related to assessing their acquiring of clinical evidence. Once users are presented these questions, they are prompted to click on a button linking them to a webpage containing questions related to assessing their ability to critically appraise clinical evidence. They are then prompted to click on a button linking them to a webpage containing questions related to applying clinical evidence in their practice. Once users are presented these questions, they are prompted to click on a button linking them to a webpage containing questions related to meta-assessment of evidence-based medical practice.

One of the decision engines that users can be linked to by search engine, URL, clicking on a button in the website is the Epidemiology decision engine. This decision engine provides information and methods for calculating epidemiological measures like odds ratios, prevalence, relative risk, incidence, control event rate (CER), experimental event rate (EER), absolute risk reduction (ARR), absolute risk increase (ARI), number needed to treat (NNT), and number needed to harm (NNH). Users are prompted to click on buttons with the different calculations embedded in them to move through the decision engine. As it pertains to testing for treatment effects, users first click on a button to be linked to the CER webpage where information and methods for calculating and interpreting CER are presented. Users are prompted to click on a button to be linked to EER webpage where information and methods for calculating and interpreting EER are presented. Users are then prompted to click on a button to be linked a webpage where they are asked if they are assuming the treatment will produce an efficacious or detrimental effect on patients. If users click on a button related to an efficacious effect, they are linked to a webpage where information and methods for calculating and interpreting ARR are presented. Users are then prompted to click on a button to be linked to the NNT webpage where information and methods for calculating and interpreting NNT are presented. If users click on a button related to a detrimental effect, they are linked to a webpage where information and methods for calculating and interpreting ARI are presented. Users are then prompted to click on a button to be linked the NNH webpage where information and methods for calculating and interpreting NNH are presented. Once users are linked to either the NNT or NNH webpage, given their current empirical context, they are prompted to click on a button that allows them to download a calculator formatted to calculate odds ratios, relative risk, CER, EER, ARR, ARI, NNT, and NNH. Users can also click on a button that allows them to download a database that is formatted for epidemiological data entry, manipulation, and analysis.

One of the decision engines that users can be linked to by search engine, URL, or clicking on a button in the website is the Diagnostic Testing decision engine. This decision engine provides information and methods for calculating diagnostic testing measures like sensitivity, specificity, receiver operator characteristic (ROC), positive predictive value (PPV), negative predictive value (NPV), and total diagnostic accuracy. Users are prompted to click on buttons with the different calculations embedded in them to move through the decision engine. As it pertains to conducting diagnostic testing, users first click on a button to be linked to the sensitivity webpage where information and methods for calculating and interpreting sensitivity are presented. Users are prompted to click on a button to be linked to the specificity webpage where information and methods for calculating and interpreting specificity are presented. Users are then prompted to click on a button to be linked to a webpage where they are asked if they are attempting to establish cut-points for maximizing the sensitivity and specificity of a diagnostic test or if they are comparing the diagnostic ability of different tests. Information and methods for conducting and interpreting ROC analysis to answer both the aforementioned questions are presented. After the presentation of ROC analysis, users are prompted to click on a button to be linked to the PPV webpage where information and methods for calculating and interpreting PPV are presented. Users are prompted to click on a button to be linked to the NPV webpage where information and methods for calculating and interpreting NPV are presented. Once the NPV webpage is presented, users are prompted to click on a button to be linked to the total diagnostic accuracy webpage where information and methods for calculating and interpreting total diagnostic accuracy are presented. Once users are linked any of the webpages in the Diagnostic Testing decision engine, they are prompted to click on a button that allows them to download a calculator formatted to calculate sensitivity, specificity, PPV, NPV, and total diagnostic accuracy.

One of the decision engines that users can be linked to by search engine, URL, or clicking on a button in the website is the Variables decision engine. This decision engine provides information and methods for measuring different types of variables and understanding scales of measurement and their subsequent effects on statistical power. Information and methods for the following scales of measurement and types of variables are presented in webpages of the decision engine: Categorical variables, nominal variables, ordinal variables, interval variables, ratio variables, continuous variables, count variables, independent variables, dependent variables, predictor variables, outcome variables, confounding variables, demographic variables, and control variables. From the Variables decision engine, users can click on a button and be linked to the scales of measurement webpage where information and methods related to measurement are presented. Users are prompted to click on buttons with the different scales of measurement embedded in them and be linked to the respective webpages where information and methods related to the scale of measurement are presented. From the Variables decision engine, users can click on a button and be linked to the types of variables webpage where information and methods related to using different kinds of variables are presented. Users are prompted to click on buttons with the different types of variables embedded in them and be linked to the respective webpages where information and methods related to the type of variable are presented.

One of the decision engines that users can be linked to by search engine, URL, or clicking on a button in the website is the Surveys decision engine. This decision engine provides a validated eight-step method for creating a survey instrument to measure for a construct or phenomenon of interest. There are eight steps in the methodology:

1. Construct specification
2. Expert review
3. Survey methodology

a. Survey parts

b. Survey types

c. Survey modes of administration

4. Writing survey items
5. Survey pretest
6. Survey structure
7. Pilot study
8. Validation study

From the Surveys decision engine webpage, users are prompted to click on a button to be linked to the construct specification page. Users are given information and methods related to construct specification and can click on a button to download a construct specification template that can be used in their research. Users are prompted to click on a button and be linked to the expert review webpage where information and methods for getting expert review of the construct specification are presented. Users are then prompted to click on a button and be linked to the survey methodology webpage where information and methods for selecting a survey methodology are presented. Users are then prompted to click on a button and be linked to the survey parts webpage where information and methods for creating the six parts of a survey are presented. Users are then prompted to click on a button and be linked to the survey types webpage where information and methods for selecting the correct type of instrument based on research questions are presented. Users are then prompted to click on a button and be linked to the survey modes of administration webpage where information and methods for five different modes of survey administration are presented. Users are then prompted to click on a button and be linked to the writing survey items webpage where information and methods for writing valid survey item stems and response sets that cover content areas are presented. Users are then prompted to click on a button and be linked to the survey pretest webpage where information and methods for pretesting the survey are presented. Users can click on a button to download a focus group template for conducting survey pretests with members of the population. Users are then prompted to click on a button and be linked to the survey structure webpage where information and methods for structuring a survey for formal presentation to survey participants are presented. Users are then prompted to click on a button and be linked to the pilot study webpage where information and methods for conducting pilot studies of survey instruments and conducting reliability and factor analysis are presented. Users are then prompted to click on a button and be linked to the validation webpage where information and methods for conducting validation studies of survey instruments and conducting validity and confirmatory factor analysis are presented. Users can click on a button to download a database structured to conduct psychometric analyses.

One of the decision engines that users can be linked to by search engine, URL, or clicking on a button in the website is the Psychometrics decision engine. This decision engine provides information and methods for conducting and interpreting different types of reliability and validity calculations. Information and methods for the following types of reliability are presented: Internal consistency reliability, Cronbach's alpha, split-half reliability, Kudar-Richardson (KR-20), test-retest reliability, Spearman-Brown, alternative/parallel forms reliability, inter-rater reliability, Kappa, intraclass correlation coefficient (ICC) and exploratory factor analysis. Information and methods for the following types of validity are presented: Construct validity, concurrent validity, predictive validity, content validity, known-groups validity, convergent validity, divergent validity, incremental validity, face validity, and confirmatory factor analysis. Users can click on a button in the decision engine and be linked to the reliability webpage where information and methods related to understanding reliability are presented. Users can click on a button and be linked to the internal consistency reliability webpage where information and methods for understanding three measures of internal consistency reliability. Users can click on a button and be linked to the Cronbach's alpha webpage where information and methods for conducting and interpreting the reliability statistic are presented. Users can also click on a button and be linked to the split-half reliability webpage where information and methods for conducting and interpreting the reliability statistic are presented. Users can also click on a button and be linked to the KR-20 webpage where information and methods for conducting and interpreting the reliability statistic are presented. Users can click on a button and be linked to the test-retest reliability webpage where information and methods for conducting and interpreting test-retest reliability and Spearman-Brown are presented. Users can click on a button and be linked to the alternate/parallel forms reliability webpage where information about the type of reliability is presented. Users can click on a button and be linked to the inter-rater reliability webpage where information about inter-rater reliability is presented. Users can click on a button and be linked to the Kappa webpage where information and methods for conducting and interpreting the inter-rater reliability analysis are presented. Users can also click on a button and be linked to the ICC webpage where information and methods for conducting the inter-rater reliability analysis are presented. In each webpage of the reliability section of the Psychometrics decision engine, users can click on a button to download a pre-formatted database structured for running the reliability analysis. Users can also click on a button be linked to the exploratory factor analysis webpage where information and methods for conducting and interpreting factor analysis are presented. In each webpage, users can also click on a button and be linked to the validity section of the Psychometrics decision engine. From the Psychometrics decision engine, users can click on buttons with types of validity evidence embedded in it and be linked to the respective webpages with information and methods for calculating and interpreting validity analyses. Users can click on a button and be linked to the construct validity webpage where information about the nature of validity evidence is presented. Users can click on a button and be linked to the concurrent validity webpage where information and methods for conducting and interpreting correlation analyses are presented. Users can click on a button and be linked to the predictive validity webpage where information and methods for conducting and interpreting correlation analyses are presented. Users can click on a button and be linked to the content validity webpage where information about covering a content area is presented. Users can click on a button and be linked to the known-groups validity webpage where information and methods for conducting and interpreting between-subjects comparisons are presented to establish this form of validity evidence. Users can click on a button and be linked to the convergent validity webpage where information and methods for conducting and interpreting correlation analyses are presented. Users can click on a button and be linked to the divergent validity webpage where information and methods for conducting and interpreting correlation analyses are presented. Users can click on a button and be linked to the incremental validity webpage where information and methods for conducting and interpreting stepwise regression are presented. Users can click on a button and be linked to the face validity webpage where information about this form of evidence is presented. Users can click on a button and be linked to the confirmatory factor analysis webpage where information and methods for conducting and interpreting confirmatory factor analysis are presented. In each webpage of the validity section of the Psychometrics decision engine, users can click on a button to download a pre-formatted database structured for running the validity analysis. Users can also click on a button and be linked to the confirmatory factor analysis webpage.

One of the decision engines that users can be linked to by search engine, URL, or clicking on a button in the website is the Education decision engine. The decision engine provides information and methods for writing instructional goals and objectives using 54 verbs derived from Bloom's Taxonomy. Users can also access information about Maslow's Hierarchy of Needs and a dictionary for research and statistical terminology. Users can click on a button and be linked to the writing instructional goals and objectives webpage where an explanation of the use of action verbs from Bloom's Taxonomy in writing instructional goals and objectives is presented. Users can also click on a button and be linked to an online dictionary for a wide range of empirical and statistical terms. The terms are defined and text links are embedded into the webpage to link users to the respective webpages with the website.

From a drop-down menu at the top of each webpage, users can be linked to any of the decision engines in Research Engineer by clicking on the name of the engine. Users can also be linked to a store webpage where statistical consultation hours can be purchased using a secure and encrypted online commerce agent. Users can also be linked to a blog related to applied research and statistical methods called Statistical Forum. Users can also be linked to a webpage where buttons with calculator names embedded in them to download the calculators. Users can download an equivalency trial calculator, a non-inferiority trial calculator, an epidemiological calculator, and a diagnostic testing calculator. Users can also be linked to a search webpage where internal and external search engines are made available. Users can also be linked to a sitemap of Research Engineer.

At the top and bottom of each webpage in Research Engineer, users can enter text search queries into internal search engines and be able to conduct a website-wide search for that particular query. Users are presented with a results webpage for the search query and can click on text links to be linked to the respective webpages in Research Engineer related to the topic.

In each webpage of Research Engineer, users can enter text search queries into a pre-formatted Google search engine designed to yield more specific search results related to external websites. Users are presented with a results webpage for the search query and can click on text links to be linked to the respective search findings yielded from Google's search algorithm.

In each webpage of Research Engineer, users can click on social buttons that link them to the social websites related to Research Engineer. Users can click on the social buttons to access the aforementioned social websites to create online social connections within social media websites such as Google+, Facebook, Twitter, and LinkedIn.

### OPERATION OF INVENTION

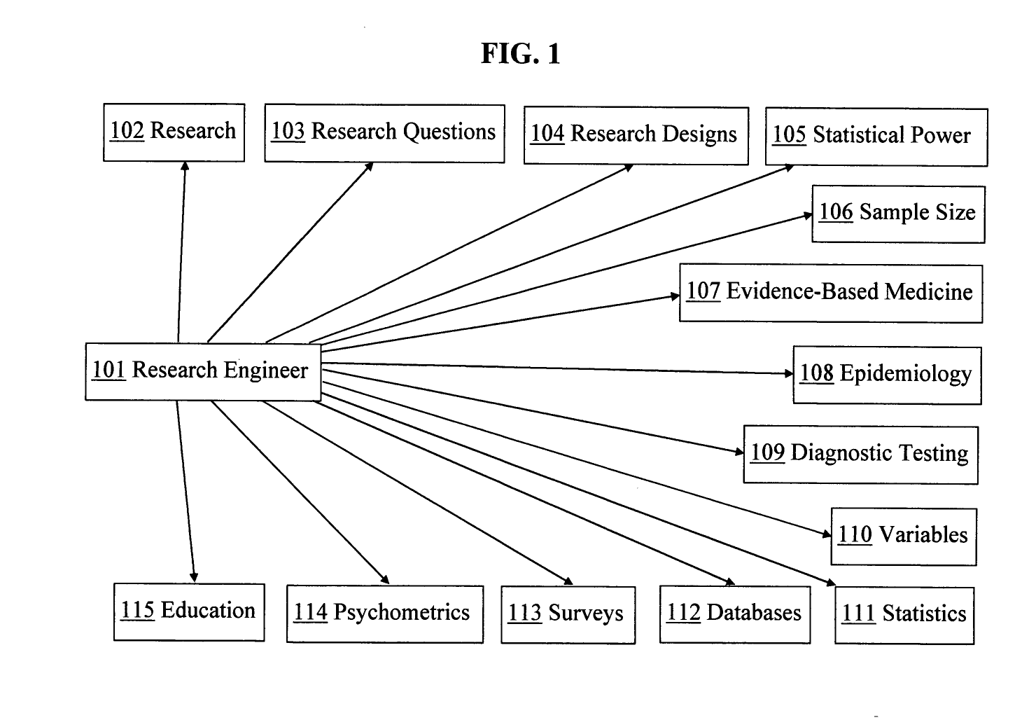

FIG. 1. Research Engineer (101) is accessed via search engine, URL, or clicking on buttons or links. From this webpage, users can click on buttons that will take them to all of the respective decision engines within Research Engineer. Buttons in the Research Engineer (101) webpage include research (102), research questions (103), research designs (104), statistical power (105), sample size (106), evidence-based medicine (107), epidemiology (108), diagnostic testing (109), variables (110), statistics (111), databases (112), surveys (113), psychometrics (114), and education (115).

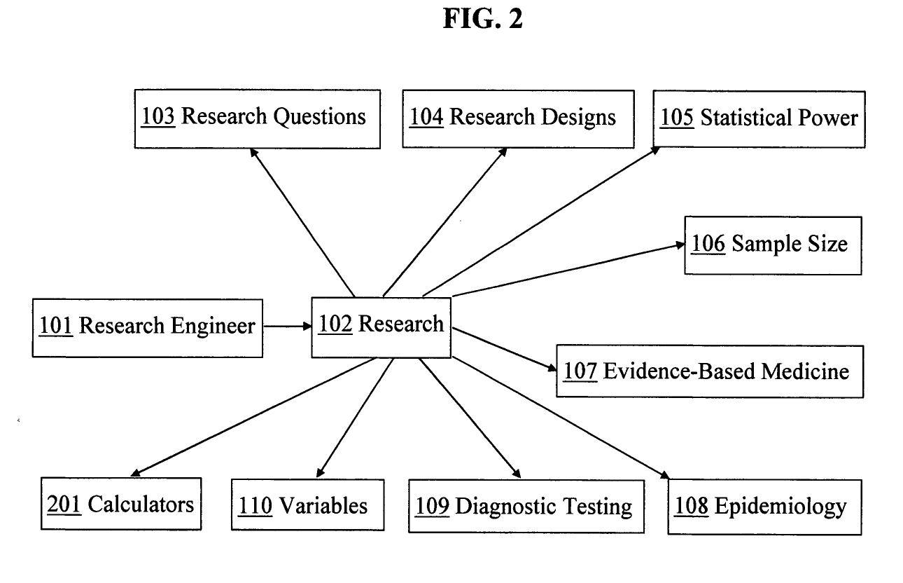

FIG. 2. The Research (102) webpage allows users to click on buttons to access all of the decision engines associated with conducting a research project. Buttons in the Research (102) webpage include research questions (103), research designs (104), statistical power (105), sample size (106), evidence-based medicine (107), epidemiology (108), diagnostic testing (109), variables (110), and calculators (201). The Calculators webpage allows users to download calculators for equivalency trials, non-inferiority trials, sample size, epidemiological calculations, and diagnostic testing calculations.

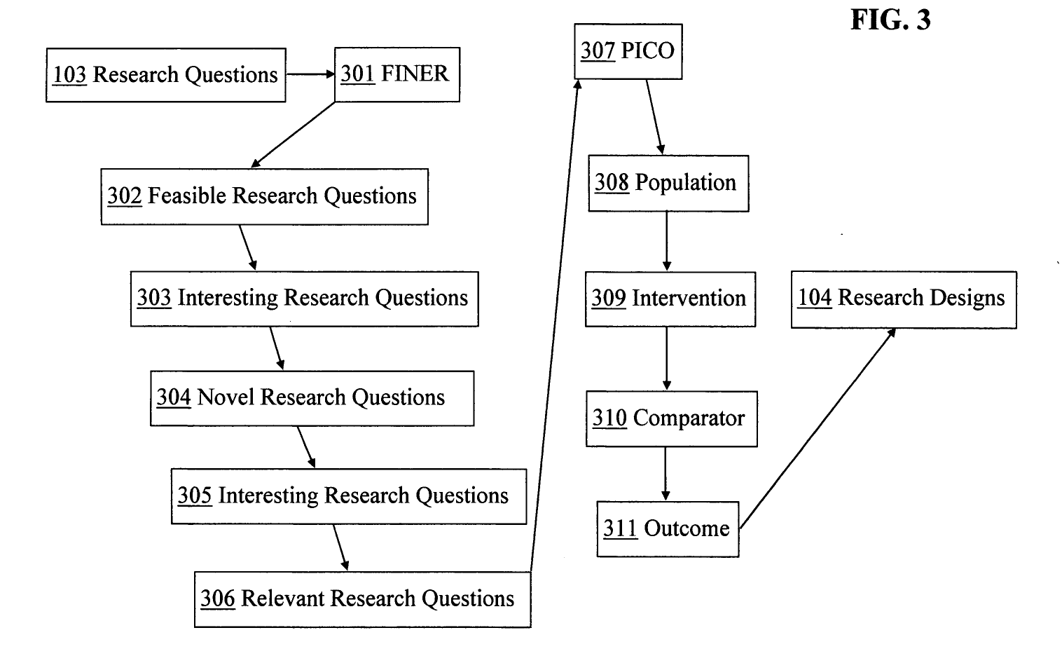

FIG. 3. The Research Questions (103) webpage allows users to the start the decision engine for formulating and refining research questions. By clicking on a button with the word FINER embedded into it, the user will be linked to the FINER (301) webpage. Users will be presented with information regarding FINER mnemonic in the webpage. Users will be prompted to click on buttons at the bottom of each webpage to navigate to next part of the mnemonic. In the FINER webpage, users will be prompted to click on a button with the words “Feasible Research Questions” embedded into it and will be linked to the Feasible Research Questions (302) webpage. Questions related to writing feasible research questions are presented. Users are prompted at the bottom of the webpage to click on a button with the words “Interesting Research Questions” embedded into it. They will be linked to the Interesting Research Questions (303) webpage. Questions related to writing interesting research questions are presented. Users are prompted at the bottom of the webpage to click on a button with the words “Novel Research Questions” embedded into it. Users will be linked to the Novel Research Questions (304) webpage. Questions related to writing novel research questions are presented. Users are prompted at the bottom of the webpage to click on a button with the words “Ethical Research Questions” embedded into it. Users will be linked to the Ethical Research Questions (305) webpage. Questions related to writing ethical research questions are presented. Users are prompted at the bottom of the webpage to click on a button with the words “Relevant Research Questions” embedded into it. Users will be linked to the Relevant Research Questions (306) webpage. Users are prompted at the bottom of the webpage to click on a button with the word “PICO” embedded into it. Users will be linked to the PICO (307) webpage. Users will be presented with information regarding the PICO mnemonic in the webpage. Users are prompted at the bottom of the webpage to click on a button with the word “Population” embedded into it. Users will be linked to the Population (308) webpage. Users will be presented with information about defining populations in research questions. Users are prompted at the bottom of the page to click on a button with the word “Intervention” embedded into it. Users will be linked to the Intervention (309) webpage. Users will be presented with information about adding interventions into research questions. Users are prompted at the bottom of the page to click on a button with the word “Comparator” embedded into it. Users will be linked to the Comparator (310) webpage. Users will be presented with information about adding comparators into research questions. Users are prompted at the bottom of the page to click on a button with the word “Outcome” embedded into it. Users will be linked to the Outcome (311) webpage. Users will be presented with information about adding outcomes to their research questions. Users will then be prompted to click on a button with the words “Research Designs” embedded into it. Users will be linked to the Research Designs (104) decision engine.

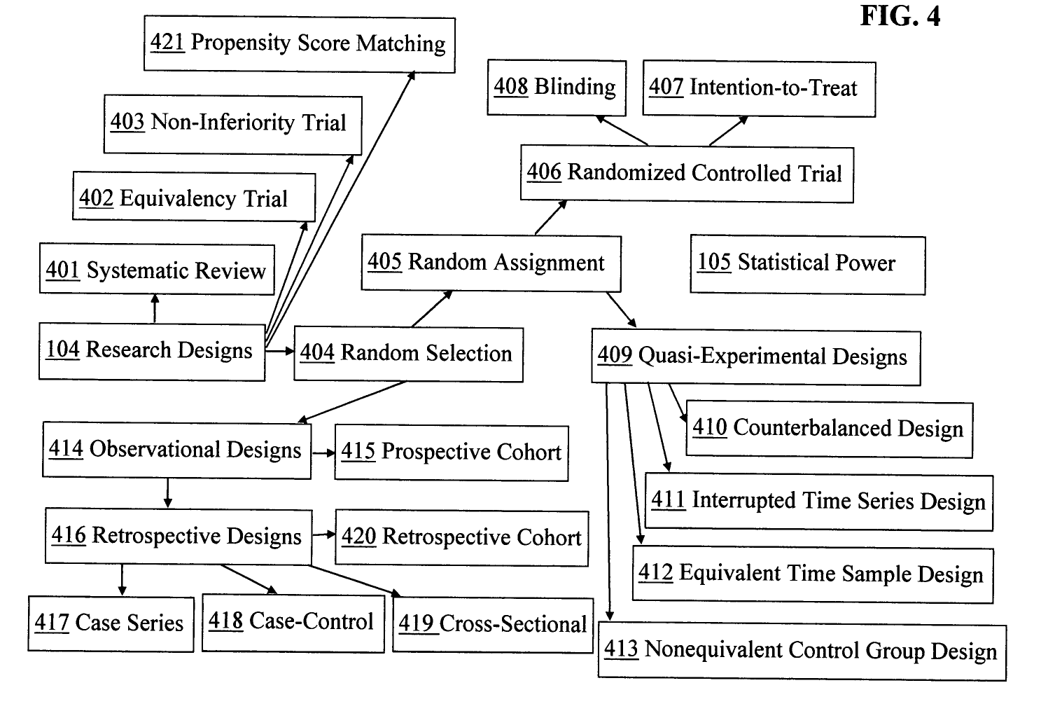

FIG. 4. The Research Questions (104) webpage allows users to the start the decision engine for choosing the most feasible research design for their research question. In the webpage, users can click on a button with the words “Systematic Review” embedded into it and be linked to the Systematic Review (401) webpage. Users will be presented with information and methods for conducting a systematic review and have the chance to download a calculator for meta-analysis, the statistical test used in a systematic review. Users can click on a button with the words “Equivalency Trial” embedded into it and be linked to the Equivalency Trial (402) webpage. Users will be presented with information and methods for conducting an equivalency trial and will have the chance to download a calculator for establishing equivalency. Users can click on a button with the words “Non-inferiority Trial” embedded into it and be linked to the Non-Inferiority Trial (403) webpage. Users will be presented with information and methods for conducting a non-inferiority trial and will have the chance to download a calculator for establishing non-inferiority.

Next, on the Research Questions (104) webpage, users are asked if they are going to use random selection (404) in their study. If they click on the button with the word “Yes” embedded in it, they will be linked to the Random Assignment (405) webpage. Users are asked if they plan to use random assignment in their study. If they click on the button with the word “Yes” embedded in it, then they will be linked to the Randomized Controlled Trial webpage. Information and methods for conducting a randomized controlled trial will be presented. Users are also prompted to click buttons with the words “Intention-to-Treat” and “Blinding” embedded in them. The Intention-to-Treat (407) webpage provides information and methods for conducting analyses in randomized controlled trials. The Blinding (408) webpage provides information and methods for single-, double-, and triple-blinded studies.

If users click on a button with the word “No” embedded in it in the Random Assignment (405) webpage, then they are linked to the Quasi-Experimental Designs (409) webpage. Users are asked what type of quasi-experimental design will best answer their research question and have the choice of clicking on any of four buttons corresponding to four popular quasi-experimental designs. Users can click on the button with the word “Counterbalanced Design” embedded into it and be linked to the Counterbalanced Design (410) webpage where information and methods for the design are presented. Users can click on the button with the words “Interrupted Time Series Design” embedded in it and be linked to the Interrupted Time Series Design (411) webpage where information and methods for the design are presented. Users can click on the button with the words “Equivalent Time Samples Design” embedded in it and be linked to the Equivalent Time Samples Design (412) webpage where information and methods for the design are presented. Users can click on the button with the words “Nonequivalent Control Group Design” embedded in it and be linked to the Nonequivalent Control Group Design (413) webpage where information and methods for the design are presented.

If users click on a button with the word “No” embedded in it in the Random Selection (404) webpage, then they are linked to the Observational Designs (414) webpage. Users are asked what type of observational design will best answer their research question and have the choice of clicking on buttons corresponding to different types of observational designs. Users can click on a button with the word “Prospective” embedded in it and be linked to the Prospective Cohort (415) webpage where information and methods for the design are presented. Users can click on a button with the word “Retrospective” embedded in it and be linked to the Retrospective Designs (416) webpage. Users are asked what type of retrospective design will best answer their research question and have the choice of clicking on any of four buttons corresponding to different types of retrospective observational designs. Users can click on a button with the words “Case Series” embedded in it and be linked to the Case Series (417) webpage where information and methods for the design are presented. Users can also click on a button with the words “Case-Control” embedded in it and be linked to the Case-Control (418) webpage where information and methods for the design are presented. Another option is for users to click on a button with the words “Cross-Sectional” embedded in it and be linked to the Cross-Sectional (419) webpage where information and methods for the design are presented. Lastly, users can click on a button with the words “Retrospective Cohort” embedded in it and be linked to the Retrospective Cohort (420) webpage where information and methods for the design are presented.

From the Research Designs (104) webpage, users can click on a button with the words “Propensity Score Matching” embedded in it and be linked to the Propensity Score Matching (421) webpage where information and methods for conducting this technique are presented. Upon completion of the Research Designs decision engine and reaching any of the aforementioned webpages, users are prompted to click on a button with the words “Statistical Power” embedded in it and be linked to the Statistical Power (105) decision engine.

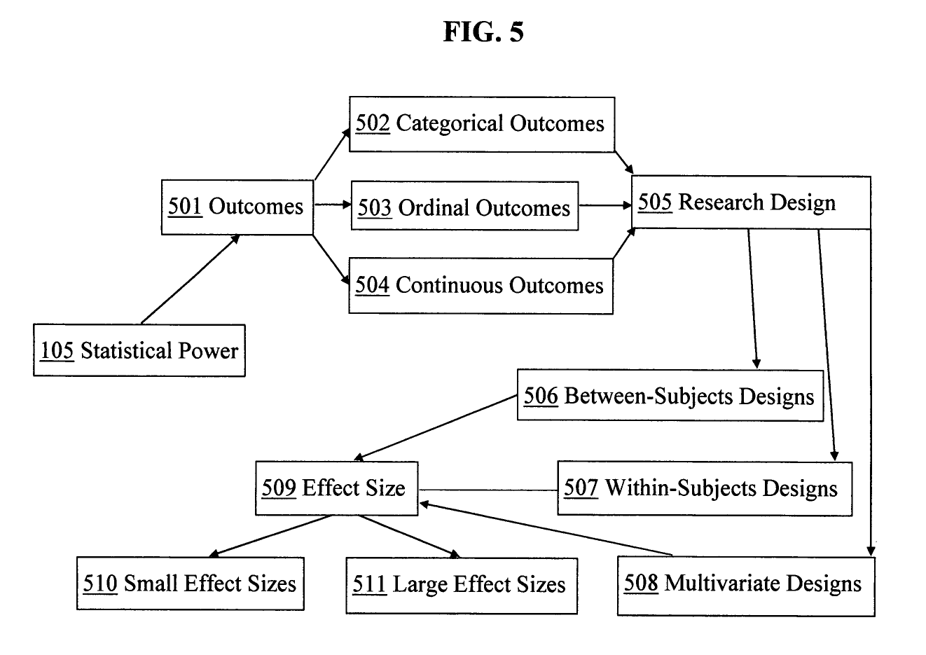

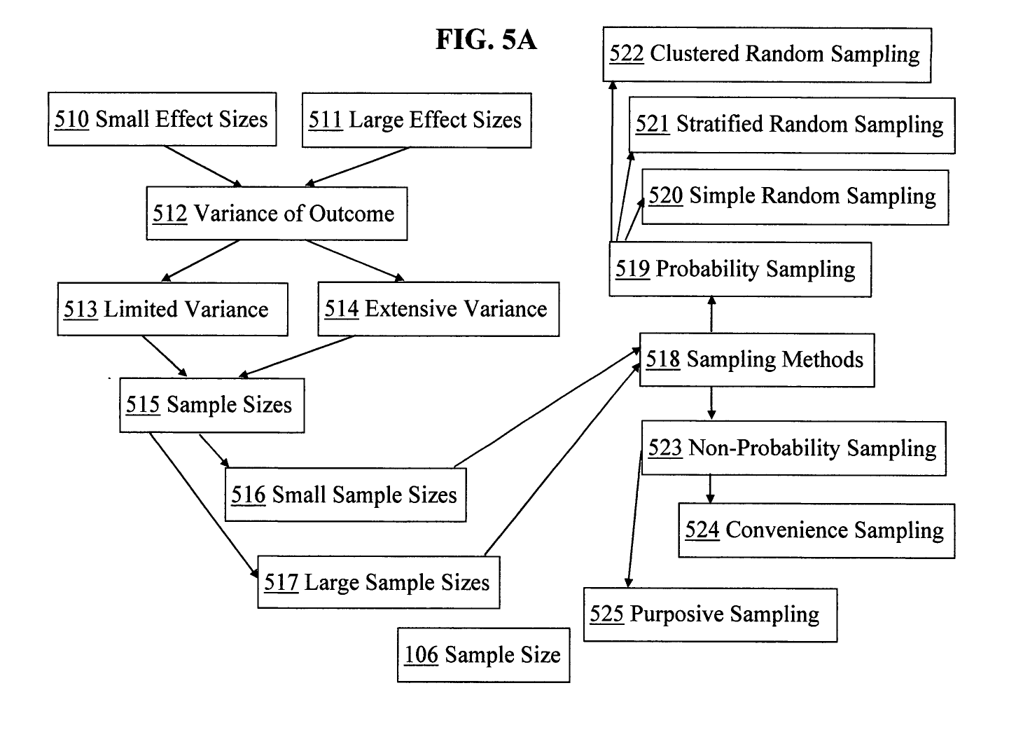

FIG. 5. The Statistical Power (105) webpage allows users to start the decision engine for understanding the effects of certain empirical decisions on statistical power. An explanation of the interdependencies between research design, scale of measurement of outcome, magnitude of effect size, variance of effect size, sample size, and statistical power are presented using Venn diagrams. Users are prompted to click on a button to start the Statistical Power decision engine.

After clicking on the button in the Statistical Power (105) webpage, users will be linked to the Outcomes (501) webpage. Users are asked what the scale of measurement is for the outcome. If users are employing a categorical outcome, they will click on a button with the word “Categorical” embedded into it and be linked to the Categorical Outcomes (502) webpage where the effects of this type of measurement on statistical power are explained. If users measure outcomes at an ordinal level, they will click on a button with the word “Ordinal” embedded in it and be linked to the Ordinal Outcomes (503) webpage where the effects of this type of measurement on statistical power are explained. If a continuous outcome is being used, users will click on a button with the word “Continuous” embedded in it and be linked to the Continuous Outcomes (504) webpage where the effects of this type of measurement on statistical power are explained. Upon navigating to any of the webpages (502-504), users will be prompted to click on a button with the words “research design and power” embedded in it. Users will be linked to the next part of the Statistical Power decision engine, the Research Design (505) webpage.

In the Research Design (505) webpage, users are asked what type of research design they are using in their study. If users are employing a between-subjects design, they will click on a button with the words “Between-Subjects” embedded in it and be linked to the Between-Subjects Designs (506) webpage where the effects of this type of research design on statistical power are explained. If users choose a within-subjects design, they will click on a button with the words “Within-Subjects” embedded in it and be linked to the Within-Subjects Designs (507) webpage where the effects of this type of research design on statistical power are explained. If a multivariate design is being used, users will click on a button with the words “Multivariate” embedded in it and be linked to the Multivariate Designs (508) webpage where the effects of this type of research design on statistical power are explained. Upon navigating to any of the webpages (506-508), users will be prompted to click on a button with the words “Magnitude of Effect Size” embedded in it. Users will be linked to the next part of the Statistical Power decision engine, the Effect Size (509) webpage.

In the Effect Size (509) webpage, users are asked how large of an effect size (magnitude) they expect will occur in their research study. If users believe that a small effect size will be detected, they will click on a button with the words “Small Effect Sizes” embedded in it and be linked to the Small Effect Sizes (510) webpage where the effects of small effect sizes on statistical power are explained. If a large effect size is hypothesized, users will click on a button with the words “Large Effect Sizes” embedded in it and be linked to the Large Effect Sizes (511) webpage where the effects of large effect sizes on statistical power are explained. Upon navigating to either of the webpages (510-511), users will be prompted to click on a button with the words “Variance of Outcome” embedded in it. Users will be linked to the next part of the Statistical Power decision engine, the Variance of Outcome (512) webpage.

In the Variance of Outcome (512) webpage, users are asked how much variance they expect will occur in the outcome in their research study. If users believe that the outcome will have limited variance, they will click on a button with the word “Limited” embedded in it and be linked to the Limited Variance (513) webpage where the effects of limited variance on statistical power are explained. If users believe that the outcome will have extensive variance, they will click on a button with word “Extensive” embedded in it and be linked to the Extensive Variance (514) webpage where the effects of extensive variance on statistical power are explained. Upon navigating to either of the webpages (513-514), users will be prompted to click on a button with the words “Sample Sizes” embedded in it. Users will be linked to the next part of the Statistical Power decision engine, the Sample Sizes (515) webpage.

In the Sample Sizes (515) webpage, users are asked if they will have access to a relatively small or large sample of participants. If users believe that they will have access to a small sample, they will click on a button with the word “Small” embedded in it and be linked to the Small Sample Sizes (516) webpage where the effects of small sample sizes on statistical power are explained. If users have access to a large sample, they will click on a button with the word “Large” embedded in it and be linked to the Large Sample Sizes (517) webpage where the effects of large sample sizes on statistical power are explained. Upon navigating to either of the webpages (516-517), users will be prompted to click on a button with the words “Sampling Methods” embedded in it. Users will be linked to the next part of the Statistical Power decision engine, the Sampling Methods (518) webpage.

In the Sampling Methods (518) webpage, users are asked if they plan on using probability or non-probability sampling methods. If users plan on using probability sampling, they will click on a button with the words “Probability” embedded in it and be linked to the Probability Sampling (519) webpage. From this webpage, users are given the choice of three different types of probability sampling methods. Users can click on a button with the words “Simple Random Sampling” embedded in it and be linked to the Simple Random Sampling (520) webpage where information and methods for conducting the sampling technique are presented. If users want to randomly sample from strata in a population, they can click on a button with the words “Stratified Random Sampling” embedded in it and be linked to the Stratified Random Sampling (521) webpage where information and methods for conducting the sampling technique are presented. If users want to randomly sample from naturally existing clusters in a population, they can click on a button with the words “Clustered Random Sampling” embedded in it and be linked to the Clustered Random Sampling (522) webpage where information and methods for conducting the sampling technique are presented.

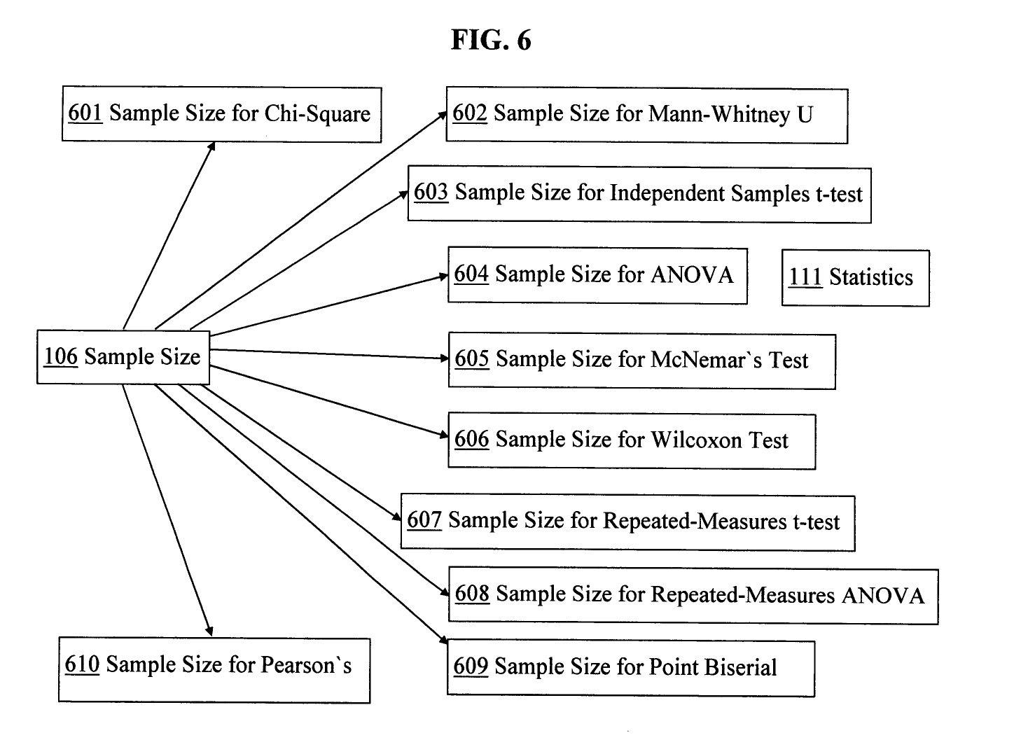

In the Sampling Methods (518) webpage, users can click on a button with the words “Non-Probability” embedded in it and be linked to the Non-Probability Sampling (523) webpage. From this webpage, users are given the choice of two different types of non-probability sampling methods. Users can click on a button with the words “Convenience Sampling” embedded in it and be linked to the Convenience Sampling (524) webpage where information and methods for conducting the sampling technique are presented. If users want to purposefully seek out participants, they can click on a button with the words “Purposive Sampling” embedded in it and be linked to the Purposive Sampling (525) webpage where information and methods for conducting the sampling technique are presented. Upon completion of the Sampling Methods (518) section of the Statistical Power decision engine and reaching any of the aforementioned webpages, users are prompted to click on a button with the words “Sample Size” embedded in it. Users will be linked to the Sample Size (106) webpage. FIG. 6. The Sample Size (106) webpage allows users to access information and methods about calculating sample size for ten different statistical tests using the open-source program, G*Power. Users are prompted to click on any of the ten buttons in the Sample Size (106) webpage. If users click on a button with the words “Sample Size for Chi-Square” embedded in it, they will be linked to the Sample Size for Chi-Square (601) webpage where the methods for conducting a sample size calculation for a Chi-square test are presented. If users click on a button with the words “Sample Size for Mann-Whitney U” embedded in it, they will be linked to the Sample Size for Mann-Whitney U (602) webpage where the methods for conducting a sample size calculation for a Mann-Whitney U test are presented. If users click on a button with the words “Sample Size for Independent Samples t-test” embedded in it, they will be linked to the Sample Size for Independent Samples t-test (603) webpage where the methods for conducting a sample size calculation for an independent samples t-test are presented. If users click on a button with the words “Sample Size for ANOVA” embedded in it, they will be linked to the Sample Size for ANOVA (604) webpage where the methods for conducting a sample size calculation for an ANOVA are presented. If users click on a button with the words “Sample Size for McNemar's Test” embedded in it, they will be linked to the Sample Size for McNemar's Test (605) webpage where the methods for conducting a sample size calculation for a McNemar's Test are presented. If users click on a button with the words “Sample Size for Wilcoxon” embedded in it, they will be linked to the Sample Size for Wilcoxon (606) webpage where the methods for conducting a sample size calculation for a Wilcoxon Test are presented. If users click on a button with the words “Sample Size for Repeated-Measures t-test” embedded in it, they will be linked to the Sample Size for Repeated-Measures t-test (607) webpage where the methods for conducting a sample size calculation for a repeated-measures t-test are presented. If users click on a button with the words “Sample Size for Repeated-Measures ANOVA” embedded in it, they will be linked to the Sample Size for Repeated-Measures ANOVA (608) webpage where the methods for conducting a sample size calculation for a repeated-measures ANOVA are presented. If users click on a button with the words “Sample Size for Point Biserial” embedded in it, they will be linked to the Sample Size for Point Biseral (609) webpage where the methods for conducting a sample size for a point biserial correlation are presented. If users click on a button with the words “Sample Size for Pearson's r” embedded in it, they will be linked to the Sample Size for Pearson's r (610) webpage where the methods for conducting a sample size for a Pearson's r are presented. Upon being linked to any of the ten aforementioned webpages (601-610), users are prompted to click on a button with the word “Statistics” embedded in it to be linked to the Statistics (111) decision engine.

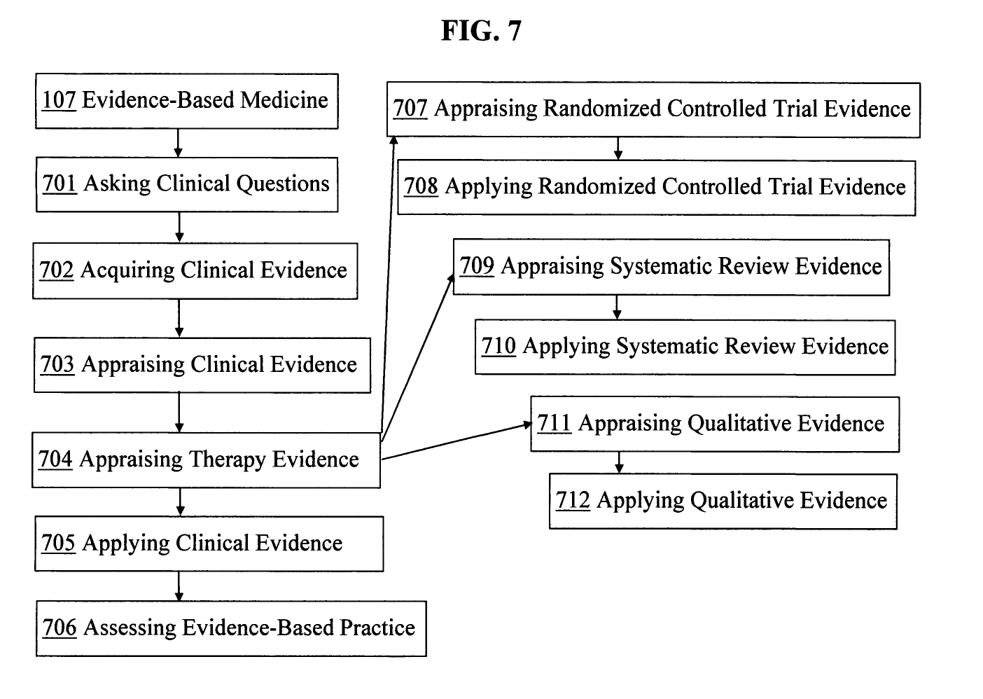

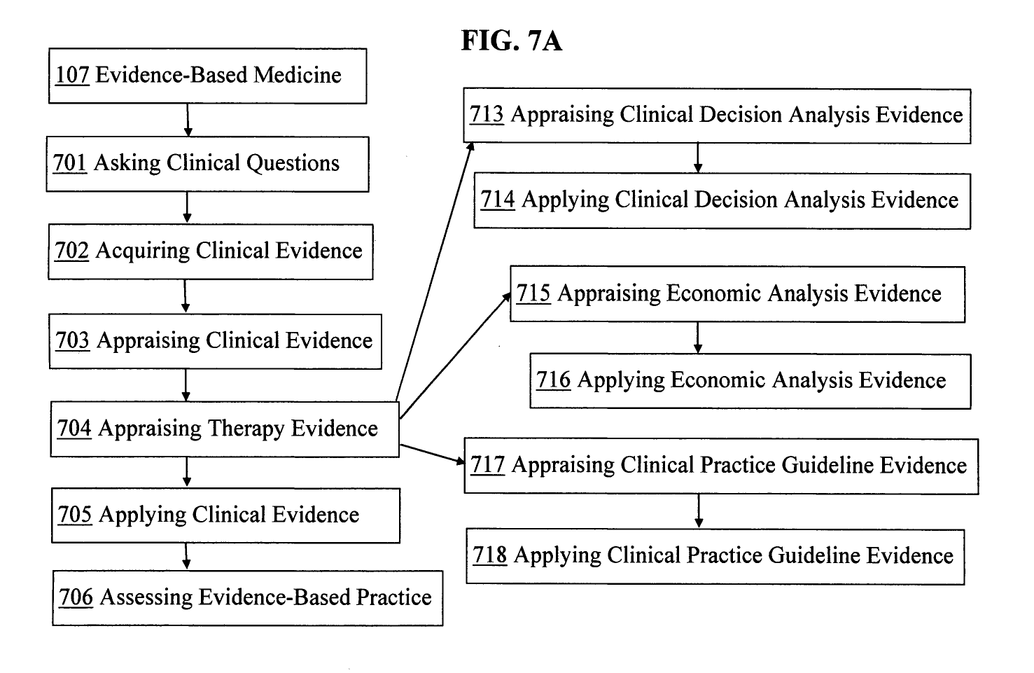

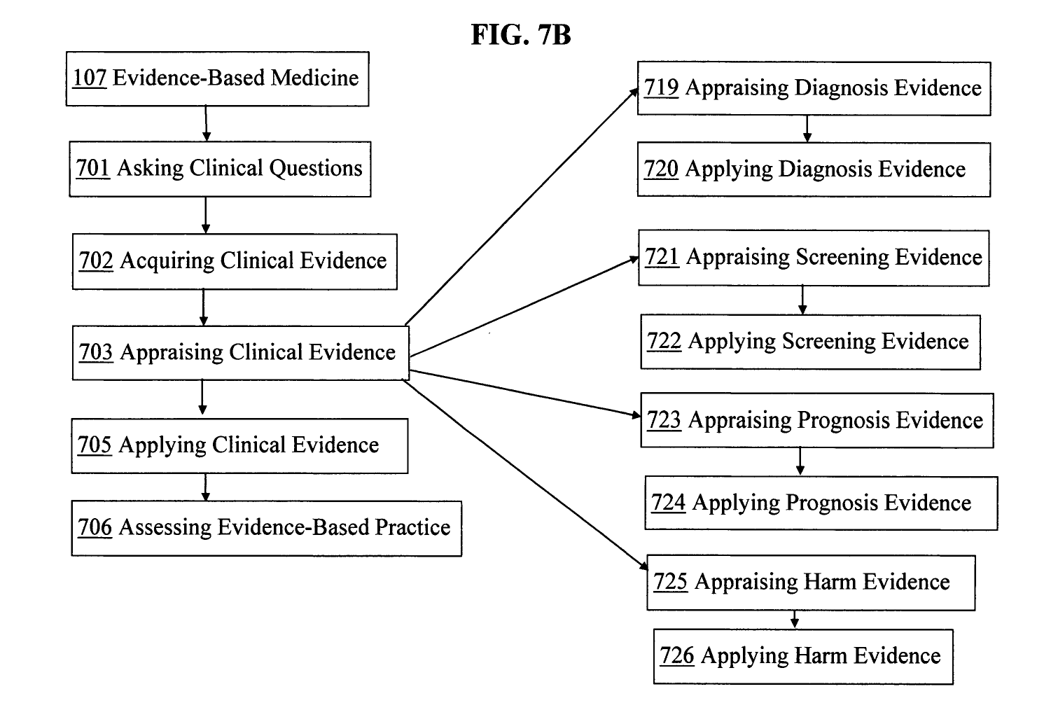

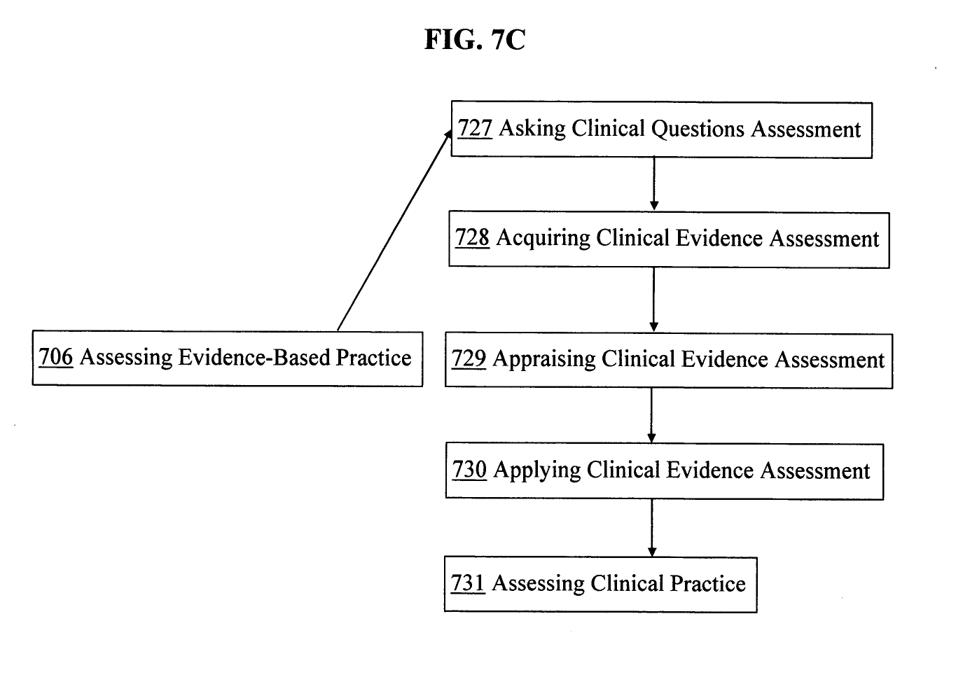

FIG. 7. The Evidence-Based Medicine (107) webpage provides access to an automated step-by-step method for asking clinical questions, acquiring clinical evidence, appraising clinical evidence, applying clinical evidence, assessing evidence-based practice. Users are prompted to click on a button with the words “Asking Clinical Questions” embedded in it and be linked to the Asking Clinical Questions (701) webpage where information and methods regarding writing valid research questions using the PICO mnemonic. At the bottom of the webpage, users will be prompted to click on a button with the words “Acquiring Clinical Evidence” embedded in it and be linked to the Acquiring Clinical Evidence (702) webpage where information about conducting quality literature searches that yield more specific or healthy search results. At the bottom of the webpage, users will be prompted to click on a button with the words “Appraise Clinical Evidence” embedded in it and be linked to the Appraising Clinical Evidence (703) webpage where users are given a number of choices for appraising five different types of clinical evidence. If the users click on a button with the word “Therapy” embedded in it, they will be linked to the Appraising Therapy Evidence (704) webpage which has six different types of articles: Randomized Controlled Trials (RCT), Systematic Reviews (SR), Qualitative, Clinical Decision Analysis, Economic Analysis, and Clinical Practice Guidelines. If users click on a button with the words “Individual RCT” embedded in it, they will be linked to the Appraising Randomized Controlled Trial Evidence (707) webpage where the information and methods needed to critically appraise Randomized Controlled Trials are presented. Users will be prompted to click on a button at the bottom of the webpage with the words “Applying RCT Evidence” embedded in it and be linked to the Applying Randomized Controlled Trial Evidence (708) webpage where the information and methods needed for applying RCT evidence are presented. If users click on a button with the words “Systematic Review” embedded in it, they will be linked to the Appraising Systematic Review Evidence (709) webpage where the information and methods needed for appraising systematic reviews are presented. Users will be prompted to click on a button at the bottom of the webpage with the words “Applying SR Evidence” embedded in it and will be linked to the Applying SR Evidence (710) webpage where information and methods needed to apply SR evidence are presented. If users click on a button with the words “Qualitative” embedded in it, they will be linked to the Appraising Qualitative Evidence (711) webpage where the information and methods needed for appraising qualitative research are presented. Users will be prompted to click on a button at the bottom of the webpage with the words “Applying Qualitative Evidence” embedded in it and will be linked to the Applying Qualitative Evidence (712) webpage where the information and methods needed for applying qualitative evidence are presented.

FIG. 7A. The Evidence-Based Medicine (107) webpage provides access to an automated step-by-step method for asking clinical questions, acquiring clinical evidence, appraising clinical evidence, applying clinical evidence, assessing evidence-based practice. Users are prompted to click on a button with the words “Asking Clinical Questions” embedded in it and be linked to the Asking Clinical Questions (701) webpage where information and methods regarding writing valid research questions using the PICO mnemonic. At the bottom of the webpage, users will be prompted to click on a button with the words “Acquiring Clinical Evidence” embedded in it and be linked to the Acquiring Clinical Evidence (702) webpage where information about conducting quality literature searches that yield more specific or healthy search results. At the bottom of the webpage, users will be prompted to click on a button with the words “Appraise Clinical Evidence” embedded in it and be linked to the Appraising Clinical Evidence (703) webpage where users are given a number of choices for appraising five different types of clinical evidence. If the users click on a button with the word “Therapy” embedded in it, they will be linked to the Appraising Therapy Evidence (704) webpage which has six different types of articles: Randomized Controlled Trials (RCT), Systematic Reviews (SR), Qualitative, Clinical Decision Analysis, Economic Analysis, and Clinical Practice Guidelines. If users click on a button with the words “Clinical Decision Analysis” embedded in it, they will be linked to the Appraising Clinical Decision Analysis Evidence (713) webpage where the information and methods needed for appraising clinical decision analyses are presented. Users will be prompted to click on a button at the bottom of the webpage with the words “Applying Qualitative Evidence” embedded in it and will be linked to the Applying Clinical Decision Analysis Evidence (714) webpage where information and methods needed to apply clinical decision analysis evidence are presented. If users click on a button with the words “Economic Analysis” embedded in it, they will be linked to the Appraising Economic Analysis Evidence (715) webpage where the information and methods needed for appraising systematic reviews are presented. Users will be prompted to click on a button at the bottom of the webpage with the words “Applying Economic Analysis Evidence” embedded in it and will be linked to the Applying Economic Analysis Evidence (716) webpage where information and methods needed to apply economic analysis evidence are presented. If users click on a button with the words “Clinical Practice Guidelines” embedded in it, they will be linked to the Appraising Clinical Practice Guidelines Evidence (717) webpage where the information and methods needed for appraising clinical practice guidelines are presented. Users will be prompted to click on a button at the bottom of the webpage with the words “Applying Clinical Practice Guidelines Evidence” embedded in it and will be linked to the Applying Clinical Practice Guidelines Evidence (718) webpage where information and methods needed to apply clinical practice guidelines evidence are presented.

FIG. 7B. The Evidence-Based Medicine (107) webpage provides access to an automated step-by-step method for asking clinical questions, acquiring clinical evidence, appraising clinical evidence, applying clinical evidence, assessing evidence-based practice. Users are prompted to click on a button with the words “Asking Clinical Questions” embedded in it and be linked to the Asking Clinical Questions (701) webpage where information and methods regarding writing valid research questions using the PICO mnemonic. At the bottom of the webpage, users will be prompted to click on a button with the words “Acquiring Clinical Evidence” embedded in it and be linked to the Acquiring Clinical Evidence (702) webpage where information about conducting quality literature searches that yield more specific or healthy search results. At the bottom of the webpage, users will be prompted to click on a button with the words “Appraise Clinical Evidence” embedded in it and be linked to the Appraising Clinical Evidence (703) webpage where users are given a number of choices for appraising five different types of clinical evidence. If users click on a button with the word “Diagnosis” embedded in it, they will be linked to the Appraising Diagnosis Evidence (719) webpage where information and methods needed to appraise diagnosis evidence are presented. Users will be prompted to click on a button at the bottom of the webpage with the words “Applying Diagnosis Evidence” embedded in it and will be linked to the Applying Diagnosis Evidence (720) webpage where information and methods needed to apply diagnosis evidence are presented. If users click on a button with the word “Screening” embedded in it, they will be linked to the Appraising Screening Evidence (721) webpage where information and methods for appraising screening evidence are presented. Users will be prompted to click on a button at the bottom of the webpage with the words “Applying Screening Evidence” embedded in it and will be linked to the Applying Screening Evidence (722) webpage were information and methods needed to apply screening evidence are presented. If users click on a button with the word “Prognosis” embedded in it, they will be linked to the Appraising Prognosis Evidence (723) webpage where information and methods needed to appraise prognosis evidence are presented. Users will be prompted to click on a button at the bottom of the webpage with the words “Applying Prognosis Evidence” embedded in it and they will be linked to the Apply Prognosis Evidence (724) webpage where information and methods for applying prognosis evidence are presented. If users click on a button with the word “Harm” embedded in it, they will be linked to the Appraising Harm Evidence (725) webpage where information and methods for appraising harm evidence are presented. Users will be prompted to click on a button at the bottom of the webpage with the words “Applying Harm Evidence” and be linked to the Applying Harm Evidence (726) webpage where information and methods for applying harm evidence are presented.

FIG. 7C. At the bottom of each webpage related to applying clinical evidence (708, 710, 712, 714, 716, 718, 720, 722, 724, and 726), users are prompted to click on a button with the words “Assessing EBM Interventions” embedded in it and be linked to the Assessing Evidence-Based Practice (706) webpage. Users are presented information and methods for assessing interventions based on clinical evidence. Users are prompted to click on a button with the words “Asking Clinical Questions” embedded in it and be linked to the Asking Clinical Questions Assessment (727) webpage where information and methods for assessing the identification of knowledge gaps and writing of clinical questions are presented. Users are prompted to click on a button with the words “Acquiring Clinical Evidence” embedded in it and be linked to the Acquiring Clinical Evidence Assessment (728) webpage where information and methods for assessing users' abilities to conduct sound literature searches that yield specific search results are presented. Users are prompted to click on a button with the words “Appraising Clinical Evidence” embedded in it and be linked to the Appraising Clinical Evidence Assessment (729) webpage where information and methods for assessing the critical appraisal skills of users are presented. Users are prompted to click on a button with the words “Applying Clinical Evidence” embedded in it and be linked to the Applying Clinical Evidence Assessment (730) webpage where information and methods for assessing the application of clinical evidence in clinical environments are presented. Users are then prompted to click on a button with the words “Assessing Clinical Practice” embedded in it and be linked to the Assessing Clinical Practice (731) webpage where information and methods for assessing all aspects of evidence-based medicine are presented.

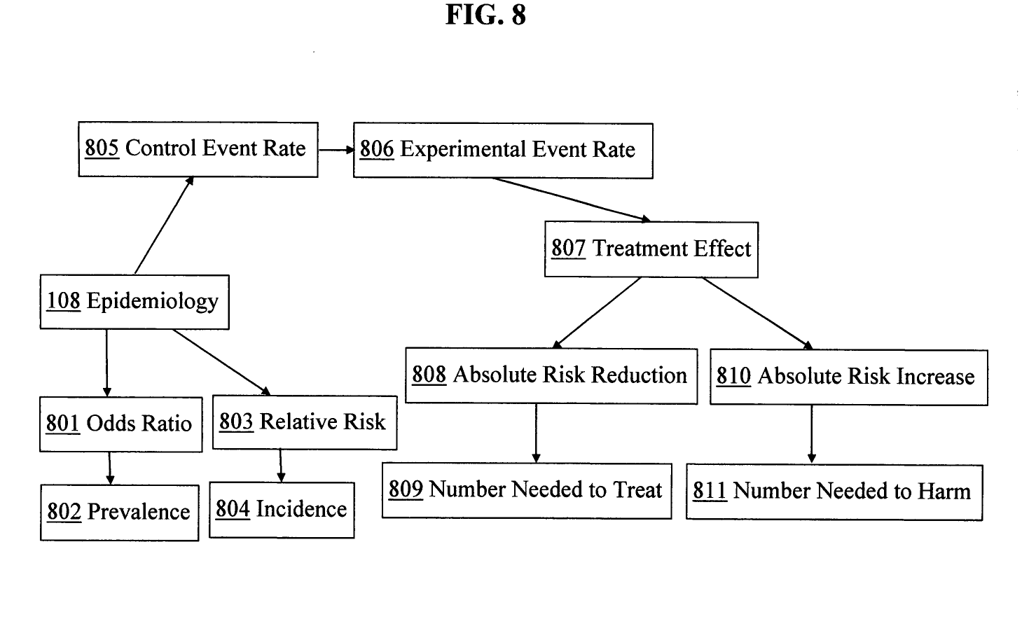

FIG. 8. The Epidemiology (108) webpage starts the decision engine for selecting the correct epidemiological calculation to answer a research question. If users click on a button with the words “Odds Ratios” embedded in it, they will be taken to the Odds Ratio (801) webpage where they will be given information and methods for using odds ratios. Users will then be prompted to click on a button with the words “Prevalence” embedded in it and be linked to the Prevalence (802) webpage where prevalence is defined and explained. If users click on a button with the words “Relative Risk” embedded in it, they will be taken to the Relative Risk (803) webpage where information, methods, and utilities of the relative risk calculation are presented. Users will be prompted to click on a button at the bottom of the webpage with the word “Incidence” embedded in it and be linked to the Incidence (804) webpage where an explanation of the definition, calculation, and use of the term is relevant.

In the Epidemiology (108) webpage, the decision engine starts when users click on the a button with the words “Control Event Rate” embedded in it and are linked to the Control Event Rate (805) webpage where information about the calculation and its utility are explained. Users are prompted to click on a button at the bottom of the screen with the words “Experimental Event Rate” embedded in it. This links users to the Experimental Event Rate (806) webpage where information about the calculation and its utility are explained. Users are prompted to click on a button at the bottom of the webpage with the words “Treatment Effect” and be linked to the Treatment Effect (807) webpage where users are asked if the treatment being studied has either an efficacious (positive) or potentially detrimental (negative) treatment effect. If the users hypothesize a decrease in the number of cases or outcomes (efficacious/positive), then they click on a button with the words “Absolute Risk Reduction” embedded in it and be linked to the Absolute Risk Reduction (808) where information and methods for calculating absolute risk reduction are presented. Users are prompted to click on a button at the bottom of the webpage with the words “Number Needed to Treat” embedded in it. They will be linked to the Number Needed to Treat (809) webpage where there is information about the utility and applicability of the calculation. If the users hypothesize an increase in the number of cases or outcomes (detrimental/negative effects), then they click on a button with the words “Absolute Risk Increase” embedded in it and they will be linked to the Absolute Risk Increase (810) webpage where information and methods for calculating absolute risk increase are presented. Users are prompted to click on a button at the bottom of the webpage with the words “Number Need to Harm” embedded in it. They will be linked to the Number Needed to Harm (811) webpage where information about the utility and applicability of the calculation.

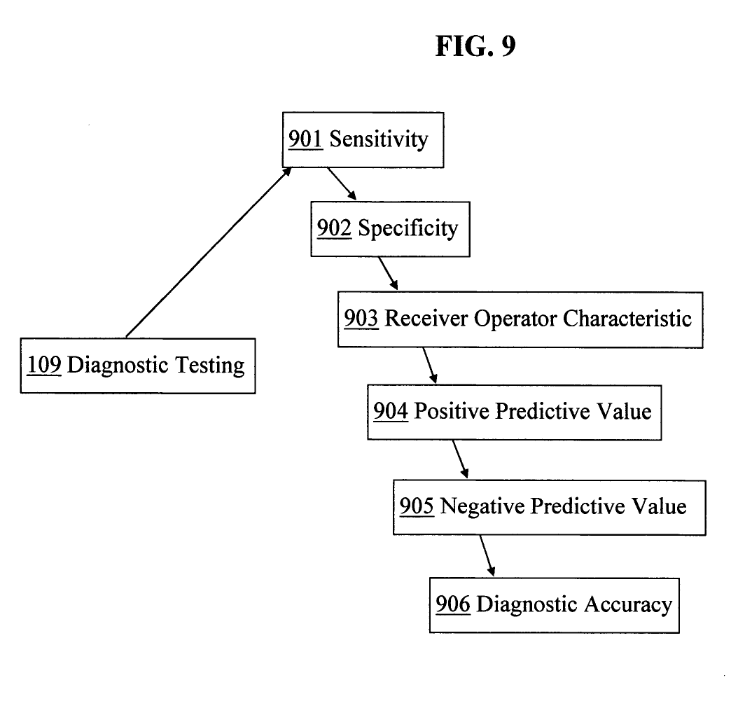

FIG. 9. The Diagnostic Testing (109) webpage starts the decision engine for selecting the correct calculation to answer diagnostic testing research questions. If users click on a button with the word “Sensitivity” embedded in it, they will be linked to the Sensitivity (901) webpage where information and methods related to the calculation and use of the statistic are presented. Users are prompted to click on a button at the bottom of the webpage with the word “Specificity” embedded in it. This takes users to the Specificity (902) webpage where information and methods related to the calculation and use of the statistic are presented. Users are prompted to click on a button at the bottom of the webpage with the words “Receiver Operator Characteristic” embedded in it. They are linked to the Receiver Operator Characteristic (903) webpage where information and methods for conduct ROC Curves are presented. Users are prompted to click on a button at the bottom of the webpage with the words “Positive Predictive Value” embedded in it. They are linked to the Positive Predictive Value (904) webpage where information and methods regarding this calculation are presented. Users are prompted to click on a button at the bottom of the webpage with the words “Negative Predictive Value” embedded in it, and they will be linked to the Negative Predictive Value (905) webpage where information and methods regarding this calculation are presented. Users are prompted to click on a button at the bottom of the webpage with the words “Diagnostic Accuracy” embedded in it, and they will be linked to the Diagnostic Accuracy (906) webpage where information and methods regarding this calculation are presented.

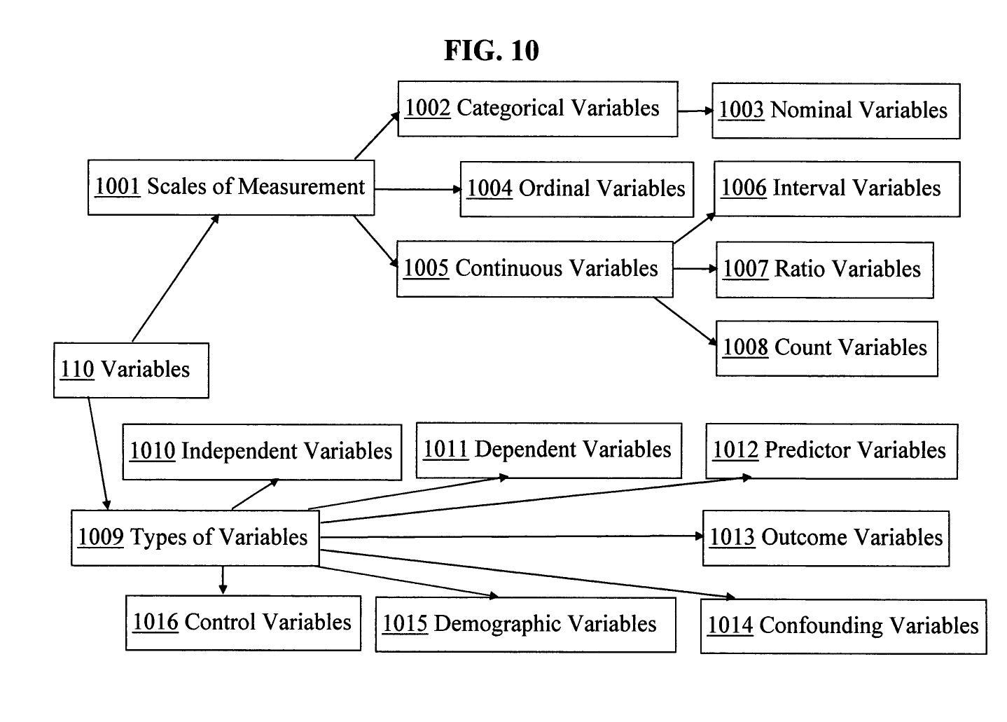

FIG. 10. The Variables (110) webpage starts the decision engine for choosing the correct types of variables and learning more about measurement. Users have two options once they land on the Variables (110) webpage, they can click on a button with the words “Scales of Measurement” embedded in it and be linked to the Scales of Measurement (1001) webpage. This page gives a description of the three types of variables and buttons can be click to access more information about each. Users can click on a button with the words “Categorical Variables” embedded in it and be linked to the Categorical Variables (1002) webpage where information about that type of measurement is presented. Users can click on the a button with the word “Nominal” embedded in it and be linked to the Nominal Variables (1003) webpage where information about that type of measurement is presented. Users can click on a button with the words “Ordinal Variables” embedded in it and be linked to the Ordinal Variables (1004) website where information about that type of measurement is presented. Users can click on a button with the words “Continuous Variables” embedded in it and be linked to the Continuous Variables (1005) webpage where information about that type of measurement is presented. Users can click on a button with the words “Interval Variables” embedded in it and be linked to the Interval Variables (1006) website where information about that type of measurement is presented. Users can click on a button with the words “Ratio Variables” embedded in it and be linked to the Ratio Variables (1007) webpage where information about that type of measurement is presented. Users can click on a button with the words “Count Variables” embedded in it and be linked to the Count Variables (1008) webpage where information about that type of measurement is presented.

Back on the Variables (110) webpage, there was a second option besides the Scales of Measurement (1001) webpage, users can click on a button in the webpage with the words “Types of Variables” embedded in it and be linked to the Types of Variables (1009) webpage. From this webpage, users can access information about seven different types of variables used in research: Independent variables, dependent variables, predictor variables, outcome variables, confounding variables, demographic variables, and control variables. Users can click on any button in the webpage and be linked to explanations of each type of variable. Users can click a button with the words “Independent Variables” embedded in it and be linked to the Independent Variables (1010) webpage where information about that type of variable is presented. Users can click on a button with the words “Dependent Variables” embedded in it and be linked to the Dependent Variables (1011) webpage where information about that type of variable is presented. Users can click on a button with the words “Predictor Variables” embedded in it and be linked to the Predictor Variables (1012) webpage where information about the type of variable is presented. Users can click on a button with the words “Outcome Variables” embedded in it and be linked to the Outcome Variables (1013) webpage where information about the type of variable is presented. Users can click on a button with the words “Confounding Variables” and be linked to the Confounding Variables (1014) webpage where information about the type of variable is presented. Users can click on a button with the words “Demographic Variables” and be linked to the Demographic Variables (1015) webpage where information about the type of variable is presented. Users can click on a button with the words “Control Variables” and be linked to the Control Variables (1016) webpage where information about the type of variable is presented.

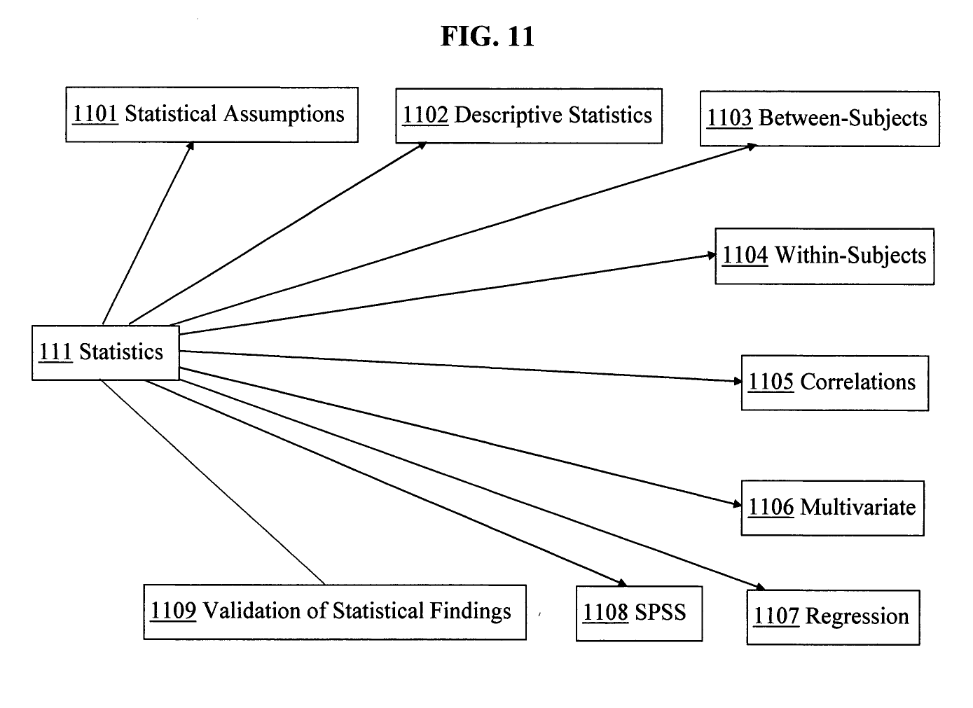

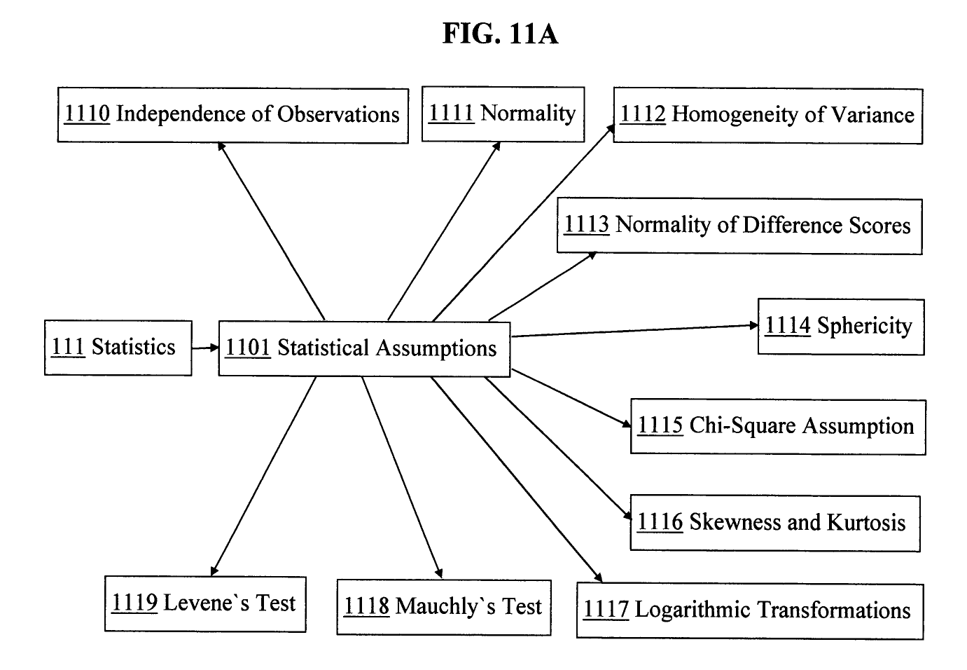

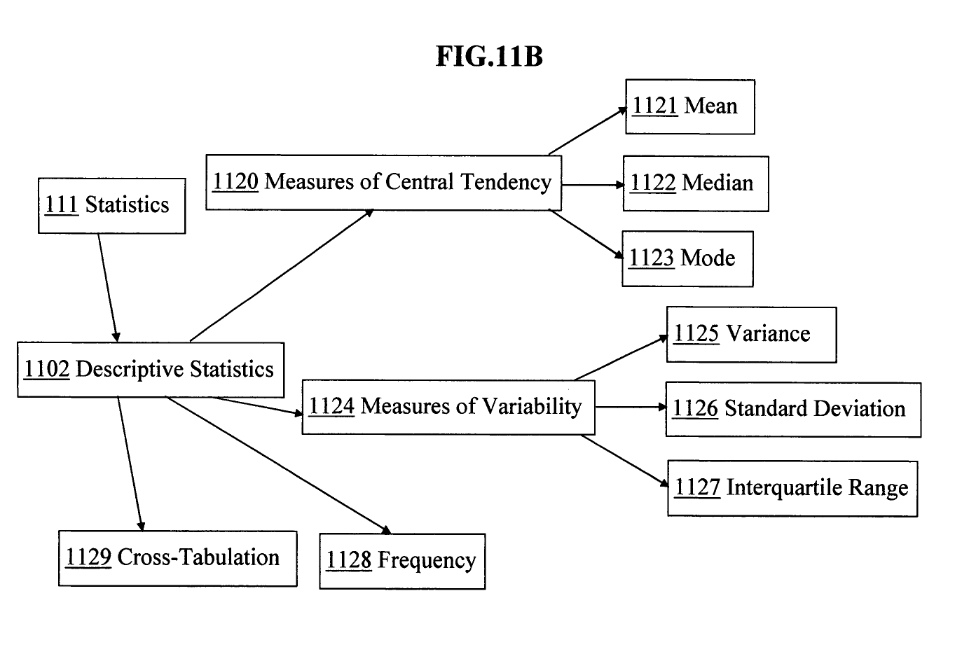

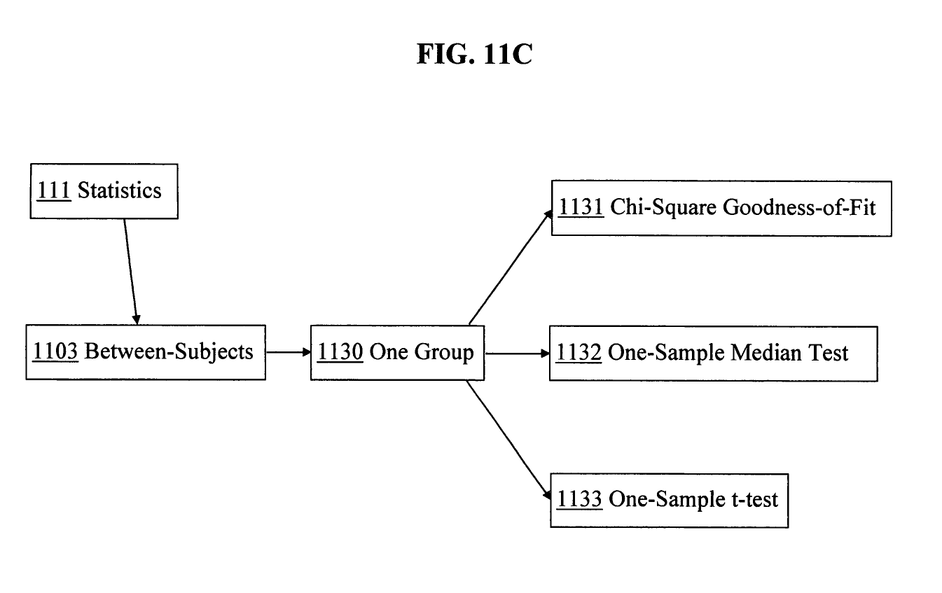

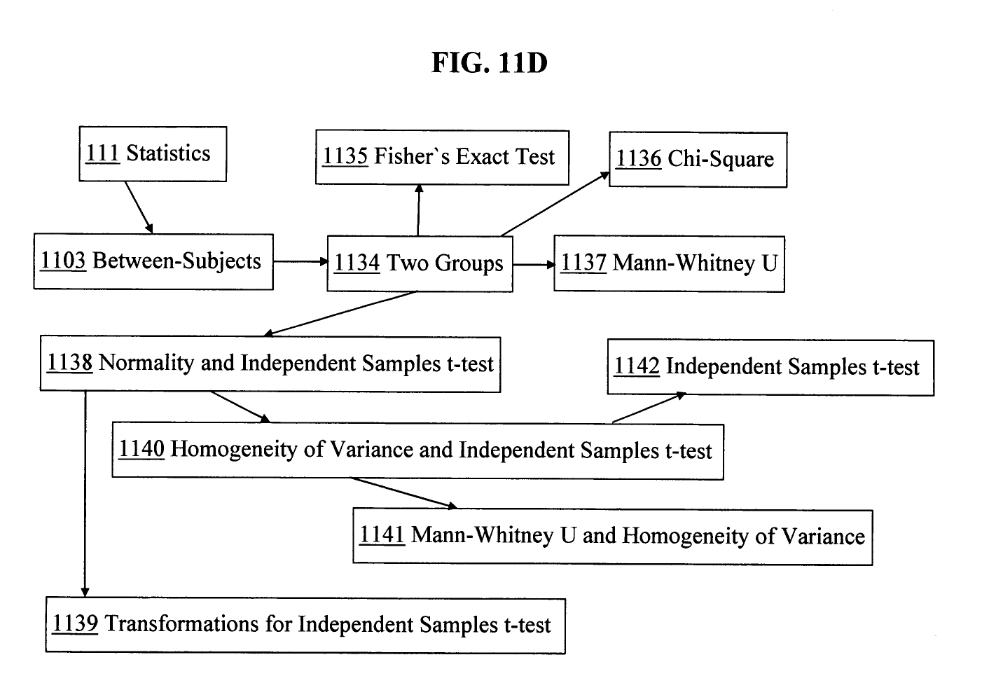

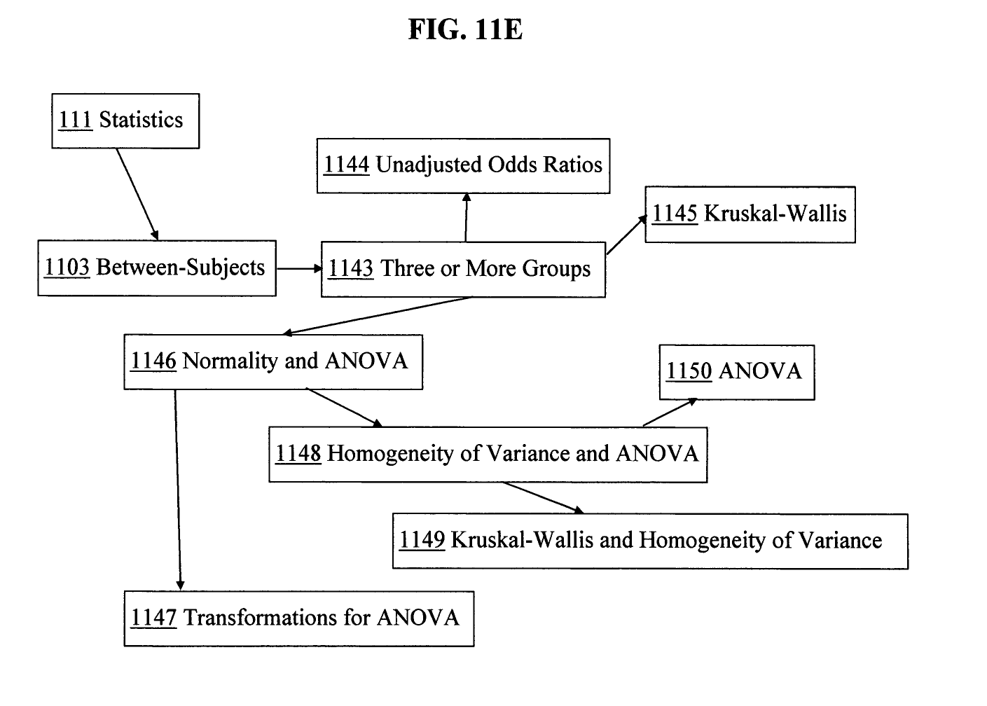

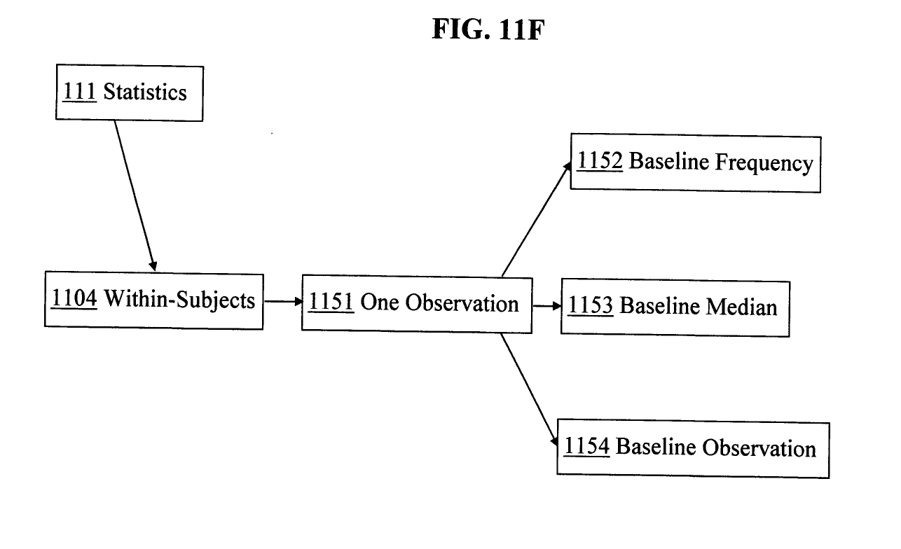

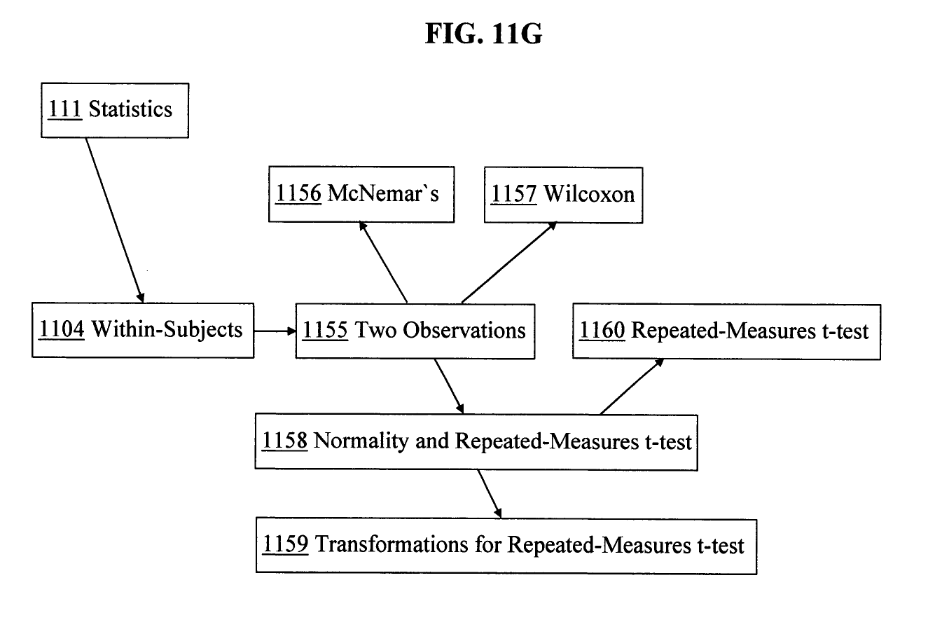

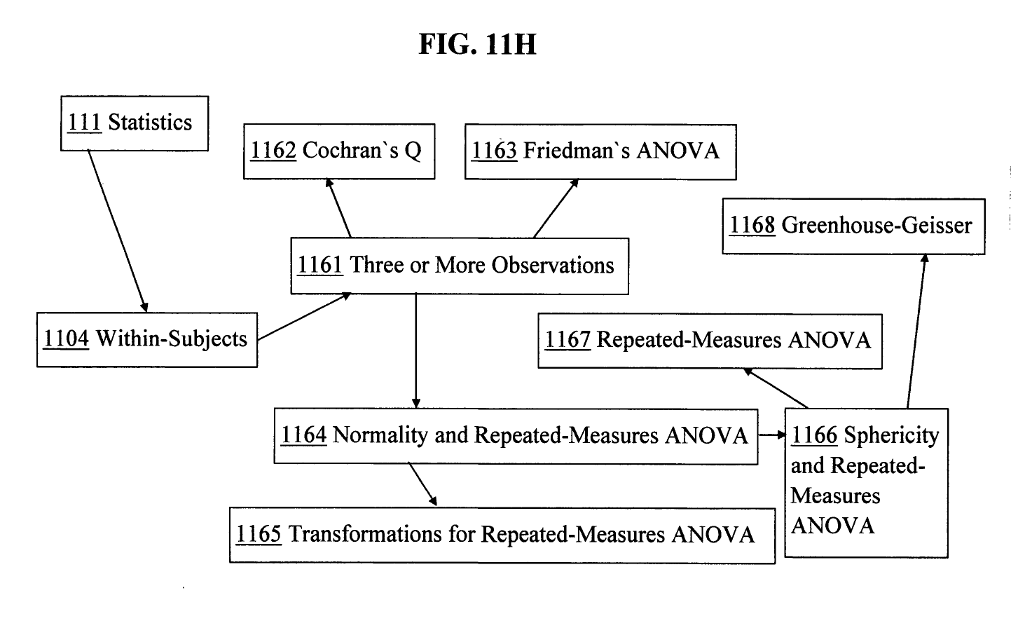

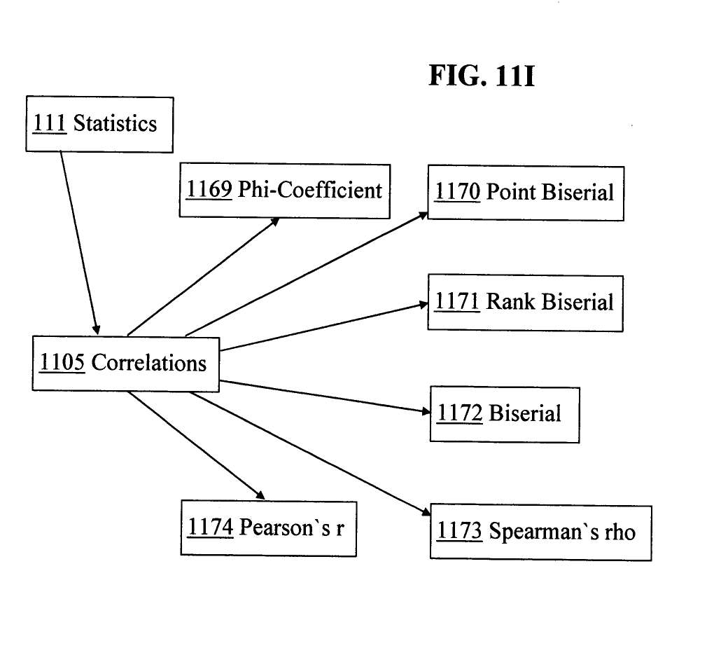

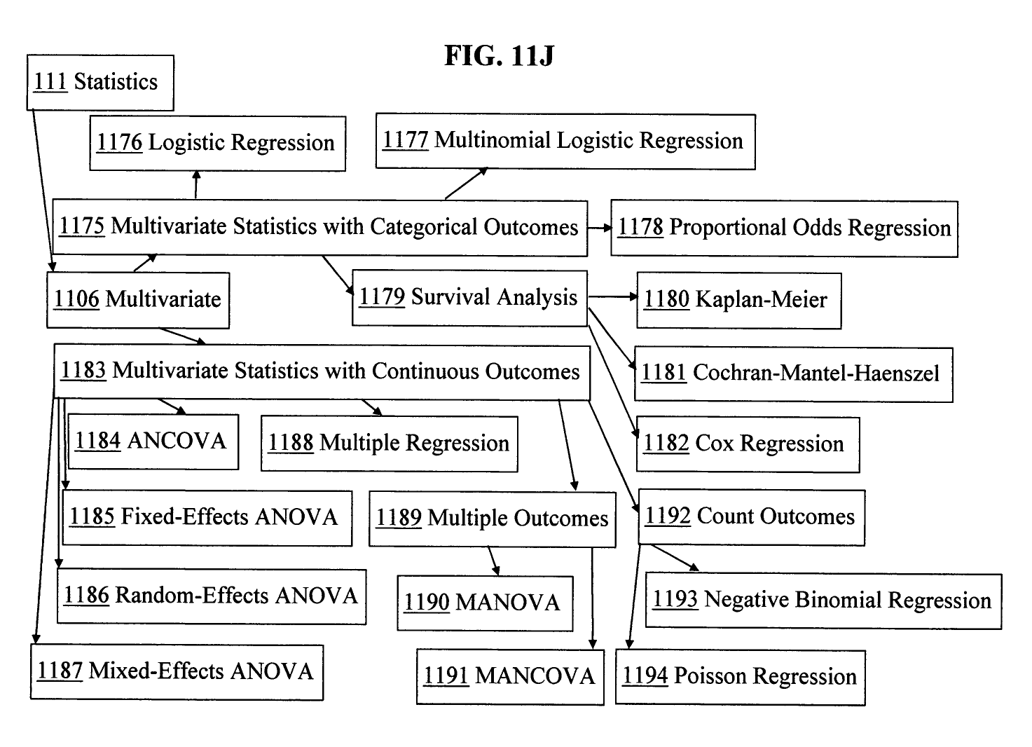

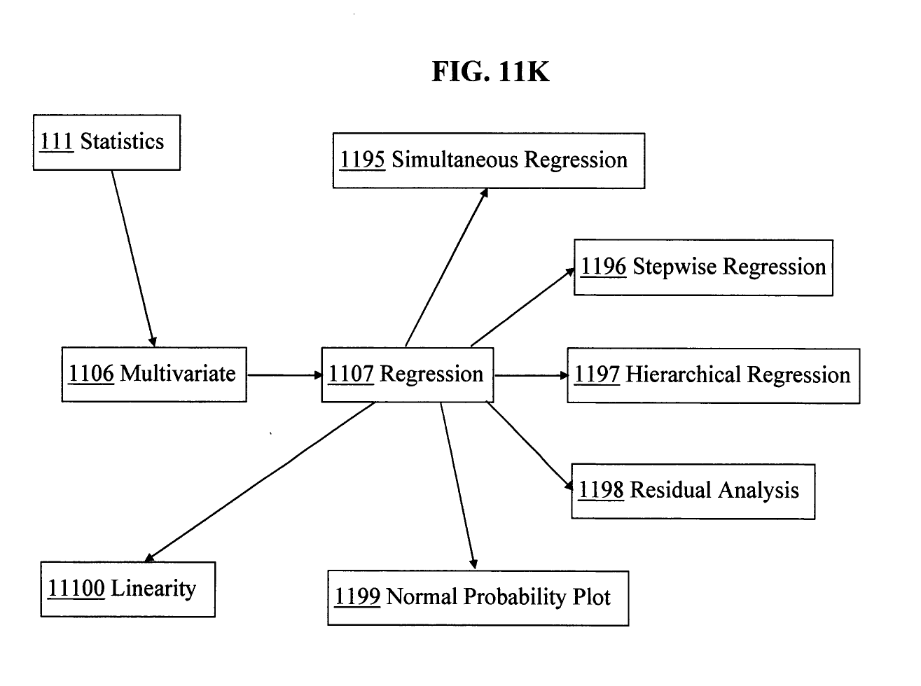

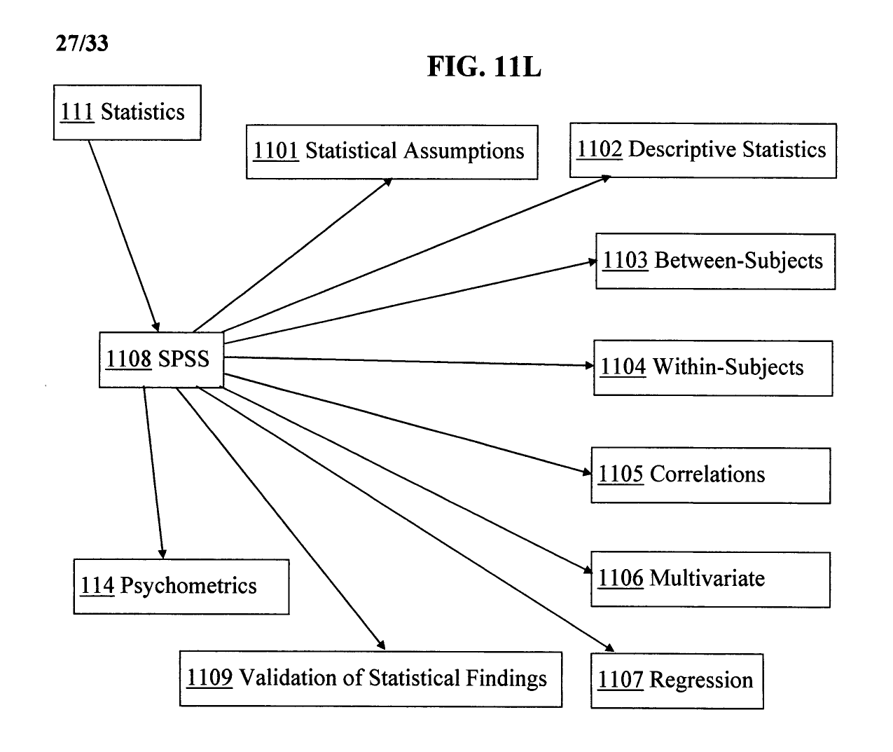

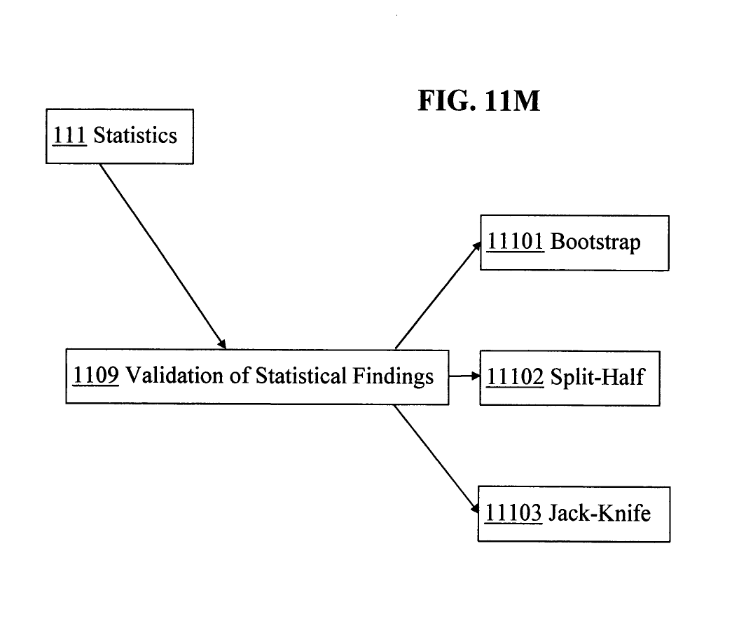

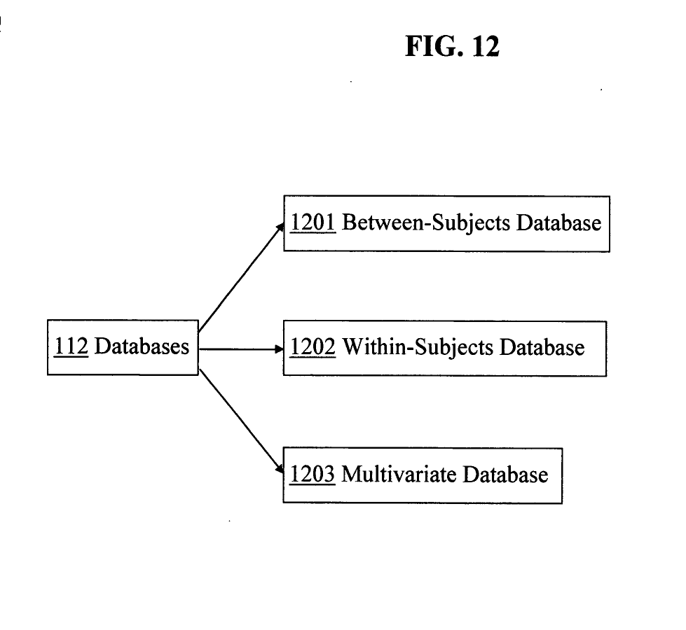

FIG. 11. The Statistics (111) webpage starts the decision engine for choosing the correct statistical test. Once the correct test is found by answering questions within the decision engine, the methods for conducting and interpreting the statistical tests in SPSS and a download of a database structured for that statistical test will be available for download. Users can click on a button with the words “Statistical Assumptions” embedded in it and will be linked to the Statistical Assumptions (1101) webpage where they can access information and methods for statistical assumptions and their tests. Users can click on a button with the words “Descriptive Statistics” embedded in it and will be linked to the Descriptive Statistics (1102) webpage where they can access information and methods related to descriptive statistics. Users can click on a button with the words “Between-Subjects” embedded in it and be linked to the Between-Subjects (1103) webpage where a series of questions are presented to get users to the correct statistical test given the number of independent groups, the type of outcome, and the meeting of statistical assumptions. Users can click on a button with the words “Within-Subjects” embedded in it and be linked to the Within-Subjects (1104) webpage where a series of questions are presented to get users to the correct statistical test given the number of observations, the type of outcome, and the meeting of statistical assumptions. Users can click on a button with the word “Correlations” embedded in it and be linked to the Correlations (1105) webpage where they can access information and methods for six types of correlations by click on buttons with the names of correlation tests embedded in them and being linked to the associated webpages. Users can click on a button with the word “Multivariate” embedded in it and be linked to the Multivariate (1106) webpage where a series of questions are presented to get users to the correct multivariate statistical test given the type of outcome being used and the meeting of statistical assumptions. Users can click on a button with the word “Regression” embedded in it and be linked to the Regression (1107) webpage where they can access information and methods on a number of topics related to regression analysis by click on buttons with the names of types of regression, statistical assumptions, and regression tests embedded in them and being linked to the associated webpages. Users can click on a button with the acronym “SPSS” embedded in it and will be linked to the SPSS (1108) webpage where users can access information and methods for conducting over 60 different statistical tests and interpreting the outputs using SPSS Version 21. Users click on buttons with the names of the different tests embedded into them and users are linked to the associated webpages. Users can click on a button with the words “Validation of Statistical Findings” embedded in it and be linked to the Validation of Statistical Findings (1109) webpage where they can access information and methods for conducting three different types of validation of statistical findings. Users click on buttons with the names of the different methods embedded into them and users are linked to the associated webpages.

FIG. 11A. From the Statistics (111) webpage, users can click on a button with the words “Statistical Assumptions” embedded in it and be linked to the Statistical Assumptions (1101) webpage. From the Statistical Assumptions (1101) webpage, users can access information and methods regarding six prevalent types of statistical assumptions and four methods for testing statistical assumptions in applied practice. Users can click on a button with the words “Independence of Observations” embedded in it and be linked to the Independence of Observations (1110) webpage where information and methods related to this statistical assumption are presented. Users can click on a button with the word “Normality” embedded in it and be linked to the Normality (1111) webpage where information and methods for testing the assumption of normality using skewness and kurtosis statistics are presented. Users can click on a button with the words “Homogeneity of Variance” embedded in it and be linked to the Homogeneity of Variance (1112) webpage where information and methods for testing the assumption of homogeneity of variance with Levene's test are presented. Users can click on a button with the words “Normality of Difference Scores” embedded in it and be linked to the Normality of Difference Scores (1113) webpage where information and methods about testing this assumption in repeated-measures analyses. Users can click on a button with the word “Sphericity” embedded in it and be linked to the Sphericity (1114) webpage where information and methods about testing the assumption of sphericity with Mauchly's test. Users can click on a button with the words “Chi-Square Assumption” embedded in it and be linked to the Chi-Square Assumption (1115) webpage where information and methods related to this statistical assumption are presented. Users can click on a button with the words “Skewness and Kurtosis” embedded in it and be linked to the Skewness and Kurtosis (1116) webpage where information and methods for conducting skewness and kurtosis statistics to meet the assumption of normality are presented. Users can click on a button with the words “Logarithmic Transformations” and be linked to the Logarithmic Transformations (1117) webpage where information and methods regarding the use of this statistical technique. Users can click on a button with the words “Mauchly's Test” embedded in it and be linked to the Mauchly's Test (1118) webpage where information and methods for the use of the test and the assumption of sphericity. Users can click on a button with the words “Levene's Test” embedded in it and be linked to the Levene's Test (1119) webpage where information and methods for using the test for the assumption of homogeneity of variance.

FIG. 11B. From the Statistics (111) webpage, users can click on a button with the words “Descriptive Statistics” embedded in it and be linked to the Descriptive Statistics (1102) webpage. From the Descriptive Statistics (1102) webpage, users can access information and methods regarding several kinds of descriptive statistics. Users can click on a button with the words “Measures of Central Tendency” embedded in it and be linked to the Measures of Central Tendency (1120) webpage. From this webpage, users can click on buttons with the three types of measures of central tendency embedded in them and be linked to the associated pages. Users can click on a button with the word “Mean” embedded in it and be linked to the Mean (1121) webpage where information and methods for calculating and interpreting means are presented. Users can click on a button with the word “Median” embedded in it and be linked to the Median (1122) webpage where information and methods for calculating and interpreting medians are presented. Users can click on a button with the word “Mode” embedded in it and be linked to the Mode (1123) webpage where information and methods for calculating and interpreting modes are presented.

From the Descriptive Statistics (1102) webpage, users can click on a button with the words “Measures of Variability” embedded in it and be linked to the Measures of Variability (1124) webpage where users can access information and methods about three types of measure of variability. Users can click on a button with the words “Variance” embedded in it and be linked to the Variance (1125) webpage where information and methods for calculating and interpreting variance are presented. Users can click on a button with the words “Standard Deviation” embedded in it and be linked to the Standard Deviation (1126) webpage where information and methods for calculating and interpreting standard deviations are presented. Users can click on a button with the words “Interquartile Range” embedded in it and be linked to the Interquartile Range (1127) webpage where information and methods for calculating and interpreting interquartile range are presented.

From the Descriptive Statistics (1102) webpage, users can click on a button with the word “Frequency” and be linked to the Frequency (1128) webpage where information and methods for conducting and interpreting frequencies are presented. Users can also click on a button with the word “Cross-Tabulation” and be linked to the Cross-Tabulation (1129) webpage where information and methods for calculating interpreting cross-tabulation statistics.

FIG. 11C. From the Statistics (111) webpage, users can click on a button with the words “Between-Subjects” embedded in it and be linked to the Between-Subjects (1103) webpage. After linking to the Between-Subjects (1103) webpage, users are asked how many groups are being compared: One group, two groups, or three or more groups. If the user click on a button with the words “One Group” embedded in it, then they are linked to the One Group (1130) webpage. In the One Group (1130) webpage, users are asked what kind of outcome they are using. If users click on a button with the word “Categorical” embedded in it, they will be linked to the Chi-Square Goodness-of-Fit (1131) webpage where information and methods for conducting and interpreting the statistical test in SPSS are presented. If users click on a button with the word “Ordinal” embedded in it, they will be linked to the One-Sample Median Test (1132) webpage where information and methods for conducting and interpreting the statistical test in SPSS are presented. If users click on a button with the word “Continuous” embedded in it, they will be linked to the One-Sample t-test (1133) webpage where information and methods for conducting and interpreting the statistical test in SPSS are presented. Upon navigating to any of the pages (1131-1133), users will be prompted to download a database structured for conducting the respective tests.

FIG. 11D. From the Statistics (111) webpage, users can click on a button with the words “Between-Subjects” embedded in it and be linked to the Between-Subjects (1103) webpage. After linking to the Between-Subjects (1103) webpage, users are asked how many groups are being compared: One group, two groups, or three or more groups. If the user clicks on a button with the words “Two Groups” embedded in it, then they are linked to the Two Groups (1134) webpage. In the Two Groups (1134) webpage, users are asked what kind of outcome they are using. If users click on a button with the word “Categorical” embedded in it, they will be linked to the Chi-Square (1136) webpage where information and methods for conducting and interpreting the statistical test in SPSS are presented. If the Chi-Square assumption is violated, then users can click on a button with the words “Fisher's Exact Test” embedded in it and be linked to the Fisher's Exact Test (1135) webpage where information and methods for conducting and interpreting the statistical test in SPSS are presented. If users click on a button with the word “Ordinal” embedded in it, they will be linked to the Mann-Whitney U (1137) webpage where information and methods for conducting and interpreting the statistical test in SPSS are presented. If users click on a button with the word “Continuous” embedded in it, they will be linked to the Normality and Independent Samples t-test (1138) webpage. Users are asked if the assumption of normality was met as per skewness and kurtosis statistics and information and methods for testing the assumption are presented. If users click on a button with the word “No” embedded in it because they did not meet the assumption of normality, they will be linked to the Transformations for Independent Samples t-test (1139) webpage where information and methods for listwise deletion, logarithmic transformations, and non-parametric statistics are explained. If users click on a button with the word “Yes” embedded in it because they did meet the assumption of normality, they will be linked to the Homogeneity of Variance and Independent Samples t-test (1140) webpage. Users are asked if the assumption of homogeneity of variance was met as per Levene's Test and information and methods for testing the assumption are presented. If users click on a button with the word “No” embedded in it because they did not meet the assumption of homogeneity of variance, they will be linked to the Mann-Whitney U and Homogeneity of Variance (1141) webpage where information and methods for conducting and interpreting non-parametric statistics when violations of the assumption are found. If users click on a button with the word “Yes” embedded in it, then they are linked to the Independent Samples t-test (1143) webpage where information and methods for conducting and interpreting the statistical test in SPSS are presented. Upon navigating to any of the pages (1135-1142). Users will be prompted to download a database structured for conducting the respective tests.

FIG. 11E. From the Statistics (111) webpage, users can click on a button with the words “Between-Subjects” embedded in it and be linked to the Between-Subjects (1103) webpage. After linking to the Between-Subjects (1103) webpage, users are asked how many groups are being compared: One group, two groups, or three or more groups. If the user clicks on a button with the words “Three or More Groups” embedded in it, then they are linked to the Three or More Groups (1143) webpage. In the Three or More Groups (1143) webpage, users are asked what kind of outcome they are using. If users click on a button with the word “Categorical” embedded in it, they will be linked to the Unadjusted Odds Ratio (1144) webpage where information and methods for conducting and interpreting the statistical test in SPSS are presented. If users click on a button with the word “Ordinal” embedded in it, they will be linked to the Kruskal-Wallis (1145) webpage where information and methods for conducting and interpreting the statistical test in SPSS are presented. If users click on a button with the word “Continuous” embedded in it, they will be linked to the Normality and ANOVA (1146) webpage. Users are asked if the assumption of normality was met as per skewness and kurtosis statistics and information and methods for testing the assumption are presented. If users click on a button with the word “No” embedded in it because they did not meet the assumption of normality, they will be linked to the Transformations for ANOVA (1147) webpage where information and methods for listwise deletion, logarithmic transformations, and non-parametric statistics are explained. If users click on a button with the word “Yes” embedded in it because they did meet the assumption of normality, they will be linked to the Homogeneity of Variance and ANO A (1148) webpage. Users are asked if the assumption of homogeneity of variance was met as per Levene's Test and information and methods for testing the assumption are presented. If users click on a button with the word “No” embedded in it because they did not meet the assumption of homogeneity of variance, they will be linked to the Kruskal-Wallis and Homogeneity of Variance (1149) webpage where information and methods for conducting and interpreting non-parametric statistics when violations of the assumption are found. If users click on a button with the word “Yes” embedded in it, then they are linked to the ANOVA (1150) webpage where information and methods for conducting and interpreting the statistical test in SPSS are presented. Upon navigating to any of the pages (1143-1150), users will be prompted to download a database structured for conducting the respective tests.

FIG. 11F. From the Statistics (111) webpage, users can click on a button with the words “Within-Subjects” embedded in it and be linked to the Within-Subjects (1104) webpage. After linking to the Within-Subjects (1104) webpage, users are asked how many observations of the outcome are being observed: One observation, two observations, or three or more observations. If users click on a button with the words “One Observation” embedded in it, then they are linked to the One Observation (1151) webpage. In the One Observation (1151) webpage, users are asked what kind of outcome they are using. If users click on a button with the word “Categorical” embedded in it, they will be linked to the Baseline Frequency (1152) webpage where information and methods for conducting and interpreting the statistical test in SPSS are presented. If users click on a button with the word “Ordinal” embedded in it, they will be linked to the Baseline Median (1153) webpage where information and methods for conducting and interpreting the statistical test in SPSS are presented. If users click on a button with the word “Continuous” embedded in it, they will be linked to the Baseline Observation (1154) webpage where information and methods for conducting and interpreting the statistical test in SPSS are presented. Upon navigating to any of the pages (1152-1154), users will be prompted to download a database structured for conducting the respective tests.

FIG. 11G. From the Statistics (111) webpage, users can click on a button with the words “Within-Subjects” embedded in it and be linked to the Within-Subjects (1104) webpage. After linking to the Within-Subjects (1104) webpage, users are asked how many observations of the outcome are being observed: One observation, two observations, or three or more observations. If users click on a button with the words “Two Observations” embedded in it, then they are linked to the Two Observations (1155) webpage. In the Two Observations (1155) webpage, users are asked what kind of outcome they are using. If users click on a button with the word “Categorical” embedded in it, they will be linked to the McNemar's Test (1156) webpage where information and methods for conducting and interpreting the statistical test in SPSS are presented. If users click on a button with the word “Ordinal” embedded in it, they will be linked to the Wilcoxon (1157) webpage where information and methods for conducting and interpreting the statistical test in SPSS are presented. If users click on a button with the word “Continuous” embedded in it, they will be linked to the Normality and Repeated-Measures t-test (1158) webpage where information and methods for conducting and interpreting skewness and kurtosis in SPSS are presented. Users are asked if they met the assumption of normality. If they click on a button with the word “No” embedded in it because they violated the statistical assumption, then they will be linked to the Transformations for Repeated-Measures t-test (1159) webpage where information and methods for listwise deletion, logarithmic transformations, and non-parametric statistics are presented. If users click on a button with the word “Yes” embedded in it because the assumption of normality is met, then they will be linked to the Repeated-Measures t-test (1160) webpage where information and methods for conducting and interpreting the statistical test are presented. Upon navigating to any of the pages (1155-1160), users will be prompted to download a database structured for conducting the respective tests.

FIG. 11H. From the Statistics (111) webpage, users can click on a button with the words “Within-Subjects” embedded in it and be linked to the Within-Subjects (1104) webpage. After linking to the Within-Subjects (1104) webpage, users are asked how many observations of the outcome are being observed: One observation, two observations, or three or more observations. If users click on a button with the words “Three or More Observations” embedded in it, then they are linked to the Three or More Observations (1161) webpage. In the Three Observations (1161) webpage, users are asked what kind of outcome they are using. If users click on a button with the word “Categorical” embedded in it, they will be linked to the Cochran's Q (1162) webpage where information and methods for conducting and interpreting the statistical test in SPSS are presented. If users click on a button with the word “Ordinal” embedded in it, they will be linked to the Friedman's ANOVA (1163) webpage where information and methods for conducting and interpreting the statistical test in SPSS are presented. If users click on a button with the word “Continuous” embedded in it, they will be linked to the Normality and Repeated-Measures ANOVA (1164) webpage where information and methods for conducting and interpreting skewness and kurtosis in SPSS are presented. Users are asked if they met the assumption of normality. If they click on a button with the word “No” embedded in it because they violated the statistical assumption, then they will be linked to the Transformations for Repeated-Measures ANOVA (1165) webpage where information and methods for listwise deletion, logarithmic transformations, and non-parametric statistics are presented. If users click on a button with the word “Yes” embedded in it because the assumption of normality is met, then they will be linked to the Sphericity and Repeated-Measures ANOVA (1166) webpage. Users are asked if they met the assumption of sphericity. If they click on a button with the word “No” embedded in it because the assumption of sphericity was violated, then they will be linked to the Greenhouse-Geisser (1168) webpage where information and methods for conducting and interpreting the statistical test in SPSS are presented. If they click on a button with the word “Yes” embedded in it because they met the assumption of sphericity, then they will be linked to the Repeated-Measures ANOVA (1167) webpage where information and methods for conducting and interpreting the statistical test in SPSS are presented. Upon navigating to any of the pages (1161-1168), users will be prompted to download a database structured for conducting the respective tests.

FIG. 11I. From the Statistics (111) webpage, users can click on a button with the word “Correlations” embedded in it and be linked to the Correlations (1105) webpage. After linking to the Correlations (1105) webpage, users are asked what the scales of measurement are for the two variables being analyzed. If users are correlating two categorical variables, they will click on a button with the words “Phi-Coefficient” embedded in it and be linked to the Phi-Coefficient (1169) webpage where information and methods for conducting and interpreting the correlation in SPSS are presented. If users are correlating a categorical variable and a continuous variable, then they will click on a button with the words “Point Biserial” embedded in it and be linked to the Point Biserial (1170) webpage where information and methods for conducting and interpreting the correlation in SPSS are presented. If users are correlating a categorical variable and an ordinal variable, then they will click on a button with the words “Rank Biserial” embedded in it and be linked to the Rank Biserial (1171) webpage where information and methods for conducting and interpreting the correlation in SPSS are presented. If users are correlating an ordinal variable and a continuous variable, then they will click on a button with the word “Biserial” embedded in it and be linked to the Biserial (1172) webpage where information and methods for conducting and interpreting the correlation in SPSS are presented. If users are correlating two ordinal variables, then they will click on a button with the words “Spearman's rho” embedded in it and be linked to the Spearman's rho (1173) webpage where information and methods for conducting and interpreting the correlation in SPSS are presented. If users are correlating two continuous variables, then they will click on a button with the words “Pearson's r” embedded in it and be linked to the Pearson's r (1173) webpage where information and methods for conducting and interpreting the correlation in SPSS are presented. Upon navigating to any of the pages (1169-1174), users will be prompted to download a database structured for conducting the respective tests.

FIG. 11J From the Statistics (111) webpage, users can click on a button with the word “Multivariate” embedded in it and be linked to the Multivariate (1106) webpage. After linking to the Multivariate (1106) webpage, users are asked what the scale of measurement is for the outcome. If users are employing categorical outcomes, they can click on a button with the word “Categorical” embedded in it, they will be linked to the Multivariate Statistics with Categorical Outcomes (1175) webpage. Users choose what type of multivariate statistic to use based on the type of categorical outcome they want to use in their study. If users are predicting for a dichotomous categorical outcome, they can click on a button with the words “Logistic Regression” embedded in it and be linked to the Logistic Regression (1176) webpage where information and methods for conducting and interpreting the statistical test in SPSS are presented. If users are predicting for a polychotomous categorical outcome, they can click on a button with the words “Multinomial Logistic Regression” embedded in it and be linked to the Multinomial Logistic Regression (1177) webpage where information and methods for conducting and interpreting the statistical test in SPSS are presented. If users are predicting for an ordinal outcome, they can click on a button with the words “Proportional Odds Regression” embedded in it and be linked to the Proportional Odds Regression (1178) webpage where information and methods for conducting and interpreting the statistical test in SPSS are presented. Upon navigating to any of the pages (1175-1178), users will be prompted to download a database structured for conducting the respective tests.

If users are comparing multiple groups on the time-to-event for a categorical outcome to occur, they can click on a button with the words “Time-to-Event/Survival Analysis” embedded in it and be linked to the Survival Analysis (1179) webpage. Users are asked what kind of survival analysis they want to conduct. If users are comparing independent groups on the time to a dichotomous categorical outcome or event, they can click on a button with the words “Kaplan-Meier” embedded in it and be linked to the Kaplan-Meier (1180) webpage where information and methods for conducting and interpreting the statistical test in SPSS are presented. If users are comparing independent groups across different treatment or environmental conditions, they can click on a button with the words “Cochran-Mantel-Haenszel” embedded in it and be linked to the Cochran-Mantel-Haenszel (1181) webpage where information and methods for conducting and interpreting the statistical test in SPSS are presented. If users are controlling for demographic, clinical, or prognostic variables when comparing independent groups on their time to a dichotomous categorical outcome, they can click on a button with the words “Cox Regression” embedded in it and be linked to the Cox Regression (1182) webpage where information and methods for conducting and interpreting the statistical test in SPSS are presented. Upon navigating to any of the pages (1180-1182), users will be prompted to download a database structured for conducting the respective tests.

After linking to the Multivariate (1106) webpage, users are asked what the scale of measurement is for the outcome. If users are employing continuous outcomes, they can click on a button with the word “Continuous” embedded in it and be linked to the Multivariate Statistics with Continuous Outcomes (1183) webpage. In the Multivariate Statistics and Continuous Outcomes (1183) webpage, users are asked what kind of multivariate analysis will be answer their research question. Explanations for each type of statistical test and the specific type of research design that coincides with each statistical test are provided. Users can click on a button with the word “ANCOVA” and be linked to the ANCOVA (1184) webpage where information and methods for conducting and interpreting the statistical test in SPSS are presented. Users can click on a button with the words “Fixed Effects ANOVA” and be linked to the Fixed Effects ANOVA (1185) webpage where information and methods for conducting and interpreting the statistical test in SPSS are presented. Users can click on a button with the words “Random Effects ANOVA” and be linked to the Random Effects ANOVA (1186) webpage where information and methods for conducting and interpreting the statistical test in SPSS are presented. Users can click on a button with the words “Mixed Effects ANOVA” embedded in it and be linked to the Mixed Effects ANOVA (1187) webpage where information and methods for conducting and interpreting the statistical test in SPSS are presented. Users can click on a button with the words “Multiple Regression” embedded in it and be linked to the Multiple Regression (1188) webpage where information and methods for conducting and interpreting the statistical test in SPSS are presented. Upon navigating to any of the pages (1184-1188), users will be prompted to download a database structured for conducting the respective tests.

In the Multivariate Statistics with Continuous Outcomes (1183), users are asked what kind of multivariate analysis will be answer their research question. Explanations for each type of statistical test and the specific type of research design that coincides with each statistical test are provided. If users are comparing independent groups across multiple outcomes, they can click on a button with the words “Multiple Outcomes” embedded in it and be linked to the Multiple Outcomes (1189) webpage. Users are asked what type of multivariate test for multiple outcomes will answer their research question. Users can click on a button with the word “MANOVA” embedded in it and be linked to the MANOVA (1190) webpage where information and methods for conducting and interpreting the statistical test in SPSS are presented. Users can click on a button with the word “MANCOVA” embedded in it and be linked to the MANCOVA (1191) webpage where information and methods for conducting and interpreting the statistical test in SPSS are presented. Upon navigating to any of the pages (1190-1191), users will be prompted to download a database structured for conducting the respective tests.

After linking to the Multivariate (1106) webpage, users are asked what the scale of measurement is for the outcome. If users are employing count outcomes, they can click on a button with the word “Count” embedded in it and be linked to the Count Outcomes (1192) webpage. Users are asked what kind of multivariate statistical test for count outcomes will answer their research question. If users click on a button with the words “Negative Binomial Regression” embedded in it, they will be linked to the Negative Binomial Regression (1193) webpage where information and methods for conducting and interpreting the statistical test in SPSS are presented. If users click on a button with the words “Poisson Regression” embedded in it, they will be clinked to the Poisson Regression (1194) webpage where information and methods for conducting and interpreting the statistical test in SPSS are presented. Upon navigating to any of the pages (1193-1194), users will be prompted to download a database structured for conducting the respective tests.

FIG. 11K. From the Statistics (111) webpage, users can click on a button with the word “Multivariate” embedded in it and be linked to the Multivariate (1106) webpage. If users click on a button with the word “Regression” embedded in it and be linked to the Regression (1107) webpage. From the Regression (1107) webpage, users can select from a wide range of regression methods by clicking on buttons with the names of the statistical tests embedded in them. Users can click on a button with the words “Simultaneous Regression” embedded in it and be linked to the Simultaneous Regression (1195) webpage where information and methods for conducting and interpreting this type of regression in SPSS are presented. Users can click on a button with the words “Stepwise Regression” embedded in it and be linked to the Stepwise Regression (1196) webpage where information and methods for conducting and interpreting this type of regression in SPSS are presented. Users can click on a button with the words “Hierarchical Regression” embedded in it and be linked to the Hierarchical Regression (1197) webpage where information and methods for conducting and interpreting the statistical test in SPSS are presented.

In the Regression (1107) webpage, users are given access to important information about regression diagnostics. Regression diagnostics must be run when conducting multivariate statistics and information and methods for using regression diagnostics are integrated into each webpage regarding regression analysis. From the Regression (1107) webpage, users can also click on buttons with the names of regression diagnostic tests embedded in them and be linked to webpages containing information and methods about each diagnostic. Users can click on a button with the words “Residual Analysis” embedded in it and be linked to the Residual Analysis (1198) webpage where information and methods for conducting and interpreting residual analysis in SPSS are presented. Users can click on a button with the words “Normal Probability Plot” embedded in it and be linked to the Normal Probability Plot (1199) webpage where information and methods for conducting and interpreting normal probability plots in SPSS are presented. Users can click on a button with the word “Linearity” embedded in it and be linked to the Linearity (11100) webpage where information and methods for conducting and interpreting the diagnostic in SPSS are presented.

FIG. 11L. From the Statistics (111) webpage, users can click on a button with the acronym “SPSS” embedded in it and be linked to the SPSS (1108) webpage. From the SPSS (1108) webpage, users can access information and methods for conducting and interpreting over 50 statistical tests in SPSS. Users can click on buttons with the names of statistical tests embedded in them and be linked to webpages with information and methods for conducting and interpreting the respective statistical tests in SPSS. Specific sections of the entire decision engine are accessible from the SPSS webpage, including the Statistical Assumptions (1101), Descriptive Statistics (1102), Between-Subjects (1103), Within-Subjects (1104), Correlations (1105), Multivariate (1106), Regression (1107), Validation of Statistical Findings (1109), and Psychometrics (114) webpages.

FIG. 11M. From the Statistics (111) webpage, users can click on a button with the words “Validation of Statistical Findings” embedded in it and be linked to the Validation of Statistical Findings (1109) webpage. Users are prompted to select a type of validation that will best work for their statistical analysis. Users do this by click on a button with the name of a validation technique embedded in it. Users can click on a button with the word “Bootstrap” embedded in it and be linked to the Bootstrap (11101) webpage where information and methods for conducting this type of validation in SPSS are presented. Users can click on a button with the words “Split-Half” embedded in it and be linked to the Split-Half (11102) webpage where information and methods for conducting this type of validation in SPSS are presented. Users can click on a button with the words “Jack-Knife” embedded in it and be linked to the Jack-Knife (11103) webpage where information and methods for conducting this type of validation in SPSS are presented.

FIG. 12. The Databases (112) webpage starts the decision engine for selecting the correct database structure for running different types of statistical analyses. Users are asked what type of research design is being used in their study. Users can choose from one of three database structures: Between-subjects, within-subjects, and multivariate. Users click on buttons with the names of database structures embedded in them that will run their statistical analysis and are linked to the respective webpages. Users are given an explanation of the design and structure of the database and then are allowed to download a database that is preformatted to run the statistical analysis required. Users can also download a codebook document that is associated with the database. Users can click on a button with the words “Between-Subjects Database” embedded in it and be linked to the Between-Subjects Database (1201) webpage where information, methods, and downloads for this type of database structure. Users can click on a button with the words “Within-Subjects Database” embedded in it and be linked to the Within-Subjects Database (1202) webpage where information, methods, and downloads for this type of database structure. Users can click on a button with the words “Multivariate Database” embedded in it and be linked to the Multivariate Database (1203) webpage where information, methods, and downloads for this type of database structure.

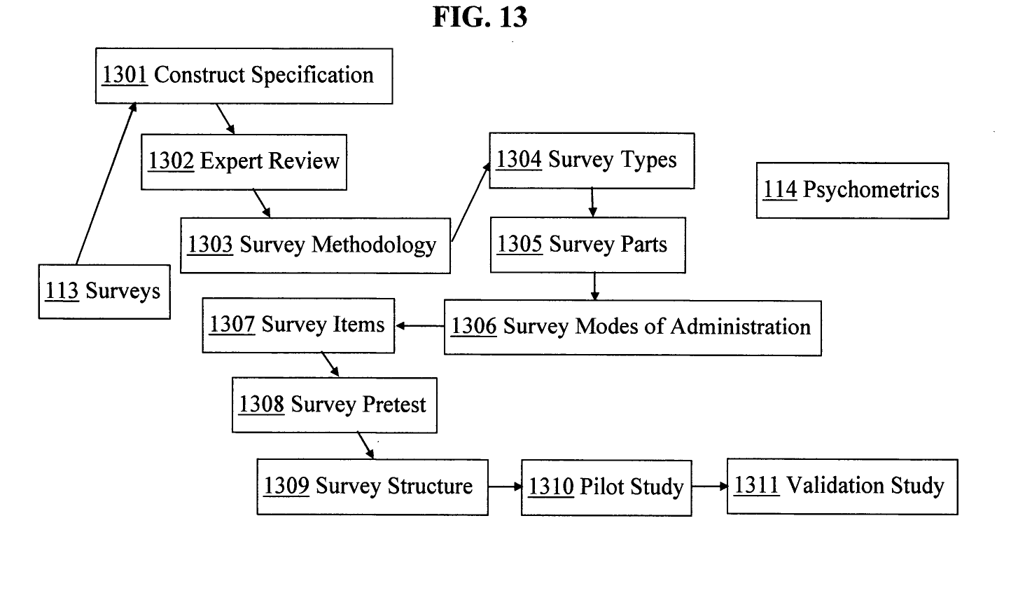

FIG. 13. The Surveys (113) webpage starts the decision engine for creating a survey using a validated eight-step methodology. Users are presented with an introduction to the eight-step method and are prompted to click on a button with the words “Construct Specification” embedded in it. Users are then linked to the Construct Specification (1301) webpage where information and methods for writing a construct specification. Users are also give the chance to download a construct specification template document. Users are prompted at the bottom of the page to click on a button with the words “Expert Review” embedded in it. Users are linked to the Expert Review (1302) webpage where information and methods for an expert review of a construct specification are presented. At the bottom of the page, users are prompted to click on a button with the words “Survey Methodology” embedded in it and are linked to the Survey Methodology (1303) webpage. Users are presented information about survey methodologies and are prompted to click on a button with the words “Survey Types” embedded in it. Users are linked to the Survey Types (1304) webpage that presents information about different types of surveys and how to choose one to answer their specific research question. Users are prompted to click on a button with the words “Survey Parts” embedded in it. Users are linked to the Survey Parts (1305) webpage where information about the six specific parts of any survey are presented. Users are prompted to click on a button with the words “Survey Modes of Administration” embedded in it. Users are linked to the Survey Modes of Administration (1306) webpage where information regarding the different modes of administering surveys to participants are reviewed. Users are prompted to click on a button with the words “Survey Items” embedded in it. Users are linked to the Survey Items (1307) webpage where information about writing item stems and response sets are presented. Users are prompted to click on a button with the words “Survey Pretest” embedded in it. Users are linked to the Survey Pretest (1308) webpage where information about pretesting a survey instrument is presented. Users can download a template for conducting a focus group for a survey pretest. Users are prompted to click on a button with the words “Survey Structure” embedded in it. Users are linked to the Survey Structure (1309) webpage where information about formally structuring a survey are presented. Users are prompted to click on a button with the words “Pilot Study” embedded in it. Users are linked to the Pilot Study (1310) webpage where information and methods for conducting a pilot study of a survey instrument are presented. Users are prompted to click on buttons with names of psychometric tests embedded in them to be linked to those respective tests. Users are prompted to click on a button with the words “Validation Study” embedded in it and are linked to the Validation Study (1311) webpage where information and methods for conducting a validation study of a survey instrument are presented. Users are prompted to click on buttons with the names of psychometric tests embedded in them to be linked to those respective tests. Users are prompted to click on a button with the word “Psychometrics” embedded in it to be linked to the Psychometrics (114) decision engine.

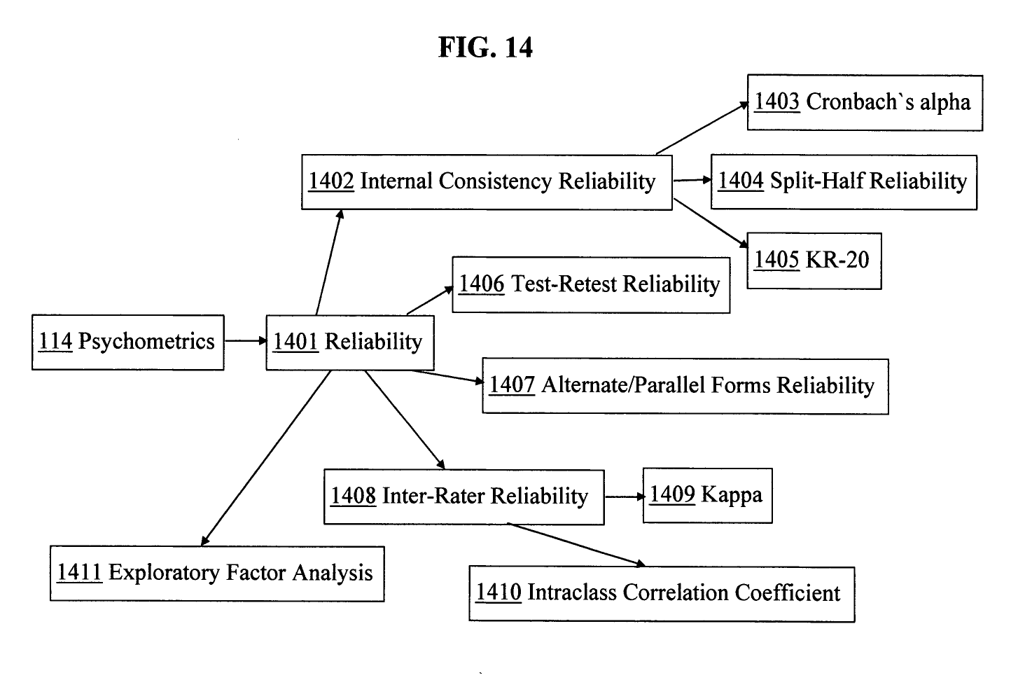

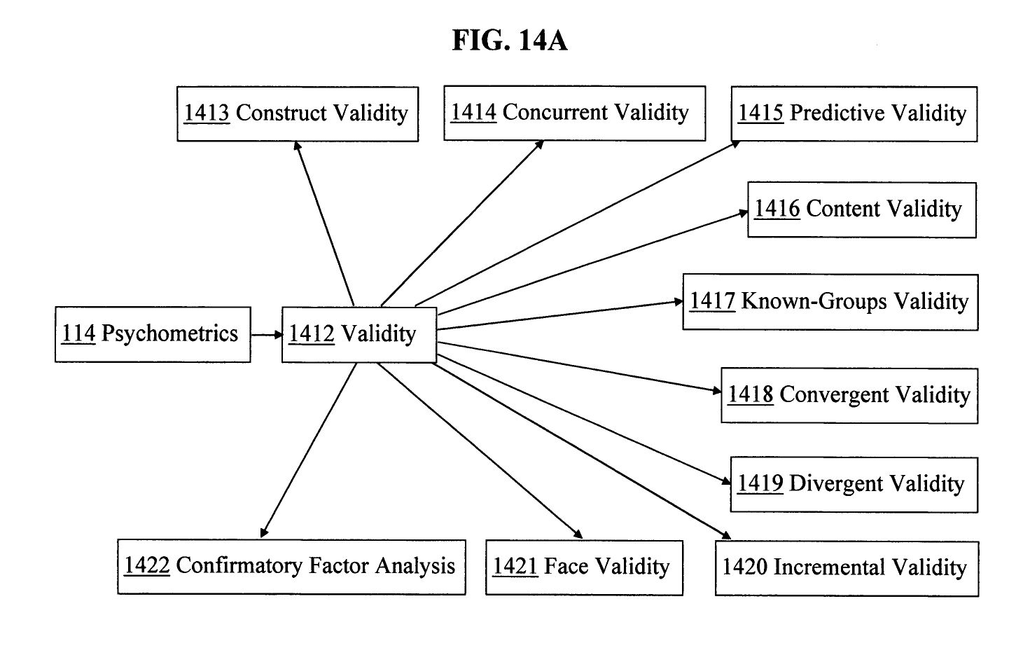

FIG. 14. The Psychometrics (114) webpage starts the decision engine for conducting and interpreting the correct psychometric tests to answer research questions. Users can click on a button with the word “Reliability” embedded in it and be linked to the Reliability (1401) webpage. The Reliability (1401) webpage asks users what type of reliability analysis will best answer their research question. Users can click on a button with the words “Internal Consistency Reliability” embedded in it and be linked to the Internal Consistency Reliability (1402) webpage. Users are presented an explanation of internal consistency reliability and are asked what type of internal consistency reliability will be used to answer their research question. Users can click on a button with the words “Cronbach's alpha” embedded in it and be linked to the Cronbach's alpha (1403) webpage where information and methods for conducting and interpreting the psychometric test in SPSS are presented. Users can click on a button with the words “Split-Half” embedded in it and be linked to the Split-Half (1404) webpage where information and methods for conducting and interpreting the psychometric test in SPSS are presented. Users can click on a button with the acronym “KR-20” embedded in it and be linked to the KR-20 (1405) webpage where information and methods for conducting and interpreting the psychometric test in SPSS are presented. Upon navigating to any of the three webpages (1403-1405), users will be prompted to download a database structured for conducting the respective tests.

From the Reliability (1401) webpage, users can click on a button with the words “Test-Retest Reliability” embedded in it and be linked to the Test-Retest Reliability (1406) webpage where information and methods for conducting and interpreting the psychometric test in SPSS are presented. Users will be prompted to download a database structured for conducting test-retest reliability analysis.

From the Reliability (1401) webpage, users can click on a button with the words “Alternate/Parallel Forms Reliability” embedded in it and be linked to the Alternate Parallel Forms Reliability (1407) webpage where information about the form of reliability is presented.

From the Reliability (1401) webpage, users can click on a button with the words “Inter-Rater Reliability” embedded in it and be linked to the Inter-Rater Reliability (1408) webpage. Users are presented with an explanation of inter-rater reliability and are asked what type of inter-rater reliability will be used based on the type of rating. Users can click on a button with the word “Kappa” embedded in it and be linked to the Kappa (1409) webpage where information and methods for conducting and interpreting the psychometric test in SPSS ae presented. Users can click on a button with the words “Intraclass Correlation Coefficient” embedded in it and be linked to the Intraclass Correlation Coefficient (1410) webpage where information and methods for conducting and interpreting the psychometric test in SPSS are presented. Upon navigating to either of the two pages (1409-1410), users will be prompted to download a database structured for conducting the respective tests.

From the Reliability (1401) webpage, users can click on a button with the words “Exploratory Factor Analysis” embedded in it and be linked to the Exploratory Factor Analysis (1411) webpage where information and methods for conducting and interpreting the statistical analysis in SPSS are presented. Upon navigating to the webpage (1411), users will be prompted to download a database structured for conducting the respective tests.

FIG. 14A. The Psychometrics (114) webpage starts the decision engine for conducting and interpreting the correct psychometric tests to answer research questions. Users can click on a button with the word “Validity” embedded in it and be linked to the Validity (1412) webpage. The Validity (1412) webpage asks users what type of validity analysis will best answer their research question. Users can click on a button with the words “Construct Validity” embedded in it and be linked to the Construct Validity (1413) webpage where information and methods for conducting and interpreting construct validity evidence. Users can click on a button with the words “Concurrent Validity” embedded in it and be linked to the Concurrent Validity (1414) webpage where information and methods for conducting and interpreting concurrent validity analyses in SPSS are presented. Users can click on a button with the words “Predictive Validity” embedded in it and be linked to the Predictive Validity (1415) webpage where information and methods for conducting and interpreting predictive validity analyses in SPSS are presented. Users can click on a button with the words “Content Validity” embedded in it and be linked to the Content Validity (1416) webpage where information and methods for establishing content validity are presented. Users can click on a button with the words “Known-Groups Validity” embedded in it and be linked to the Known-Groups Validity (1417) webpage where information and methods for conducting and interpreting known-groups validity analyses in SPSS are presented. Users can click on a button with the words “Convergent Validity” embedded in it and be linked to the Convergent Validity (1418) webpage where information and methods for conducting and interpreting convergent validity analyses in SPSS are presented. Users can click on a button with the words “Divergent Validity” embedded in it and be linked to the Divergent Validity (1419) webpage where information and methods for conducting and interpreting divergent validity analyses in SPSS are presented. Users can click on a button with the words “Incremental Validity” embedded in it and be linked to the Incremental Validity (1420) webpage where information and methods for conducting and interpreting incremental validity analyses in SPSS are presented. Users can click on a button with the words “Face Validity” embedded in it and be linked to the Face Validity (1421) webpage where information regarding face validity. Users can click on a button with the words “Confirmatory Factor Analysis” embedded in it and be linked to the Confirmatory Factor Analysis (1422) webpage where information and methods for conducting and interpreting confirmatory factor analysis in SPSS AMOS are presented. Upon navigating to any of the webpages (1413-1422), users will be prompted to download a database structured for conducting the respective analyses.

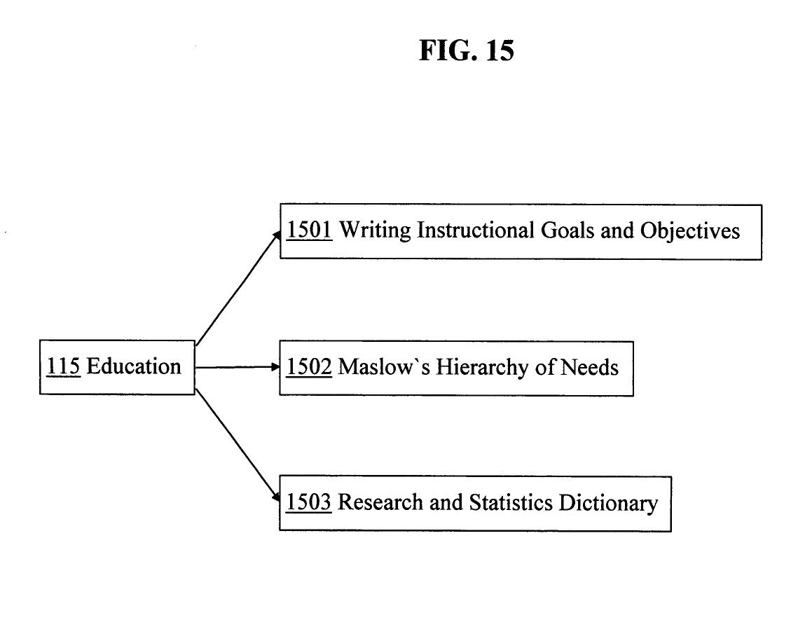

FIG. 15. The Education (115) webpage starts the decision engine for writing instructional goals and objectives, using Maslow's Hierarchy of Needs, and defining research and statistics terminology. Users are prompted to click on buttons with words embedded in them to link to other respective webpages. Users can click on a button with the words “Writing Instructional Goals and Objectives” embedded in it and be linked to the Writing Instructional Goals and Objectives (1501) webpage where information and methods for writing goal and objectives using Bloom's Taxonomy. Users can click on a button with the words “Maslow's Hierarchy of Needs” embedded in it and be linked to the Maslow's Hierarchy of Needs (1502) webpage where information about the developmental theory is presented. Users can click on a button with the words “Research and Statistics Dictionary” embedded in it and be linked to the Research and Statistics Dictionary (1503) webpage where a wide spectrum of empirical and statistical terms are defined and linked to respective webpages.

### CONCLUSION, RAMIFICATIONS, AND SCOPE OF THE INVENTION

Accordingly the reader will see that, according to one embodiment of the invention, I have provided a non-provisional patent application related to an online decision engine for applied research and statistics. Researchers are asked questions in the webpages of Research Engineer and by clicking on buttons with their answers embedded in them, they will be linked to other webpages where information and methods for conducting and interpreting research methods and statistics are presented.

While the above description contains many specificities, these should not be construed as limitations on the scope of any embodiment, but as exemplifications of the presently preferred embodiments thereof. Many other ramifications and variations are possible with the teachings of the various embodiments. For example, any number of web-based applications for creating websites can be used. Any number of online decision engines for applied research and statistics can be created using various programming languages or web-based applications. Different empirical and statistical philosophies and methods can be employed by scientists and researchers based upon their training and current context or environment. There a myriad of ways to ask questions to get researchers to the correct method or statistical test. There are many empirical and statistical tests that are not presented in this online decision engine. There are many other mediums where decision trees or processes can be presented. There are many ways to link between webpages in a website besides clicking on buttons or text links. There are several types of statistical software packages besides SPSS that can be integrated into an online decision engine. There are different http protocols with different domain names and webpage names where a decision engine could be created. There are many ways to land on webpages via search engines and typing in search queries. There are many types of decision trees. There are many ways to search the internet. There are many ways to download documents and databases. There are many types of social media entities. The website can be transitioned into an application that is available for purchase or download from Apple devices, Android devices, or any other type of application delivery service.

Thus, the scope of the invention should be determined by the appended claims and their legal equivalents, and not by the examples given.

I claim:

1. A new method of choosing research and statistics methods, comprising an online decision engine being published and made accessible via internet or Wi-Fi for applied research and statistics where users are presented with questions and answer the questions by clicking on buttons or links with their answers embedded in them, whereby users are linked to other respective webpages where information and methods for conducting and interpreting said methods are presented. By clicking on buttons or links to answer said questions, users can work through online decision engines for research questions, research designs, statistical power, sample size, databases, statistics, evidence-based medicine, epidemiology, diagnostic testing, variables, measurement, surveys, psychometrics, and education, whereby they can choose the correct research and statistics methods for their needs.

2. The online decision engine of claim 1, further including users being presented with questions and clicking on buttons or links with their answers embedded in them to be linked to the research questions decision engine where information and methods for writing feasible, interesting, novel, ethical, and relevant research questions containing the population, intervention, comparator, and outcome are presented, whereby users will write more valid and answerable research questions.

3. The online decision engine of claim 1, further including users being presented with questions and clicking on buttons or links with their answers embedded in them to be linked to the research designs decision engine where information and methods for equivalency trials, non-inferiority trials, systematic reviews, propensity score matching, random selection, random assignment, randomized controlled trials, blinding, intention-to-treat analysis, quasi-experimental designs, counterbalanced designs, interrupted time series designs, equivalent time samples designs, nonequivalent control group designs, observational designs, prospective cohort designs, retrospective designs, retrospective cohort designs, cross-sectional designs, case-control designs, and case series designs are presented, whereby users will choose the correct research design to answer their research questions.

4. The online decision engine of claim 1, further including users being presented with questions and clicking on buttons or links with their answers embedded in them to be linked to the statistical power decision engine where information and methods for outcomes, categorical outcomes, ordinal outcomes, continuous outcomes, research design, between-subjects designs, within-subjects designs, multivariate designs, effect size, small effect sizes, large effect sizes, variance of outcome, limited variance, extensive variance, sample sizes, small sample sizes, large sample sizes, sampling methods, probability sampling, simple random sampling, stratified random sampling, clustered random sampling, non-probability sampling, convenience sampling, and purposive sampling are presented, whereby users will gain a better understanding of the effects of research design, outcomes, effect size, variance, sample size, and sampling methods on statistical power.

5. The online decision engine of claim 1, further including users being presented with questions and clicking on buttons or links with their answers embedded in them to be linked to the sample size decision engine where information and methods for conducting and interpreting sample size for Chi-square, sample size for Mann-Whitney U, sample size for independent samples t-test, sample size for ANOVA, sample size for McNemar's test, sample size for Wilcoxon test, sample size for repeated-measures t-test, sample size for repeated-measures ANOVA, sample size for point biserial, sample size for Pearson's r are presented, whereby users will be able to calculate the needed sample sizes for their research.

6. The online decision engine of claim 1, further including users being presented with questions and clicking on buttons or links with their answers embedded in them to be linked to the evidence-based medicine decision engine where information and methods for asking clinical questions, acquiring clinical evidence, appraising clinical evidence, applying clinical evidence, assessing evidence-based practice, appraising therapy evidence, appraising randomized controlled trial evidence, applying randomized controlled trial evidence, appraising systematic review evidence, applying systematic review evidence, appraising qualitative evidence, applying qualitative evidence, appraising clinical decision analysis evidence, applying clinical decision analysis evidence, appraising economic analysis evidence, applying economic analysis evidence, appraising clinical practice guideline evidence, applying clinical practice guideline evidence, appraising diagnosis evidence, applying diagnosis evidence, appraising screening evidence, applying screening evidence, appraising prognosis evidence, applying prognosis evidence, appraising harm evidence, applying harm evidence, asking clinical questions assessment, acquiring clinical evidence assessment, appraising clinical evidence assessment, applying clinical evidence assessment, and assessing clinical practice are presented, whereby users will be able to better integrate clinical evidence into their practice.

7. The online decision engine of claim 1, further including users being presented with questions and clicking on buttons or links with their answers embedded in them to be linked to the epidemiology decision engine where information and methods for calculating and interpreting odds ratio, prevalence, relative risk, incidence, control event rate, experimental event rate, treatment effect, absolute risk reduction, number needed to treat, absolute risk increase, and number need to harm are presented, whereby users can calculate, interpret, and apply these measures in their current empirical or clinical context.

8. The online decision engine of claim 1, further including users being presented with questions and clicking on buttons or links with their answers embedded in them to be linked to the diagnostic testing decision engine where information and methods for calculating and interpreting sensitivity, specificity, receiver operator characteristic, positive predictive value, negative predictive value, and diagnostic accuracy are presented, whereby users can calculate, interpret, and apply these measures in their current empirical or clinical context.

9. The online decision engine of claim 1, further including users being presented with questions and clicking on buttons or links with their answers embedded in them to be linked to the variables decision engine where information and methods for scales of measurement, categorical variables, nominal variables, ordinal variables, continuous variables, interval variables, ratio variables, count variables, types of variables, independent variables, dependent variables, predictor variables, outcome variables, confounding variables, demographic variables, and control variables are presented, whereby users will choose the correct scales of measurement and types of variables to answer their research questions.

10. The online decision engine of claim 1, further including users being presented with questions and clicking on buttons or links with their answers embedded in them to be linked to the statistics decision engine where information and methods for conducting and interpreting statistical assumptions, descriptive statistics, between-subjects, within-subjects, correlations, multivariate, regression, SPSS, validation of statistical findings, independence of observations, normality, homogeneity of variance, normality of difference scores, sphericity, chi-square assumption, skewness, kurtosis, logarithmic transformations, Mauchly's test, Levene's test, measures of central tendency, mean, median, mode, measures of variability, variance, standard deviation, interquartile range, frequency, cross-tabulation, one group, Chi-square Goodness-of-fit, one-sample median test, one-sample t-test, two groups, Fisher's Exact Test, Chi-square, Mann-Whitney U, normality and independent samples t-test, transformations for independent samples t-test, homogeneity of variance and independent samples t-test, Mann-Whitney U and homogeneity of variance, independent samples t-test, three or more groups, unadjusted odds ratio, Kruskal-Wallis, normality and ANOVA, transformations for ANOVA, homogeneity of variance and ANOVA, Kruskal-Wallis and homogeneity of variance, ANOVA, one observation, baseline frequency, baseline median, baseline observation, two observations, McNemar's test, Wilcoxon, normality and repeated-measures t-test, transformations for repeated-measures t-test, repeated-measures t-test, three or more observations, Cochran's Q, Friedman's ANOVA, normality and repeated-measures ANOVA, transformations for repeated-measures ANOVA, sphericity and repeated-measures ANOVA, repeated-measures ANOVA, Greenhouse-Geisser, Phi-coefficient, point biserial, rank biserial, biserial, Spearman's rho, Pearson's r, multivariate statistics with categorical outcomes, logisitic regression, multinomial logistic regression, proportional odds regression, survival analysis, Kaplan-Meier, Cochran-Mantel-Haenszel, Cox regression, multivariate statistics with continuous outcomes, ANCOVA, fixed-effects ANOVA, random-effects ANOVA, mixed-effects ANOVA, multiple regression, multiple outcomes, MANOVA, MANCOVA, count outcomes, negative binomial regression, Poisson regression, simultaneous regression, stepwise regression, hierarchical regression, residual analysis, normal probability plot, linearity, bootstrap, split-half, and jack-knife are presented, whereby users will be able to choose the correct statistical test to answer their research question, given they have met all statistical assumptions.

11. The online decision engine of claim 1, further including users being presented with questions and clicking on buttons or links with their answers embedded in them to be linked to the databases decision engine where information and methods for structuring a between-subjects database, a within-subjects database, a multivariate database, and a codebook are presented, whereby users will be able to choose and download a database and code book structured for their research needs.

12. The online decision engine of claim 1, further including users being presented with questions and clicking on buttons or links with their answers embedded in them to be linked to the surveys decision engine where information and methods for creating construct specifications, expert review, survey methodology, survey types, survey parts, survey modes of administration, writing survey items, survey pretest, survey structure, pilot study, and validation study are presented, whereby users will be able to create high-quality survey instruments with a validated methodology.

13. The online decision engine of claim 1, further including users being presented with questions and clicking on buttons or links with their answers embedded in them to be linked to the psychometrics decision engine where information and methods for conducting and interpreting reliability, internal consistency reliability, Cronbach's alpha, split-half reliability, KR-20, test-retest reliability, alternate/parallel forms reliability, inter-rater reliability, Kappa, intraclass correlation coefficient, exploratory factor analysis, validity, construct validity, concurrent validity, predictive validity, content validity, known-groups validity, convergent validity, divergent validity, incremental validity, face validity, and confirmatory factor analysis are presented, whereby users can conduct psychometric analyses and interpret them in their current empirical or clinical context.

14. The online decision engine of claim 1, further including users being presented with questions and clicking on buttons or links with their answers embedded in them to be linked to the education decision engine where information and methods for writing instructional goals and objectives, using Maslow's Hierarchy of Needs, and defining research and statistics terms.

15. The online decision engine of claim 1, further including users being able to click on buttons or links with words embedded in them to download pre-formatted documents and spreadsheets from the website, whereby they will have access to between-subjects databases, within-subjects databases, multivariate databases, epidemiology calculators, diagnostic testing calculators, equivalency trial calculators, non-inferiority trial calculators, meta-analysis calculators, construct specification templates, and focus group templates.

16. The online decision engine of claim 1, further including users being able to enter text search queries into both internal and external search engines embedded in the webpages, whereby users will be able to access more specific information within the decision engines or from the internet.

17. The online decision engine of claim 1, further including users being able to click on social media buttons embedded in the webpages, whereby users will be able to connect with the website via social media platforms.

18. The online decision engine of claim 1, further including users being able to choose the correct research and statistics methods using an online decision engine, whereby the users can access the website on any type of device capable of using the internet or Wi-Fi such as tablets, smart phones, laptops, desktops, or other types of electronic devices as well as the website in the form of an application or “app.”

19. The online decision engine of claim 1, further including users being able to access a wide range of research and statistical terms in an online dictionary published on the website, whereby they will be able to define confusing and nebulous research and statistical terms and be able to link to respective webpages by clicking on text links.

20. The online decision engine of claim 1, further including users being able to conduct and interpret research and statistical methods because they are published to an online decision engine, whereby users can use existing software packages and platforms to conduct and interpret their research and statistical methods independently using the information and methods presented in the webpages.
